(19) United States
(12) Patent Application Publication
(10) Pub. No.: US 2026/0070172 A1
(43) Pub. Date: Mar. 12, 2026

(54) VOICE CONTROL POSITIONING SYSTEM

(71) Applicant: ALM POSITIONERS, INC., Rock Island, IL (US)

(72) Inventors: Patrick W. Pollock, Bettendorf, IA (US); Brett Stewart, Davenport, IA (US); James Kuhman, Davenport, IA (US); Ajay Malik, Saratoga, CA (US)

(21) Appl. No.: 19/208,289

(22) Filed: May 14, 2025

Related U.S. Application Data
(60) Provisional application No. 63/692,439, filed on Sep. 9, 2024.

(51) Int. Cl. B23Q 1/25; B23K 37/04; G06F 3/16; G06F 40/58; G10L 15/22

(52) U.S. Cl. CPC B23Q 1/25; G06F 3/167; G10L 15/22; B23K 37/04; G06F 40/58; G10L 2015/223

(57) ABSTRACT

A positioning system includes a voice activation device configured to receive voice input, an AI-enabled voice control module operatively connected to the voice activation device wherein the module is configured to convert the voice input to a machine-readable language and/or a communication protocol, and a positioner operatively connected to the module wherein the positioner is configured to perform an operation on a work piece based on the machine-readable language and/or communication protocol. The voice activation device can comprise a headset that allows a user to control the positioner via voice commands in a hands-free manner. Being able to operate the positioner in a hands-free manner improves safety, efficiency, productivity, ergonomics, and cost-effectiveness related to operation of the positioner.

### CROSS REFERENCE TO RELATED APPLICATIONS

This application claims priority under 35 U.S.C. § 119 to provisional patent application U.S. Ser. No. 63/692,439, filed Sep. 9, 2024. The provisional patent application is herein incorporated by reference in its entirety, including without limitation, the specification, claims, and abstract, as well as any figures, tables, appendices, or drawings thereof.

### TECHNICAL FIELD

The present disclosure relates generally to apparatus(es), system(s), and/or method(s) having applications in at least the industrial positioning field. More particularly, but not exclusively, the present disclosure relates to an AI-enabled voice control positioning system that allows an operator to move industrial work pieces via voice commands in a hands-free manner.

### BACKGROUND

Traditional industrial equipment handling for manufacturing processes, such as welding and/or component assembly, use different types of positioning technology such as hydraulic positioner(s), electric servo motors, and electro-mechanical mechanisms. These traditional approaches to industrial equipment handling require an operator to manually adjust or position a work piece and/or manufactured product by coming into physical contact with aspect(s) of the positioner(s) and/or work piece/manufactured product.

Such manual adjustment and positioning that is required by current positioning technology has many drawbacks. Such manual adjustment and positioning are associated with safety concerns, productivity limitations, and ergonomic concerns. For example, stopping to interact with manual controls can expose the operator to various hazards, such as burns and hot surfaces, injuries from moving parts, and even more severe accidents involving heavy machinery and/or heavy work pieces. Further, such manual adjustment of positioning equipment can be time-consuming and can interrupt the welding and/or assembly process, which leads to decreased efficiency and productivity. Each time an operator must stop to adjust the positioner and/or product(s), valuable working time is lost and overall workflow is disrupted and/or slowed. This leads to higher costs as more time and resources are needed to manufacture and/or produce the product. Additionally, such manual adjustment and positioning can create physical strain for the operator(s) such as by forcing the operator(s) to perform repetitive movements and/or maintain awkward positions to manipulate positioning equipment and/or work pieces.

Thus, there exists a need in the art for a technological solution including an apparatus, system, and/or method that provides effective positioning related to industrial equipment handling while also providing safety, efficiency, productivity, cost-effectiveness, and ergonomic benefits.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of aspects and/or embodiments shown and/or described in the present disclosure to provide apparatus(es), system(s), and/or method(s) that provide effective positioning related to industrial equipment, work piece, and/or component handling while also providing improved safety, efficiency, productivity, cost-effectiveness, and/or ergonomics.

It is a further object, feature, and/or advantage of the present disclosure to provide apparatus(es), system(s), and/or method(s) that allow an operator to control positioning equipment, work pieces, and/or components via voice commands in a hands-free manner.

It is a further object, feature, and/or advantage of the present disclosure to provide apparatus(es), system(s), and/or method(s) that include an AI-enabled voice control module that can convert voice and/or sound into a machine-readable language and/or communication protocol.

It is a further object, feature, and/or advantage of the present disclosure to provide apparatus(es), system(s), and/or method(s) that include an AI-enabled voice control module that can perform voice-to-text conversion(s) and/or text-to-voice conversion(s) enabling text-to-operation functionality and/or status-to-text-to-voice functionality.

It is a further object, feature, and/or advantage of the present disclosure to provide apparatus(es), system(s), and/or method(s) that provide feedback regarding the positioning equipment, work pieces, and/or components thereof to an operator audibly via sound and/or voice.

It is still yet a further object, feature, and/or advantage of the present disclosure to provide apparatus(es), system(s), and/or method(s) that provide real-time alert(s) regarding the positioner and/or components thereof to an operator audibly via sound and/or voice.

The apparatus(es), system(s), and/or method(s) disclosed herein can be used in a wide variety of applications. For example, the apparatus(es), system(s), and/or method(s) described herein can be part of original or new positioning equipment, or may be configured as an add-on module such that the apparatus(es), system(s), and/or method(s) can be retrofit to existing positioning machines, enabling operator(s) to adopt the functionality described herein without the need for purchasing entirely new equipment. Further, the apparatus(es), system(s), and/or method(s) described herein are substantially universal such that they can be adapted to fit a wide variety of positioning machines. Thus, the apparatus(es), system(s), and/or method(s) described herein are versatile and applicable to different industrial settings and environments. Further, the add-on nature of the apparatus(es), system(s), and/or method(s) described herein render the apparatus(es), system(s), and/or method(s) to be easily and quickly integrated with existing positioning machines, which serves to minimize downtime and disruption. Further, by upgrading existing machines rather than replacing them, the apparatus(es), system(s), and/or method(s) described herein contribute to sustainability efforts. By upgrading existing machines rather than replacing them, waste and the overall environmental impact associated with manufacturing and disposing of industrial equipment is reduced. Additionally, the apparatus(es), system(s), and/or method(s) described herein can be modular in nature which allows for scalable implementations. For example, a business can start with a single unit to test and evaluate the benefits before committing to a full-scale rollout. This scalability renders the technology described herein adaptable to the evolving needs and capacities of different operations.

It can be beneficial that the apparatus be safe, cost-effective, and durable. For example, some embodiments of the apparatus(es), system(s), and/or method(s) described herein can include industrial enclosure(s) to protect particular hardware components, such as electronics, from industrial conditions including, but not limited to, dust, heat, vibration, and the like.

According to some aspects of the present disclosure, a method of controlling work on a work piece held by a positioner comprises: raising, lowering, and/or rotating the positioner, or a component thereof, using voice activated software operatively coupled with the positioner, without manual adjustment of the work piece, for a series of operations on the work piece.

According to some additional aspects of the present disclosure, the operations include welding, moving, and/or assembly.

According to some additional aspects of the present disclosure, the method further comprises receiving one or more voice commands via a voice activation device wherein the voice activation device is operatively connected to the voice activation software.

According to some additional aspects of the present disclosure, the one or more voice commands are customizable based on operational needs and/or preferences.

According to some additional aspects of the present disclosure, the method further comprises, via the voice activated software, translating the one or more voice commands to a machine-readable language and/or a communication protocol.

According to some additional aspects of the present disclosure, the method further comprises, via the voice activated software, receiving feedback from the positioner wherein such feedback comprises one or more of: a ready to move signal; a move command signal; a fault signal comprising identification of a fault and information regarding how to rectify the fault; and a confirmation signal regarding command execution.

According to some additional aspects of the present disclosure, the method further comprises providing one or more real-time verbal alerts wherein the one or more verbal alerts comprises one or more of: a machine status alert; a maintenance alert; and a safety alert.

According to some additional aspects of the present disclosure, the method further comprises offering ongoing technical support and/or update(s) to ensure the system remains effective and up-to-date.

According to some additional aspects of the present disclosure, the method further comprises using an AI-enabled voice control module to perform voice-to-text conversion(s) and/or text-to-voice conversion(s) enabling text-to-operation functionality and/or status-to-text-to-voice functionality.

According to some additional aspects of the present disclosure, the AI-enabled voice control module is housed within an industrial enclosure.

According to some other aspects of the present disclosure, a positioning system for performing operations on a work piece comprises: a positioner configured for moving a work piece to different positions; a wearable device adapted to be worn by an operator, the wearable device being operatively connected to the positioner; an intelligence control module operatively connected to the wearable device to move the work piece, using the positioner, by voice activation from the operator via the wearable device and the software.

According to some additional aspects of the present disclosure, the wearable device comprises a microphone and/or an auditory mechanism.

According to some additional aspects of the present disclosure, the operator can operate the system in a hands-free manner.

According to some additional aspects of the present disclosure, the software comprises one or more safety protocols to prevent accidental activation and/or misuse of the system.

According to some additional aspects of the present disclosure, the system is configured such that the operator can engage in a voice conversation with the system to perform one or more of: troubleshooting; seeking help; receiving guidance; enhancing efficiency of problem resolution; inquiring about scheduled tasks; checking pending items; communicating with a manager; and streamlining workflow and/or coordination.

According to some additional aspects of the present disclosure, the operator can login to the system and the system automatically adjusts to the operator's preferences.

According to some other aspects of the present disclosure, a positioning system for performing operations on a work piece comprises: a hands-free interface device configured to receive voice input; an AI-enabled voice control module operatively connected to the interface device, wherein the module is configured to convert the voice input to a machine-readable language and/or a communication protocol; and a positioner operatively connected to the module wherein the positioner is configured to perform an operation on a work piece based on the machine-readable language and/or communication protocol.

According to some additional aspects of the present disclosure, the voice activation device is a headset to be worn by an operator, the headset comprising a microphone and an auditory mechanism, wherein the auditory mechanism comprises a speaker for one or both of the operator's ears.

According to some additional aspects of the present disclosure, the module utilizes AI for voice-to-text conversion(s) and/or text-to-voice conversion(s) enabling text-to-operation functionality and/or status-to-text-to-voice functionality.

According to some additional aspects of the present disclosure, an operator can operate the system in a hands-free manner.

According to some other aspects of the present disclosure, a combination of an AI-enabled voice control module and a programmable logic controller (PLC) comprises: an AI-enabled voice control module comprising a data communication mechanism; a PLC comprising a library, the PLC being operatively connected to the module; wherein the combination of the module and PLC is configured to receive voice data, via the data communication mechanism, and convert the voice data to text data using artificial intelligence; and wherein the text data is capable of being used, in conjunction with the library, to control machinery.

According to some additional aspects of the present disclosure, the machinery comprises positioning machinery related to welding and/or assembly of components.

According to some additional aspects of the present disclosure, the text data comprises a machine-readable language and/or a communication protocol.

According to some other aspects of the present disclosure, an AI-enabled voice control module for use with positioning equipment comprises: a data communication mechanism configured to receive voice data; software configured to convert the voice data into a machine-readable language and/or communication protocol; a processing unit to execute the software; and at least one ethernet connector configured to operatively connect the module to positioning equipment, wherein the machine-readable language and/or communication protocol can be communicated to the positioning equipment.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

In addition, as will be understood, any of the aspects of any of the embodiments shown and/or described herein could be combined with one another to form any number of embodiments, whether expressly disclosed or not, which would be understood by one skilled in the art.

FIG. 1 is a perspective view showing an example embodiment of a hydraulic positioner, including a master headstock column and a slave tailstock column, with the headstock shown in a solid line lowered position and a broken line raised position.

FIG. 2 is a side elevation view of positioner columns of the hydraulic positioner of FIG. 1.

FIG. 3 is a partially exploded view of the positioner columns of the hydraulic positioner of FIG. 1.

FIG. 4 is an enlarged view showing hard stop components on the headstock column of the hydraulic positioner of FIG. 1.

FIG. 5 is a perspective view of a headstock carriage of the hydraulic positioner of FIG. 1.

FIG. 6 is a sectional view of one of the columns of the hydraulic positioner of FIG. 1 showing the internal hydraulic cylinder.

FIG. 7 is an illustration of an example positioning system according to at least some aspects of the present disclosure.

FIG. 8 is a block diagram of an example positioning system according to at least some aspects of the present disclosure.

FIG. 9A is a front elevation view of an example industrial enclosure associated with hands-free voice control equipment according to at least some aspects of the present disclosure.

FIG. 9B is a modified front elevation view of the industrial enclosure of FIG. 9A showing example dimensions.

FIG. 9C is a bottom elevation view of the industrial enclosure of FIG. 9A.

FIG. 9D is a modified bottom elevation view of the industrial enclosure of FIG. 9A showing example dimensions.

FIG. 9E is a right-side elevation view of the industrial enclosure of FIG. 9A.

FIG. 9F is a modified right-side elevation view of the industrial enclosure of FIG. 9A showing example dimensions.

FIG. 9G is a left-side elevation view of the industrial enclosure of FIG. 9A.

FIG. 9H is a modified left-side elevation view of the industrial enclosure of FIG. 9A showing example dimensions.

FIG. 9I is a front internal elevation view of the industrial enclosure of FIG. 9A wherein the internal components of the industrial enclosure are visible.

FIG. 9J is a modified front internal elevation view of the industrial enclosure of FIG. 9A showing example dimensions.

FIG. 10 is a perspective view of the industrial enclosure of FIG. 9A mounted on a stand.

FIG. 11 is a perspective view of the industrial enclosure of FIG. 9A wherein the industrial enclosure is open such that the internal components of the industrial enclosure are visible.

FIGS. 12A and 12B are perspective views of components of a hands-free interface device according to at least some aspects of the present disclosure.

FIG. 13 is a perspective view of an example hands-free interface device comprising at least some of the components of FIGS. 12A and/or 12B according to at least some aspects of the present disclosure.

FIG. 14A is an external front elevation view of an example industrial enclosure for a main control panel according to at least some aspects of the present disclosure.

FIG. 14B is an external bottom elevation view of the industrial enclosure of FIG. 14A.

FIG. 14C is an external top elevation view of the industrial enclosure of FIG. 14A.

FIG. 14D is an external left-side elevation view of the industrial enclosure of FIG. 14A.

FIG. 14E is an external right-side elevation view of the industrial enclosure of FIG. 14A.

FIG. 14F is an internal elevation view of the industrial enclosure of FIG. 14A according to some embodiments.

FIG. 14G is an internal elevation view of a right side of the industrial enclosure of FIG. 14A according to some embodiments.

FIG. 14H is an internal elevation view of the right side of the industrial enclosure of FIG. 14A according to some embodiments.

FIG. 15A is an external front elevation view of an example industrial enclosure associated with a tailstock portion of positioning equipment according to some embodiments.

FIG. 15B is an internal elevation view of the industrial enclosure of FIG. 15A.

FIG. 15C is an external left-side elevation view of the industrial enclosure of FIG. 15A.

FIG. 15D is an external top elevation view of the industrial enclosure of FIG. 15A.

FIG. 15E is an external bottom elevation view of the enclosure of FIG. 15A.

FIG. 16A is an external front elevation view of an industrial enclosure associated with an external hydraulic power unit (HPU) according to some embodiments.

FIG. 16B is an internal elevation view of the industrial enclosure of FIG. 16A.

FIG. 16C is an external left-side elevation view of the industrial enclosure of FIG. 16A.

FIG. 16D is an external bottom elevation view of the industrial enclosure of FIG. 16A.

FIG. 17 is an external left-side elevation view of industrial enclosure of FIG. 15A according to some embodiments.

FIG. 18 is an external right-side elevation view of the industrial enclosure of FIG. 14A according to some embodiments.

FIG. 19A is an elevation view of a female portion of a connector according to some embodiments.

FIG. 19B is a perspective view of the female portion of FIG. 19A.

FIG. 20A is an elevation view of a male portion of a connector according to some embodiments.

FIG. 20B is a perspective view of the male portion of FIG. 20A.

FIG. 21 is an elevation view of the female portion of FIG. 19A or the male portion of FIG. 20A.

FIGS. 22 and 23 are schematic diagrams of circuitry relating to electrical controls regarding 480 VAC power distribution according to at least some aspects of the present disclosure.

FIGS. 24-26 are schematic diagrams of circuitry relating to electrical controls regarding 24 V DC power distribution according to at least some aspects of the present disclosure.

FIG. 27 is a schematic diagram of circuitry relating to electrical controls regarding embedded input wiring related to a controller and operatively connected component(s) according to at least some aspects of the present disclosure.

FIG. 28 is a schematic diagram of circuitry relating to electrical controls regarding embedded output wiring related to the controller of FIG. 27 and operatively connected component(s) according to at least some aspects of the present disclosure.

FIGS. 29 and 30 are schematic diagrams of circuitry relating to electrical controls regarding embedded high-speed counters (HSC) wiring related to the controller of FIG. 27 and operatively connected component(s) according to at least some aspects of the present disclosure.

FIGS. 31 and 32 are schematic diagrams of circuitry relating to electrical controls regarding embedded analog input/output wiring related to the controller of FIG. 27 and operatively connected component(s) according to at least some aspects of the present disclosure.

FIG. 33 is a schematic diagram of circuitry relating to electrical controls regarding analog wiring related to an output module and operatively connected component(s) according to at least some aspects of the present disclosure.

FIGS. 34 and 35 are schematic diagrams of circuitry relating to electrical controls regarding wiring related to output module(s) and operatively connected component(s) according to at least some aspects of the present disclosure.

FIG. 36 is a schematic diagram of circuitry relating to electrical controls regarding inputs related to a safety controller and operatively connected component(s) according to at least some aspects of the present disclosure.

FIG. 37 is a schematic diagram of circuitry relating to electrical controls regarding outputs related to the safety controller of FIG. 36 and operatively connected component(s) according to at least some aspects of the present disclosure.

FIGS. 38 and 39 are schematic diagrams of circuitry relating to electrical controls regarding inputs and outputs related to a safety expansion and operatively connected component(s) according to some embodiments.

FIG. 40 is a schematic diagram of components of the positioning system of FIG. 8 according to some embodiments.

FIG. 41 is a flow chart of an example method for controlling positioning equipment via voice commands in a hands-free manner according to at least some aspects of the present disclosure.

An artisan of ordinary skill in the art need not view, within isolated figure(s), the near infinite number of distinct permutations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

The terms “a,”“an,”and “the”include both singular and plural referents.

The term “or” is synonymous with “and/or” and means any one member or combination of members of a particular list.

The term “and/or” where used herein is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

The terms “invention” or “present invention” are not intended to refer to any single embodiment of the particular invention but encompass all possible embodiments as described in the specification and the claims.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as “constructed”, “arranged”, “adapted”, “manufactured”, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

As used herein, the term “exemplary” refers to an example, an instance, or an illustration, and does not indicate a most preferred embodiment unless otherwise stated.

To the extent to which any of the preceding definitions are inconsistent with definitions provided in any patent or non-patent reference incorporated herein by reference, any patent or non-patent reference cited herein, or in any patent or non-patent reference found elsewhere, it is understood that the preceding definition will be used herein.

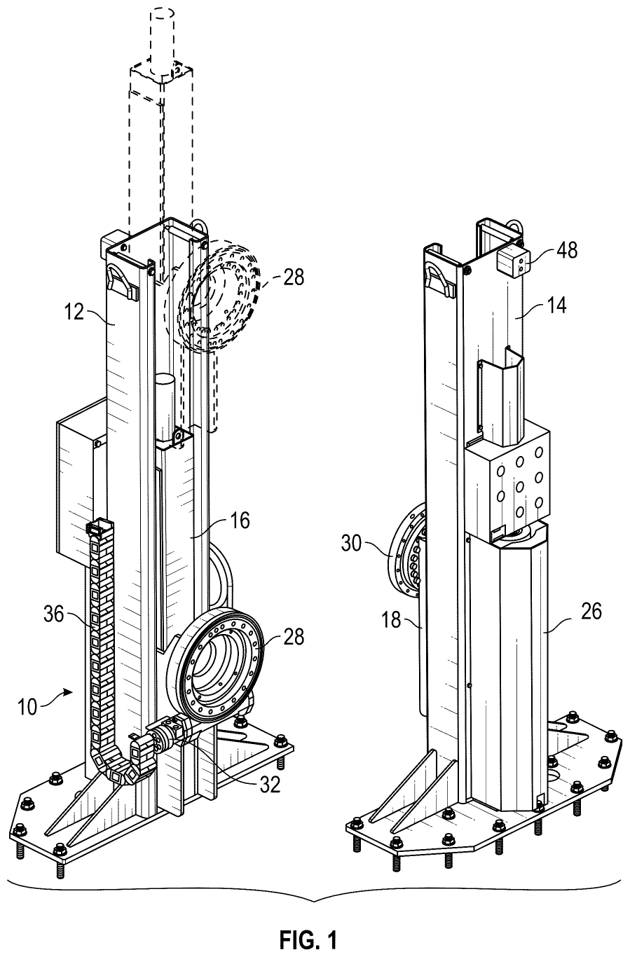

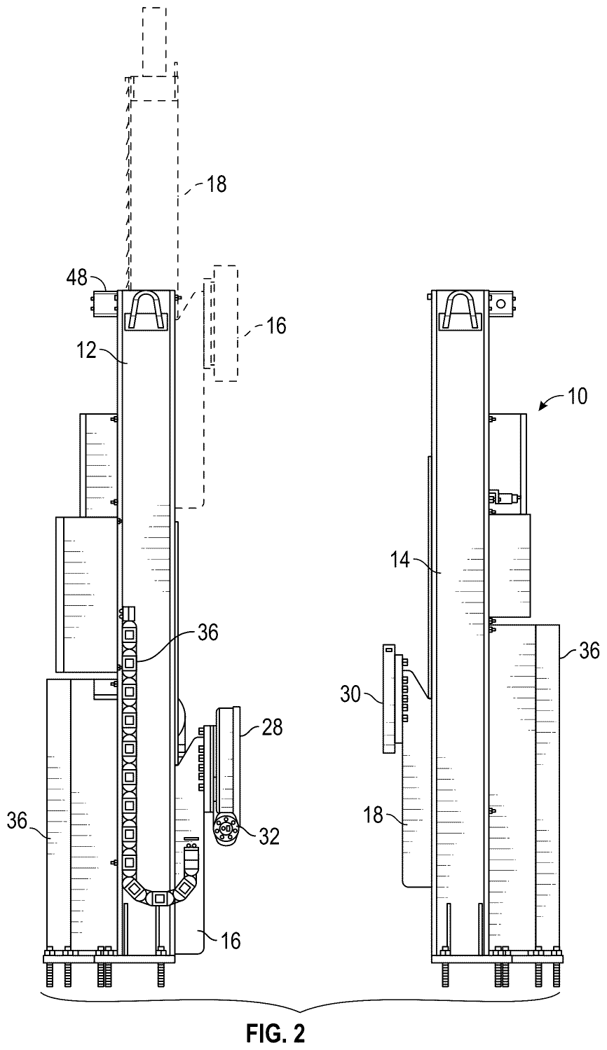

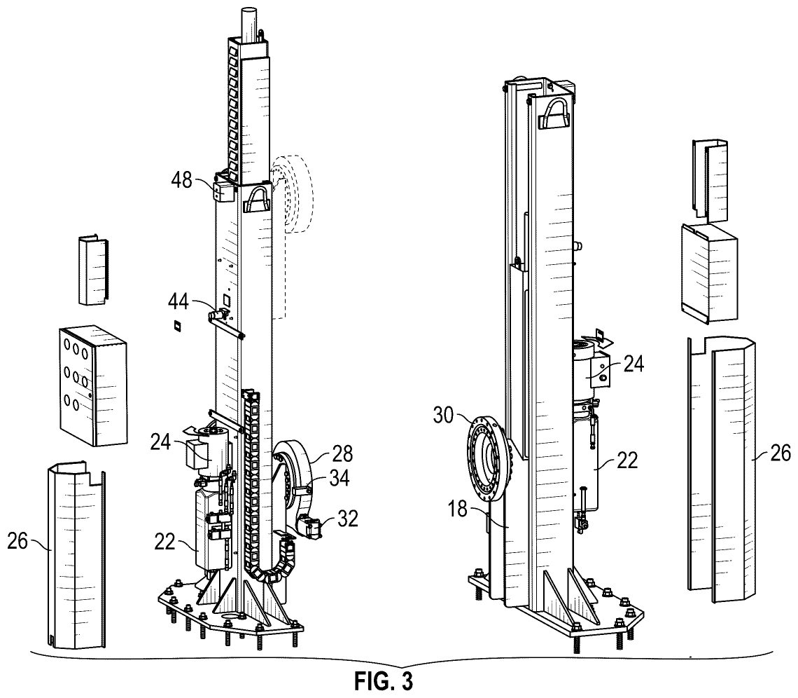

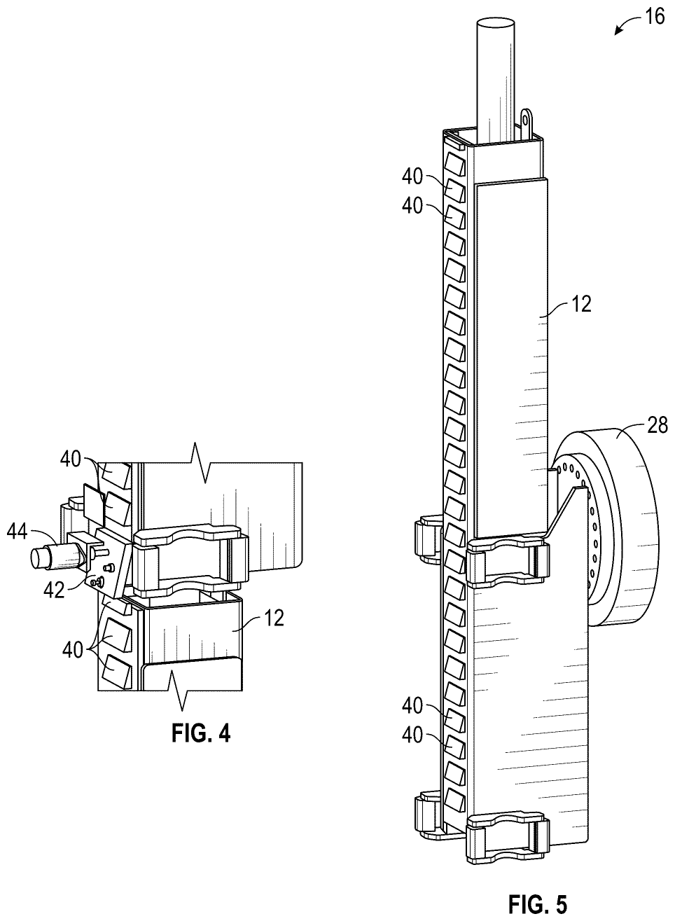

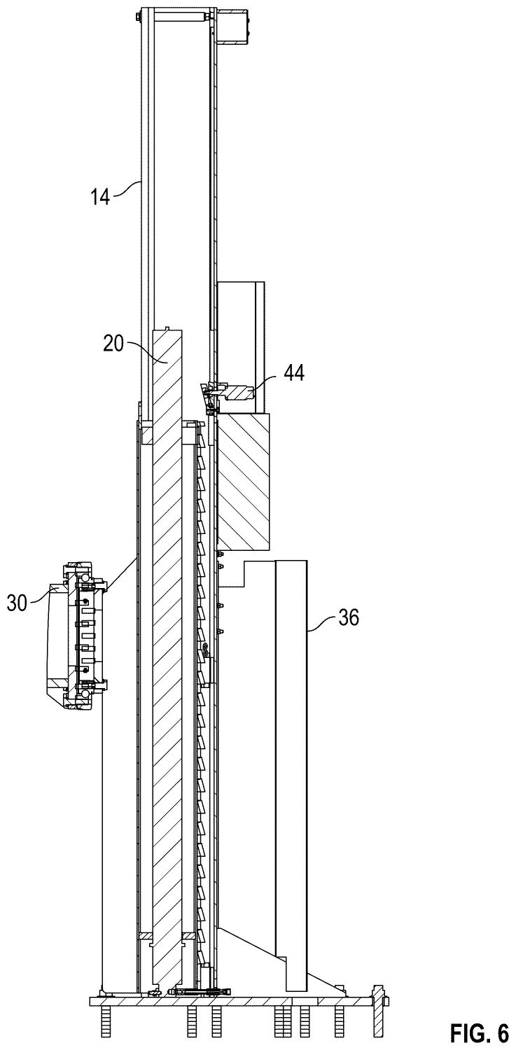

Referring now to the figures, an example embodiment of a positioner 10 is shown in FIGS. 1-6. While FIGS. 1-6 show an example positioner 10, the positioner 10 could be any sort of positioning equipment configured for raising, lowering, tilting, rotating, and/or otherwise moving a work piece. According to some embodiments, the positioner 10 can be used in an industrial and/or manufacturing setting. As shown in FIGS. 1-6, according to some embodiments, the positioner 10 includes a headstock column 12 and a tailstock column 14 which are spaced apart so as to receive a work piece (not shown) between the columns. A work piece, also known as a fixture, can be defined herein as any sort of material capable of being manipulated by positioning equipment for manufacturing purposes. Non-limiting examples of a work piece include, but are not limited to, a piece of metal, glass, plastic, wood, and the like. The headstock column 12 includes a headstock carriage 16, and the tailstock column 14 includes a tailstock carriage 18. Each carriage 16, 18 can be raised and lowered by a hydraulic cylinder 20 mounted within the respective column 12, 14. A fluid reservoir 22 and a hydraulic motor pump 24 is provided on each column 12, 14 for moving the carriages 16, 18. A cover 26 detachably mounts to each column 12, 14 so as to enclose the reservoir 22 and pump 24.

A headstock 28 is rotatably mounted on the headstock carriage 16, and a tailstock 30 is rotatably mounted on the tailstock carriage 18. A hydraulic motor 32 is provided for each of the headstock 28 and tailstock 30 for rotation in clockwise and counterclockwise directions. The headstock 28 and tailstock 30 each include a mounting plate with a slew bearing and a rotary hydraulic slew drive 32 with a self-locking worm drive. A limit switch 34 is operatively connected to each of the headstock 28 and tailstock 30. A flex chain 36 is also provided on each of the columns 12, 14 for management of the various cables of the positioner 10.

One feature of the positioner 10 is the provision of a hard stop for all programmed positions for repeatability. More particularly, the hard stop system includes a plurality of teeth 40 on each column 12, 14, as best shown in FIG. 5. A plate 42 is hinged to each column. A solenoid 44 is operatively connected to each hinge plate 42 and to the PLC (not shown) of the positioner 10.

A further feature of the positioner 10, according to some embodiments, is the use of linear, non-contact, absolute encoders 48 in conjunction with the carriage elevation axes. These encoders 48 have magnetostrictive position sensing.

In operation, the headstock 28 and tailstock 30 can be independently elevated to different programmed positions so as to provide an angular tilt to the work piece supported between the headstock and tailstock. The headstock 28 and tailstock 30 can also be rotated in unison in either the clockwise or counterclockwise directions so as to rotate the work piece.

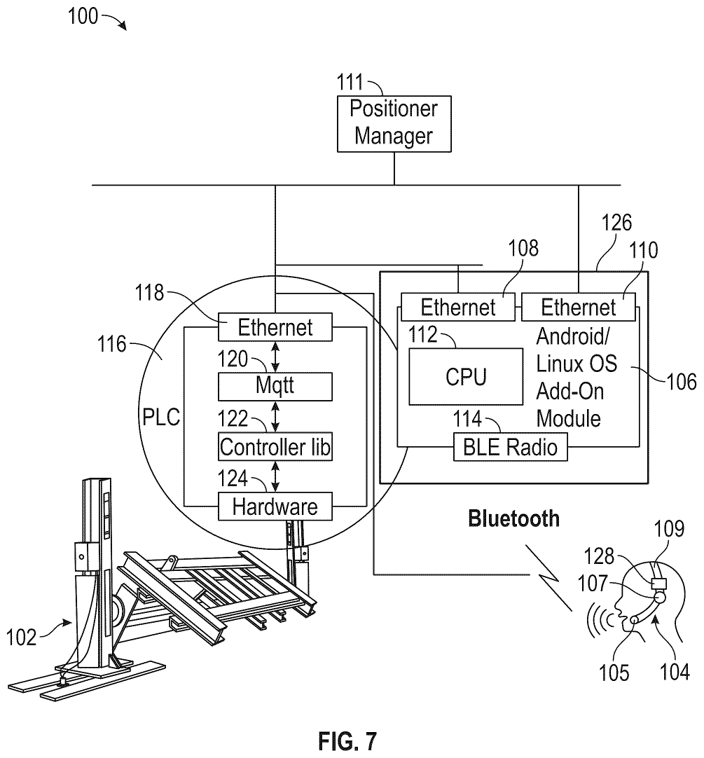

FIG. 7 shows an example system 100 according to some embodiments. The system 100 can comprise a positioner 102 capable of moving one or more work pieces. According to some embodiments, the positioner 102 can be any device, machine, mechanism, and/or equipment capable of moving one or more work pieces such as the positioner 10 described herein. Additionally, according to some embodiments, the positioner 102 can be that disclosed in U.S. Pat. No. 10,280,053, which is hereby incorporated by reference in its entirety.

As shown in FIG. 7, the system 100 can further comprise a hands-free interface device 104. The hands-free interface device 104 can comprise a transducer 105 and/or any other mechanism, device, and/or machine capable of receiving sound and/or any type of audio material and converting that sound and/or audio material into a signal. Such sound and/or audio material could include, but is not limited to, spoken words and/or the voice of a user. According to some embodiments, the hands-free interface device 104 can be and/or comprise a wearable headset wherein the headset comprises the transducer 105 and an auditory mechanism 107, as is shown in FIG. 7. According to some embodiments, the transducer 105 can be and/or comprise a microphone. The auditory mechanism 107 can be and/or comprise any sort of mechanism, device, and/or machine capable of emitting sound. According to some embodiments, the auditory mechanism 107 can comprise, but is not limited to, speaker(s), headphone(s), earpiece(s), and the like. According to some embodiments, the hands-free interface device 104 can be and/or comprise another suitable wearable item other than a headset including, but not limited to, a necklace, armband, wristband, helmet and/or any other suitable wearable item. For embodiments wherein the hands-free interface device 104 comprises a headset comprising a transducer 105 and an auditory mechanism 107, wherein the transducer 105 comprises a microphone and the auditory mechanism 107 comprises speaker(s), headphone(s), and/or earpiece(s), the headset can be configured wherein the transducer/microphone 105 is positioned at and/or near the user's mouth, while the user is wearing the headset, such that the transducer/microphone 105 is effective to substantially receive the user's spoken words and/or voice. The headset can be further configured wherein the auditory mechanism/speaker(s), headphone(s), and/or earpiece(s) 107 are positioned at and/or near one or both of the user's ears, while the user is wearing the headset, such that the auditory mechanism/speaker(s), headphone(s), and/or ear piece(s) 107 are effective to emit sound(s) and/or word(s) wherein the user is able to substantially hear, understand, and/or interpret the emitted sound(s) and/or word(s). Thus, according to some embodiments, a user can wear the hands-free interface device 104 as a headset wherein the hands-free interface device 104 can receive the user's spoken words and/or voice and via the transducer 105, and the hands-free interface device 104 can also emit sound(s) and/or word(s) via the auditory mechanism 107 so that the user is capable of hearing, understanding, and/or interpreting the emitted sound(s) and/or word(s). According to some embodiments, the hands-free interface device 104 can comprise one or two auditory mechanisms 107, wherein the auditory mechanism(s) 107 are positioned at and/or near one or both of the user's ear(s) when the user is wearing the hands-free interface device 104. According to some embodiments, the hands-free interface device 104 can comprise a securing mechanism 109 configured to effectively help secure components of the hands-free interface device 104 to the user's head and/or any other suitable body part. According to some embodiments, the securing mechanism 109 could be and/or comprise a strap, a semi-rigid material, a rigid material, and/or any suitable structure and/or mechanism capable of helping to secure the hands-free interface device 104 to the user.

As shown in FIG. 7, the hands-free interface device 104 can comprise a wearable communication mechanism 128 wherein the wearable communication mechanism 128 is configured to be able to communicate with the AI-enabled intelligence control module 106 (and/or the data communication mechanism 114 thereof), the positioner manager 111, and/or any other aspect of the system 100 or entity external of the system 100. According to some embodiments, the communication mechanism can be and/or comprise a device with Bluetooth capability, Wi-Fi capability, RFID capability, radio capability, ethernet capability, and/or any other capability for wireless and/or wired data communication such that the hands-free interface device 104 can communicate with the AI-enabled intelligence control module 106 and/or other components of the system 100.

As shown in FIG. 7, the system 100 can further include an artificial intelligence (AI)-enabled intelligence control module 106. According to some embodiments, the AI-enabled intelligence control module 106 can comprise software and firmware. While FIG. 7 shows the AI-enabled intelligence control module 106 to include an Android or Linux operating system, the AI-enabled intelligence control module 106 can run on any suitable operating system including, but not limited to, Android, Linux, Windows, iOS, and/or any other suitable commercially available operating system.

As shown in FIG. 7, the AI-enabled intelligence control module 106 may comprise a first ethernet connector 108 and a second ethernet connector 110. According to some embodiments, the AI-enabled intelligence control module 106 can comprise any number of ethernet connectors. The ethernet connectors 108, 110 can comprise any sort of connector and/or connection device such as a port, wire, cable, and the like capable of facilitating an ethernet connection. The ethernet connectors 108, 110 can be configured to connect the AI-enabled intelligence control module 106 to other aspect(s) of the system 100 including, but not limited to, the programmable logic controller (PLC) 116 and/or the positioner manager 111. The ethernet connectors 108, 110 can additionally or alternatively be configured to connect the AI-enabled intelligence control module 106 to one or more entities outside of the system 100 including, but not limited to, the Internet. Alternatively, according to some embodiments, rather than including ethernet connectors 108, 110, the AI-enabled intelligence control module 106 can include any other communication component(s) configured to operatively connect the AI-enabled intelligence control module 106 to other aspect(s) of the system 100 (including, but not limited to, the PLC 116 and/or the positioner manager 111) and/or to entities outside of the system 100 (including, but not limited to, the Internet). Such communication component(s) can include any sort of communication component(s) mentioned herein and/or any sort of communication component(s) capable of data communication via Wi-Fi, Bluetooth, RFID, and/or wired connections.

According to some embodiments, the positioner manager 111 can be operatively connected to multiple positioners 102. Additionally or alternatively, according to some embodiments, the positioner manager 111 can be operatively connected to all positioner(s) 102 within a facility. The positioner manager 111 can be configured to control and/or receive feedback from each positioner 102 to which it is operatively connected. The hands-free interface device 104 and the AI-enabled intelligence control module 106 can be operatively connected to the positioner manager 111 such that the user can verbally interact with the positioner manager 111, via the hands-free interface device 104 and the AI-enabled intelligence control module 106, in order to control multiple positioners 102 via the positioner manager 111 and/or receive feedback from multiple positioners 102. Operation of the positioner manager 111 via the AI-enabled intelligence control module 106 and the hands-free interface device 104 to control multiple positioners 102 and/or receive feedback from multiple positioners 102 can occur in the same manner and/or in a similar manner as controlling a single positioner 102 and/or receiving feedback from a single positioner 102 via the AI-enabled intelligence control module 106 and the hands-free interface device 104 as described herein.

While ethernet is shown in FIG. 7 to be utilized by the AI-enabled intelligence control module 106 to communicate with other aspect(s) of the system 100 and/or with one or more entities external to the system 100, any suitable form of data communication could be used. For example, according to various embodiments, the AI-enabled intelligence control module 106 can include any combination of modem(s), router(s), access point(s), bridge(s), gateway(s), hub(s), repeater(s), switch(es), transceiver(s), and the like in order to facilitate communication. The AI-enabled intelligence control module 106 can be configured to perform data communication wirelessly and/or in a wired fashion. The AI-enabled intelligence control module 106 can include one or more communications ports in addition to and/or alternative to ethernet such as serial advanced technology attachment (“SATA”), universal serial bus (“USB”), or integrated drive electronics (“IDE”), for transferring, sending, receiving, and/or or storing data.

Wireless communication can include, but is not limited to, Bluetooth, Wi-Fi, cellular data, radio waves, satellite, RFID, and/or generally any other form of wireless connection.

Therefore, the AI-enabled intelligence control module 106 and/or any other component(s) of the system 100 can include generally any electronic components necessary to allow for such wireless communication.

Wired communication can take the form of CAN bus, ethernet, co-axial cable, fiber optic line, and/or generally any other device and/or protocol which will allow for wired communication. Therefore, the AI-enabled intelligence control module 106 and/or any other component(s) of the system 100 can include generally any electronic components necessary to allow for such wired communication.

According to some embodiments, the system 100 can utilize a network. Communications through the network can be protected using one or more encryption techniques. For example, the system 100 could be connected to a company network.

As shown in FIG. 7, the AI-enabled intelligence control module 106 can comprise a processing unit 112, denoted as “CPU” in FIG. 7. The processing unit 112 can be any sort of computer processing unit such as a processor. As shown in FIG. 7, the processing unit 112 can be a CPU (central processing unit). Non-limiting examples of processors include a microprocessor, a microcontroller, an arithmetic logic unit (“ALU”), and most notably, a central processing unit (“CPU”).

As shown in FIG. 7, the AI-enabled intelligence control module 106 can comprise a data communication mechanism 114. The data communication mechanism 114 in FIG. 7 is shown to be a Bluetooth Low Energy (BLE) radio. While the data communication mechanism 114 is shown to be a BLE radio in FIG. 7, the data communication mechanism 114 could be and/or comprise any suitable data communication device such as any data communication device capable of performing data communication using any of the communication protocols mentioned herein including, but not limited to, Bluetooth, Wi-Fi, RFID, and/or wired connections. The ability for the data communication mechanism 114 to support various data communication and/or connectivity options ensures compatibility of the system 100 and/or AI-enabled intelligence control module 106 with a wide range of industrial environments and requirements. The data communication mechanism 114 can be configured to connect the AI-enabled intelligence control module 106 to other aspect(s) of the system 100 including, but not limited to, the hands-free interface device 104 such that the hands-free interface device 104, including aspect(s) thereof such as the wearable communication mechanism 128, and the AI-enabled intelligence control module 106, including aspect(s) thereof such as the data communication mechanism 114, are paired, coupled, and/or are otherwise operatively connected. According to some embodiments, the hands-free interface device 104 can automatically pair, couple, and/or otherwise connect with the AI-enabled intelligence control module 106 when powering ON the hands-free interface device 104. When the hands-free interface device 104 is paired, coupled, and/or otherwise connected with the AI-enabled intelligence control module 106, the system 100 is configured to provide a voice message to a user via the hands-free interface device 104 that the hands-free interface device 104 is connected and, according to some embodiments, provide a battery level of the hands-free interface device 104. The data communication mechanism 114 can additionally be configured to connect the AI-enabled intelligence control module 106 to one or more entities outside of the system 100. According to some embodiments, the data communication mechanism 114 and the hands-free interface device 104 are configured to operatively communicate with each other. According to some embodiments, such communication can be performed via any other suitable form of data communication including, but not limited to, Bluetooth, Wi-Fi, RFID, cellular data, ethernet, and the like. According to some embodiments, the data communication mechanism 114 is configured to pair, couple, and/or otherwise connect with the wearable communication mechanism 128.

The AI-enabled intelligence control module 106 can be configured to perform voice-to-text conversion(s) and/or text-to-voice conversion(s). Such voice-to-text conversion(s) and/or text-to-voice conversion(s) can enable text-to-operation functionality and/or status-to-text-to-voice functionality. The AI-enabled intelligence control module 106 can be configured to understand, interpret, and/or translate the speech and/or voice data received by the hands-free interface device 104 and sent to the data communication mechanism 114. Thus, when an operator speaks, the operator's voice can be received via the hands-free interface device 104 wherein the voice data can be communicated to the AI-enabled intelligence control module 106. The AI-enabled intelligence control module 106 can include internal, built-in software that understands, interprets, and/or translates the voice data. For example, the software of the AI-enabled intelligence control module 106 can perform the voice-to-text conversion(s). The AI-enabled intelligence control module 106 can convert the voice data to a machine-readable language and/or to a communication protocol such as MQTT (i.e., MQ Telemetry Transport/Message Queue Telemetry Transport). The machine-readable language and/or communication protocol can then be sent from the AI-enabled intelligence control module 106 to the PLC 116 and/or the positioner 102 to control precise action(s) of the positioner 102. Such action(s) can be executed by the positioner 102 in real time. In this way, an operator can issue voice commands using the hands-free interface device 104 that are translated via the AI-enabled intelligence control module 106, and the translation(s) are then used by the PLC 116 and/or positioner 102 to control the positioner 102. It is appreciated that the software used by the AI-enabled intelligence control module 106, which can include the use of AI as described herein, to perform voice-to-text conversion(s) and/or text-to-voice conversion(s) can operate effectively with any language, English or otherwise, as well as various dialects, accents, and the like. Additionally, the software of the AI-enabled intelligence control module 106 is configured to be able to translate to and from any desired language as specified by the operator.

Thus, the system 100 allows for an operator to control the positioner 102 via voice commands in a hands-free manner. In this way, the user can engage in a voice conversation with the AI-enabled intelligence control module 106. This hands-free approach increases safety by reducing the need for physical contact with machinery and improves efficiency by enabling continuous operation without interruptions for manual control adjustments. Since an operator can control the positioner 102 using only the operator's voice, the need for manual adjustments is effectively eliminated and/or reduced. This hands-free approach also allows an operator to maintain focus on the manufacturing task rather than, perhaps, being distracted by needing to make a manual adjustment to the positioner 102.

The AI-enabled intelligence control module 106 can comprise one or more non-transitory computer readable media and/or any other suitable memory to store executable instructions of the AI-enabled intelligence control module's 106 software used to perform voice-to-text and/or text-to-voice conversion(s). The processing unit 112 can be operatively connected to the non-transitory computer readable medium and/or other memory and can be configured to execute said executable instructions.

In general, the software of the AI-enabled intelligence control module 106 may, when loaded and/or executed by the processing unit 112, transform the AI-enabled intelligence control module 106 from a general-purpose computing system into a special-purpose computing system customized to facilitate the method(s) and/or system(s) described herein.

The software of the AI-enabled intelligence control module 106 that is configured to understand, interpret, and/or translate the voice data and/or text data can be integrated with artificial intelligence (AI). According to some embodiments, the software of the AI-enabled intelligence control module 106 can utilize AI, can be trained using AI, and/or can integrate AI in any suitable fashion that enable(s) and/or improves the voice-to-text conversion(s) and/or text-to-voice conversion(s) to enable text-to-operation functionality and/or status-to-text-to-voice functionality. AI can be used such that the AI-enabled intelligence control module 106 continuously improves voice-to-text conversion(s) and text-to-voice conversion(s) so that text-to-operation functionality and status-to-text-to-voice functionality improves. According to some embodiments, the AI can utilize machine learning and/or deep learning. The AI can be trained to focus on and/or be directed to the command structure of moving and interfacing with positioner(s) 102. In this way, the scope of translation for the AI can be more focused. By narrowing the scope of the translation, the AI is able to interact with the positioner 102 quicker and execute commands to the positioner 102 quicker.

The AI-enabled intelligence control module 106 can be configured to not only use AI for voice-to-text conversion but also for interpreting the voice command from the operator. According to some embodiments, the AI-enabled intelligence control module 106 can perform voice-to-text conversion and/or interpretation of the voice command from the operator in order to leverage the positioner manager 111 to perform a task and/or action involving multiple positioners 102 within a facility and/or to perform a task and/or action at a facility-wide level. The AI-enabled intelligence control module 106 is configured to then communicate with the positioner 102 and/or the positioner manager 111, leveraging MQTT, and/or any other type of machine-readable language and/or communication protocol, to execute action(s) and retrieve status update(s).

For voice-to-text and text-to-voice conversion(s), the AI-enabled intelligence control module 106 can have the built-in capability to perform such conversion(s). Additionally or alternatively, according to some embodiments, the AI-enabled intelligence control module 106 can use the Internet to perform such conversion(s). As an example, the AI-enabled intelligence control module 106 could use a SIM card to access the Internet to perform such conversions. Additionally or alternatively, according to some embodiments, the AI-enabled intelligence control module 106 could utilize any suitable manner of accessing the Internet including, but not limited to, Wi-Fi, ethernet, and the like.

As shown in FIG. 7, the system 100 can include a PLC 116. The PLC 116 can be associated with the positioner 102 such that the PLC 116 can effectively control the positioner 102. The PLC 116 can be any suitable type of controller capable of controlling the positioner 102. According to some embodiments, the PLC 116 can be part of the positioner 102 and can be used to facilitate function(s) of the positioner 102. The hands-free interface device 104 and the AI-enabled intelligence control module 106 can be operatively connected to the PLC 116 to execute commands. According to some embodiments, the PLC 116 can be a ruggedized computer and/or computing device. According to some embodiments, the PLC 116 can include the same as and/or similar cyberinfrastructure as the AI-enabled intelligence control module 106 including component(s) such as memory, software, an operating system, and the like.

According to some embodiments, the PLC 116 can include internal, built-in software and/or hardware, and/or hardware adjacent to the PLC 116 that is controlled by the PLC 116 such as the hardware 124 shown in FIG. 7, that can operate in conjunction with the software of the AI-enabled intelligence control module 106 to control the positioner 102 based on the translated machine-readable language and/or communication protocol 120 and the controller library 122. The internal software and/or hardware of the PLC 116 and/or hardware 124 adjacent to the PLC 116 can also operate in conjunction with the AI-enabled intelligence control module 106 to provide feedback and/or alert(s) to an operator. The alert(s) can also be referred to as alarm(s).

As shown in FIG. 7, the PLC 116 can comprise an ethernet connector 118. According to some embodiments, the PLC 116 can comprise more than one ethernet connector. The ethernet connector 118 can be the same as and/or similar to the ethernet connectors 108, 110, and/or could comprise any suitable type of connector capable of forming an ethernet connection. Alternatively, according to some embodiments, rather than including ethernet connector 118, the PLC 116 can include any other communication component(s) configured to operatively connect the PLC 116 to other aspect(s) of the system 100 (including, but not limited to, the AI-enabled intelligence control module 106 and/or the positioner manager 111) and/or to entities outside of the system 100 (including, but not limited to, the Internet). Such communication component(s) can include any sort of communication component(s) mentioned herein and/or any sort of communication component(s) capable of data communication via Wi-Fi, Bluetooth, RFID, and/or wired connections. According to some embodiments, the PLC 116 can be operatively connected to the AI-enabled intelligence control module 106 via a combination of the ethernet connectors 108, 110, 118, and/or any other suitable type of communication protocol such as Bluetooth, Wi-Fi, RFID, and the like. According to some embodiments, the AI-enabled intelligence control module 106 can be bolted on to the PLC 116 and/or to the positioner 102. After translating voice data to a machine-readable language and/or communication protocol, such as MQTT, the AI-enabled intelligence control module 106 can then send the machine-readable language and/or communication protocol to the PLC 116 via ethernet connection and/or any other suitable type of connection. Also, when the system 100 is providing feedback and/or alert(s) to an operator, the PLC 116 can be configured to send textual data, such as a machine-readable language and/or communication protocol like MQTT to the AI-enabled intelligence control module 106 via ethernet connection and/or any other suitable connection wherein the AI-enabled intelligence control module 106 can translate the textual data to voice data and present it audibly to an operator.

As shown in FIG. 7, the PLC 116 can integrate the received machine-readable language and/or communication protocol (e.g., MQTT) 120 with a controller library 122. The PLC 116 can use the machine-readable language and/or communication protocol 120 in combination with the controller library 122 to control the positioner 102 and cause the positioner 102 to perform necessary and/or desired actions. For example, the controller library 122 can comprise a plurality of function(s) and/or action(s) used to control the positioner 102. Such function(s) and/or action(s) could include causing the positioner 102 to move a work piece as well as many other types of function(s) and/or action(s). Such movement of a work piece could include raising, lowering, and/or rotating the work piece. The PLC 116 is configured to select the proper function(s) and/or action(s) from the controller library 122 to send to the positioner 102 based on the machine-readable language and/or communication protocol 120 as well as select the manner in which such function(s) and/or action(s) are performed such as the sequence of such function(s) and/or action(s), the amount of time spent performing each function and/or action, and the like. Thus, the machine-readable language and/or communication protocol 120 dictates what actions are performed by the positioner 102. The voice data from the operator dictates the machine-readable language and/or communication protocol 120 that is sent from the AI-enabled intelligence control module 106 to the PLC 116. In this way, the operator can control and/or dictate the action(s) of the positioner 102 via voice commands. According to some embodiments, the PLC 116 can interface with hardware 124 that is adjacent to the PLC 116 and that aids in controlling the positioner 102 via the machine-readable language and/or communication protocol 120. The adjacent hardware 124 can include any suitable hardware capable of and/or necessary for controlling a positioner 102 and/or any hardware capable of and/or necessary for communicating with the positioner 102. According to some embodiments, the adjacent hardware 124 controlled by the PLC 116, and operatively connected to the PLC 116, can include, but is not limited to, a safety controller (such as a Keyence safety controller), safety scanner(s) (such as Keyence safety scanner(s)), various valves(s), various solenoid(s), and/or various switch(es) that enable functionality of the positioner 102 that is controlled by the PLC 116.

According to some embodiments, the system 100 can be configured to provide feedback to an operator, wherein said feedback can be vocal, audio feedback such that a user can receive the feedback via the hands-free interface device 104. The feedback can comprise one or more status condition(s) of the positioner 102 and/or component(s) thereof. For example, the feedback can comprise one or more of a “ready to move” signal, a move command signal, a fault signal comprising identification of a fault and information regarding how to rectify the fault; and/or a confirmation signal regarding command execution. A ready to move signal can indicate that the positioner 102 and/or component(s) thereof are ready to receive a command and/or instruction and/or are ready to move in terms of being ready to perform an action. A move command signal can indicate that at least one aspect of the positioner 102 is in motion and/or in action. The identification of a particular fault could include a fault code. A fault could comprise any issue and/or anything unusual regarding operation such as an occurrence of an overvoltage above a particular threshold, an occurrence of an undervoltage below a particular threshold, an occurrence of electric current over a particular threshold, an occurrence of electric current under a particular threshold, an obstruction and/or blockage during operation, a component of the positioner being too damaged to function and/or needing replacement, a disrupted connection between any component(s) of the system 100, and the like. A confirmation signal regarding command execution can comprise an indication that execution of a particular command has been completed.

According to some embodiments, the positioner 102 and/or other component(s) of the system 100 can include one or more sensor(s) to measure and/or monitor component(s) of the system 100 and/or aspect(s) of operation thereof. The one or more sensor(s) can be used to detect, sense, and/or recognize status conditions of component(s) of the system 100 and/or operation thereof. The one or more sensors can contribute to the feedback. According to some embodiments, the one or more sensors can include one or more of the following: vision sensor(s), radar sensor(s), LIDAR sensor(s), heat sensor(s), moisture content sensor(s), fluid level sensor(s), rotational sensor(s), position sensor(s), gyroscope(s), radio frequency sensor(s), short-range radio(s), long-range radio(s), antenna(e), voltmeter(s), ammeter(s), and the like.

Such feedback can be delivered audibly via the hands-free interface device 104 and/or visually via a human machine interface (HMI), which can be included as part of the system 100 according to some embodiments. The HMI can be any sort of device and/or mechanism that allows a user to provide visual input to and/or allows a user to receive visual output from a machine such as a display, computer, and/or computing device. In instances wherein the feedback is delivered audibly, the AI-enabled intelligence control module 106 can be used to perform one or more text-to-voice conversion(s) which enables the status-to-text-to-voice functionality. For example, feedback regarding the status of the positioner 102 and/or other portions of the system 100 can be sent to the AI-enabled intelligence control module 106 via text such as via MQTT and/or any machine-readable language, communication protocol, and/or other text format, wherein the AI-enabled intelligence control module 106 converts the text into voice. The AI-enabled intelligence control module 106 can utilize AI for such conversion. The voice data can then be sent to the hands-free interface device 104 wherein the voice data is audibly emitted via the hands-free interface device 104 for the operator to hear. Additionally or alternatively, according to some embodiments, the feedback can be presented visually via the HMI in real time and/or in substantially real time.

It is appreciated that the AI utilized by the system 100 and/or the AI-enabled intelligence control module 106 for the voice-to-text and/or text-to-voice conversion(s) can be integrated generative AI and/or can be advanced AI. The use of AI enhances the system's 100 responsiveness and adaptability to complex commands and/or instructions and helps to provide real-time status updates in a user-friendly manner.

It is appreciated that the AI-enabled intelligence control module 106 can be configured to be able to be included in any original or new positioning equipment, or alternatively, to be retrofit to any existing positioning equipment regardless of brand or model in order to be able to provide the voice-activated control of the positioning equipment in a hands-free manner. Thus, the AI-enabled intelligence control module 106 is configured to be versatile and substantially universally compatible with existing positioning and/or welding equipment. Thus, the AI-enabled intelligence control module 106 can be applicable to different industrial settings and requirements. Such universal compatibility increases accessibility to voice-activated control and reduces the need for new equipment purchases. Additionally, the AI-enabled intelligence control module 106 is configured such that it can be quickly and easily installed on and/or integrated into existing machinery without significant modifications. This serves to minimize downtime and disruption to operations and also facilitates quick integration into current workflows. This ease of integration encourages adoption, as businesses can upgrade their capabilities without significant interruption to their production schedules. Further, by being compatible with existing equipment such that existing machines can be upgraded rather than replaced, the system 100 and/or AI-enabled intelligence control module 106 serves to extend the life of existing equipment by adding modern functionalities and serves to reduce waste and environmental impact associated with manufacturing and disposing of industrial equipment. Thus, the system 100 and/or AI-enabled intelligence control module 106 supports sustainable, eco-friendly practices, at least in part, by reducing unnecessary equipment turnover.

Being able to retrofit the AI-enabled intelligence control module 106 to existing machinery provides even further benefits. For example, the AI-enabled intelligence control module 106 improves cost efficiency. By being able to incorporate the AI-enabled intelligence control module 106 with existing machinery, the apparatus(es), system(s), and/or method(s) described herein become accessible to a wider range of businesses, including smaller operations that may not have the budget for brand new, state-of-the-art equipment. This makes the apparatus(es), system(s), and/or method(s) described herein a cost-effective solution for improving safety and productivity.

Also, being able to integrate the AI-enabled intelligence control module 106 with existing machinery in a modular fashion allows for scalable implementations where businesses can start with a single unit to test and evaluate the benefits before committing to a full-scale rollout. In other words, the system 100 and/or AI-enabled intelligence control module 106 could be implemented on a single machine and/or could be scaled up to include multiple machines within a facility. This scalability makes the system 100 and/or AI-enabled intelligence control module 106 adaptable and/or flexible to the evolving needs and capacities of different operations such as budget and/or operational concerns and/or needs.

The independent and/or modular design, according to some embodiments, allows for easy updates and the addition of new commands and/or features. The modularity of the AI-enabled intelligence control module 106 also facilitates future enhancements and customization without extensive re-engineering. Further, the system 100 and/or AI-enabled intelligence control module 106 can be programmed with custom commands to fit specific operational needs and/or preferences. For example, the system 100 and/or AI-enabled intelligence control module 106 can be programmed such that a specific word and/or phrase spoken by an operator can trigger the system 100 and/or positioner 102 to perform a particular action. Such customizability of the commands ensures adaptability to different working environments and user requirements.

According to some embodiments, the system 100, and aspects thereof such as the AI-enabled intelligence control module 106, are configured to understand the following commands and take proper action based on each command: voice commands ON; voice commands OFF; start auto mode; auto mode stop; pause auto mode; park positioner 102 or rest on safety pawl; next step; previous step; clear alarms; stop positioner 102; elevate, lift, raise, or lower positioner 102, headstock, or tailstock a desired number of inches; tilt clockwise, counterclockwise, or shortest path a desired number of degrees; a positioner with a second rotator is required (such as a Skyhook and/or Backbone); and rotate clockwise, counterclockwise, or shortest path a desired number of degrees. While the system 100, including the AI-enabled intelligence control module 106, is able to understand and take action based on the following commands, the system 100, including the AI-enabled intelligence control module 106, can be customized to be able to receive, understand, and take action regarding additional commands. According to some embodiments, in order for the system 100, including the AI-enabled intelligence control module 106, to understand and take action regarding a voice command, a user must say “machine” before delivering the voice command.

When the system 100, or aspect thereof such as the AI-enabled intelligence control module 106, receives a voice commands ON command, the system 100 is configured to take action such that the system 100 is capable and ready to receive voice commands, such as from a user.

When the system 100, or aspect thereof such as the AI-enabled intelligence control module 106, receives a voice commands OFF command, the system 100 is configured to take action such that the system 100 does not receive voice commands and/or does not take action regarding voice commands. When voice commands are OFF, a user may not interact with the system 100 via voice commands and must interact with the system 100 in another manner such as via an HMI or another manner.

When the system 100, or aspect thereof such as the AI-enabled intelligence control module 106, receives a start auto mode command, the system 100 is configured to take action to initiate and/or start an automatic mode of operation. According to some embodiments, the automatic mode of operation can include automated workflows as noted herein.

When the system 100, or aspect thereof such as the AI-enabled intelligence control module 106, receives an auto mode off command, the system 100 is configured to take action to end automatic mode of operation.

When the system 100, or aspect thereof such as the AI-enabled intelligence control module 106, receives a pause auto mode command, the system 100 is configured to take action to pause automatic mode of operation.

When the system 100, or aspect thereof such as the AI-enabled intelligence control module 106, receives a park positioner 102 or rest on safety pawl command, the system 100 is configured to take action to place the positioner 102, and/or aspect(s) thereof such as a load, in a safe, secure, and stable position such as resting on the safety pawl. According to some embodiments, this command can extend to additional machinery other than the positioner 102.

When the system 100, or aspect thereof such as the AI-enabled intelligence control module 106, receives a next step command, the system 100 is configured to take action to proceed to the next step of a task and/or to proceed to the next task in a queue of tasks.

When the system 100, or aspect thereof such as the AI-enabled intelligence control module 106, receives a previous step command, the system 100 is configured to take action to proceed to the previous step of a task and/or to proceed to the previous task in a queue of tasks.

When the system 100, or aspect thereof such as the AI-enabled intelligence control module 106, receives a clear alarms command, the system 100 is configured to take action to clear any alarms and/or alerts that the system 100 is or has exhibited and/or stored.

When the system 100, or aspect thereof such as the AI-enabled intelligence control module 106, receives a stop positioner 102 command, the system 100 is configured to take action to stop operation and/or movement of the positioner 102, and/or any aspect(s) thereof such as a load. According to some embodiments, this command can extend to additional machinery other than the positioner 102.

When the system 100, or aspect thereof such as the AI-enabled intelligence control module 106, receives a command to elevate, lift, raise, or lower the positioner 102, headstock, or tailstock a desired number of inches, the system 100 is configured to take action to elevate, lift, raise, or lower the positioner 102, headstock, or tailstock said desired number of inches. According to some embodiments, this command can extend to additional machinery other than the positioner 102.

Further, it is appreciated that the system 100, including the AI-enabled intelligence control module 106, is configured such that a user can provide a command to move an aspect of the positioner 102 based on incremental motion rather than based on moving said aspect to a particular point. For example, the system 100, including the AI-enabled intelligence control module 106, is configured such that a user can provide a command to lift the headstock up 5 inches, wherein the positioner 102 is configured to lift the headstock 5 inches higher than its current position prior to the user issuing the command. In other words, a user can provide a command to lift the headstock up 5 inches relative to its current position rather than a command to lift the headstock to, for example, 25 inches above the ground. While lifting is used as an example in conjunction with the headstock, any aspect of the positioner 102 or other machinery could be moved in any way including, but not limited to, lifted, lowered, tilted, rotated, and the like, based on incremental motion. According to some embodiments, the system 100, including the AI-enabled intelligence control module 106, is additionally or alternatively configured to receive and take action based on movement commands regarding a particular point. For example, a user could provide a command to lift the headstock 25 inches above the ground, and the system 100, including the AI-enabled intelligence control module 106, would then perform the movement. Again, while lifting in conjunction with the headstock is used as an example, any aspect of the positioner 102 or other machinery could be moved in any way including, but not limited to, lifting, lowering, tilting, rotating, and the like, based on an command regarding a particular point.

When the system 100, or aspect thereof such as the AI-enabled intelligence control module 106, receives a command to tilt clockwise, counterclockwise, or based on a shortest path (if no direction is specified) a desired number of degrees, the system 100 is configured to take action to tilt clockwise, counterclockwise, or based on a shortest path the positioner 102, headstock, tailstock, load, or other piece of machinery said desired number of degrees. According to some embodiments, the shortest path is the default setting. For example, when a user does not specify direction of tilt, the system 100, or aspect thereof such as the AI-enabled intelligence control module 106, can default to the shortest path.

When the system 100, or aspect thereof such as the AI-enabled intelligence control module 106, receives a command that a positioner with a second rotator is required, the system 100, or aspect thereof such as the AI-enabled intelligence control module 106, is configured to utilize a positioner with a second rotator when performing task(s) and/or alert a user that a positioner with a second rotator is required. According to some embodiments, the positioner with a second rotator can be a 3-axis positioner. According to some embodiments, the positioner with a second rotator can be a Skyhook and/or Backbone. As used herein, the term “Skyhook” refers to the Elevating Skyhook Positioner produced by ALM Positioners, Inc. As used herein, the term “Backbone” refers to the Drop Center/Headstock & Tailstock Positioner produced by ALM Positioners, Inc. Both the Skyhook and Backbone are 3-axis positioners.

When the system 100, or aspect thereof such as the AI-enabled intelligence control module 106, receives a command to rotate clockwise, counterclockwise, or based on a shortest path a desired number of degrees, the system 100, or aspect thereof such as the AI-enabled intelligence control module 106, is configured to take action to rotate clockwise, counterclockwise, or based on a shortest path the positioner 102, headstock, tailstock, load, or other piece of machinery said desired number of degrees. According to some embodiments, the shortest path is the default setting. For example, when a user does not specify direction of rotation, the system 100, or aspect thereof such as the AI-enabled intelligence control module 106, can default to the shortest path.

According to some embodiments, the AI-enabled intelligence control module 106 can include an industrial enclosure 126 as shown in FIG. 7. The industrial enclosure 126 can be any sort of structure effective to substantially protect the electronics of the AI-enabled intelligence control module 106 from industrial conditions including, but not limited to, dust, heat, vibration, and the like. For example, the industrial enclosure 126 could be any sort of rigid and/or semi-rigid box, case, compartment, casket, tub, and the like. According to some embodiments, the industrial enclosure 126 can be water-resistant and/or waterproof. The industrial enclosure 126 can ensure that the AI-enabled intelligence control module 106 has appropriate connectors for power and data communication. The industrial enclosure 126 can further ensure that such connectors for power and data communication are substantially protected from industrial conditions. According to some embodiments, the industrial enclosure 126 can serve as a housing for the AI-enabled intelligence control module 106, wherein the AI-enabled intelligence control module 106 can be housed, at least partially, within the industrial enclosure 126.

According to some embodiments, the system 100 and/or AI-enabled intelligence control module 106 can comprise built-in safety protocols to prevent accidental activation and/or misuse. These built-in safety protocols provide an additional layer of safety for operators. These built-in safety protocols can comprise verbal communication, via the AI-enabled intelligence control module 106 and the hands-free interface device 104 as described herein, wherein the verbal communication can include potential faults. Such a verbally communicated fault can refer to any sort of fault mentioned herein. Such a verbally communicated fault can include verbal communication stating “safety scanner tripped” and/or any other sort of verbal communication. The AI-enabled intelligence control module 106 and the hands-free interface device 104 can work in conjunction to react to particular commands from a user as a safety override. For example, when a user verbally communicates the word “stop”, and/or any synonym thereof, the system 100 can be configured to stop and/or halt whatever action and/or motion of the positioner 102 is in progress and place the positioner 102 in a fault that will need to be reset prior to beginning operations again. Another built-in safety protocol is that the hands-free interface device 104 and/or the AI-enabled intelligence control module 106 can be configured to only receive, recognize, and/or pick up the voice of the user who is speaking directly into the hands-free interface device 104. Thus, any conversations from others occurring near the user interacting with the hands-free interface device 104 will not accidently cause the machine to move or otherwise perform an unwanted action.

According to some embodiments, the system 100 and/or AI-enabled intelligence control module 106 provides ongoing technical support and provides updates to ensure the system 100 and/or AI-enabled intelligence control module 106 remains effective and up-to-date. The continuous technical support and updates ensure the long-term reliability and performance of the system 100 and/or AI-enabled intelligence control module 106. Such technical support and updates can be communicated audibly to an operator via the hands-free interface device 104. According to some embodiments, such technical support and updates can be conducted via technical field service technicians on an as needed basis.

According to some embodiments, the system 100 can comprise a software application that allows an operator to create a profile and login to the system 100. The software application could be deployed as a mobile application, a desktop application, and/or a web application. According to some embodiments, the system 100 can allow an operator to login to the system 100 verbally via the hands-free interface device 104 and/or login via the HMI described herein.

According to some embodiments, the system 100 and/or AI-enabled intelligence control module 106 allows for an operator to engage in verbal conversation(s) with the system 100 and/or AI-enabled intelligence control module 106. Such verbal conversation(s) can involve problem solving support including, but not limited to, topics such as troubleshooting issues, seeking help, receiving guidance, and/or enhancing the efficiency of problem resolution. Such verbal conversation(s) regarding problem solving support can help to provide faster resolution of issues as well as improve ease of use. Additionally or alternatively, according to some embodiments, such verbal conversation(s) can involve task management support including, but not limited to, topics such as inquiring about scheduled tasks, checking pending items, communicating with a manager, and/or streamlining workflow and/or coordination. Such verbal conversation(s) regarding task management support can help to provide configurable and automated workflows. These verbal and/or auditory conversation(s) between an operator and the system 100 can be conducted via the hands-free interface device 104 and the AI-enabled intelligence control module 106. The operator can engage the system 100 by asking a question such as “what is the active fault code?”, “how should I troubleshoot this fault?”, and/or “how many more steps are in this program?”. The operator can also engage the system 100 by stating an assertion. The hands-free interface device 104 can receive the operator's voice question(s) and/or statement(s) and send the voice data to the AI-enabled intelligence control module 106 wherein voice-to-text conversion(s) are applied as described herein. The system 100 can understand and interpret the operator's question(s) and/or statement(s) and provide a response to the AI-enabled intelligence control module 106. The module can then perform text-to-voice conversion(s) as described herein wherein the system's 100 response is communicated to the operator verbally and/or audibly via the hands-free interface device 104. In this way, an operator can engage in conversation with the system 100 in a hands-free manner wherein said conversation is completely verbal and/or auditory. Being able to engage in conversation with the system 100 allows for faster resolution of issues and ease of use as well as configurable and automated workflows. According to some embodiments, the operator must login to the system 100 before engaging in conversation with the system 100.

Based on the present disclosure, the verbal, voice communication between an operator and the system 100 allows the system 100 to be fully operational without the need for a handheld HMI or any other type of HMI.

According to some embodiments, the system 100 allows an operator to personalize and/or customize aspect(s) of the system 100. For example, an operator can set preferences. According to some embodiments, upon an operator logging into the system 100, via an HMI or any other suitable manner, aspect(s) of the system 100 including, but not limited to, the hands-free interface device 104, AI-enabled intelligence control module 106, PLC 116, and/or positioner 102 can automatically adjust based on the operator's preferences. Such preferences can be predefined in the software application that allows an operator to create a profile and login to the system 100. This allows for an operator to have a personalized experience, which increases usability and leads to increased efficiency. Additionally or alternatively, according to some embodiments, aspect(s) of the system 100 including, but not limited to, the hands-free interface device 104, AI-enabled intelligence control module 106, PLC 116, and/or positioner 102 can automatically adjust to the settings of the operator's last usage upon the operator logging into the system 100.

According to some embodiments, the system 100 can provide real-time alerts and/or notifications to the operator(s) regarding anything related to the system 100 and/or aspect(s) thereof including, but not limited to, machine status, maintenance needs, safety warnings, and the like. Such alerts and/or notifications can enhance situational awareness, leading to increased efficiency and safety. Such alerts can be presented visually via the HMI described herein and/or can be presented verbally/audibly via the hands-free interface device 104. When the system 100 recognizes a status, condition, and/or situation that triggers an alert, the system 100 can engage in text-to-speech conversion via the AI-enabled intelligence control module 106 in order to communicate that alert to an operator via the hands-free interface device 104 verbally/audibly. According to some embodiments, alert(s) can be detected, sensed, and/or recognized by the same and/or similar sensor(s) used to provide feedback.

According to some embodiments, the system 100 and/or AI-enabled intelligence control module 106 can be configured for other industrial equipment and/or machinery beyond positioning equipment. In such embodiments, the positioner 102 can be replaced with any suitable type of industrial equipment and/or machinery. Thus, the utility and applicability of the system 100 can be maximized across different tools and processes.

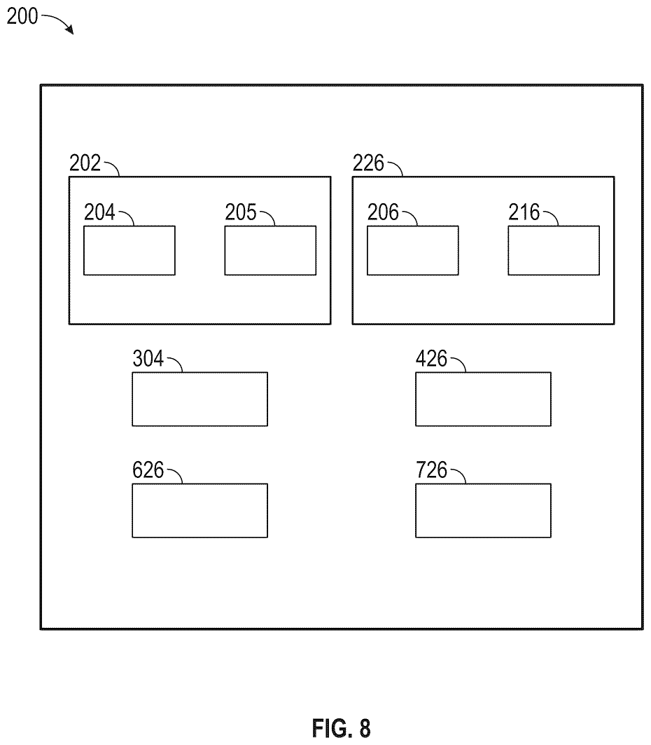

FIG. 8 shows a block diagram of a system 200 according to some embodiments of the present disclosure. As shown in FIG. 8, the system 200 can comprise a positioner 202. The positioner 202 can be the same as and/or similar to either of the positioner 10 and/or the positioner 102. Further, as shown in FIG. 8, the positioner 202 can comprise a headstock portion 204 and a tailstock portion 205. The headstock portion 204 can comprise and/or be the same as and/or similar to corresponding headstock elements of the either the positioner 10 and/or the positioner 102. The headstock portion 204 can comprise any elements related to the headstock and/or control thereof. The tailstock portion 205 can comprise and/or be the same as and/or similar to corresponding tailstock elements of the either the positioner 10 and/or the positioner 102. The tailstock portion 205 can comprise any elements related to the tailstock and/or control thereof.

As shown in FIG. 8, the system 200 can comprise an industrial enclosure 226, and associated control panel, relating to voice control of components of the system 200. According to some embodiments, the industrial enclosure 226 can include an AI-enabled intelligence control module 206 and a PLC 216. The AI-enabled intelligence control module 206 can be the same as and/or similar to the AI-enabled intelligence control module 106. The PLC 216 can be the same as and/or similar to the PLC 116. According to some embodiments, the PLC 216 is not located in the enclosure 226.

As shown in FIG. 8, the system 200 can comprise a hands-free interface device 304. According to some embodiments, the hands-free interface device 304 can be the same as and/or similar to the hands-free interface device 104.

As shown in FIG. 8, the system 200 can comprise an industrial enclosure 426, and associated control panel, relating to a main control panel; an industrial enclosure 626, and associated control panel, relating to controlling the tailstock portion 205 of the positioner 202; and an industrial enclosure 726, and associated control panel, relating to controlling an external hydraulic power unit (HPU).

According to some embodiments, any components and/or aspects of the system 100 can be included in the system 200 and vice versa. In other words, elements of the system 100 and the system 200 can be combined, replaced, and/or interchanged with each other. The system 200 can be configured to provide the same capabilities and functionality as described herein with reference to the system 100.

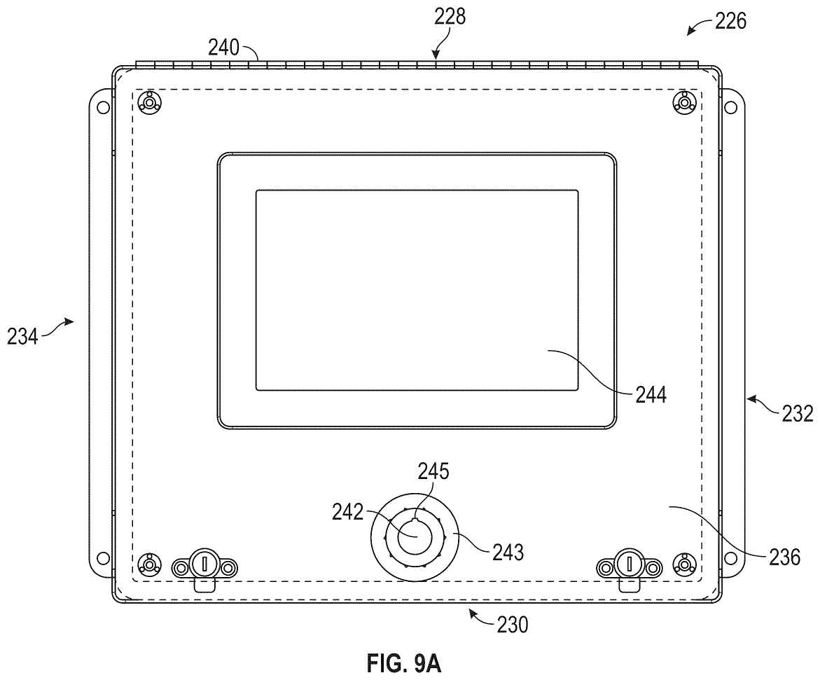

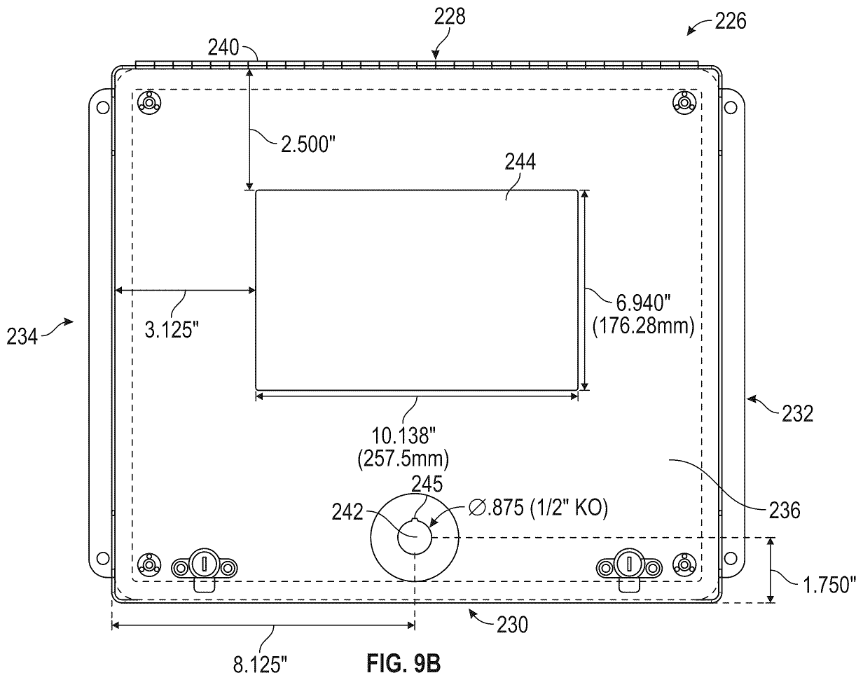

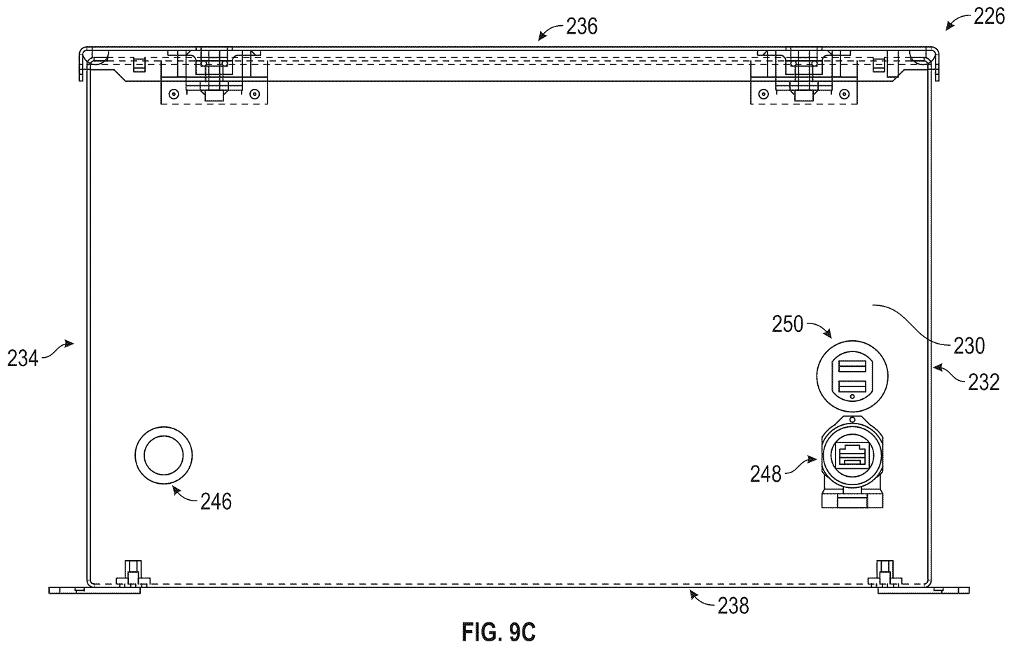

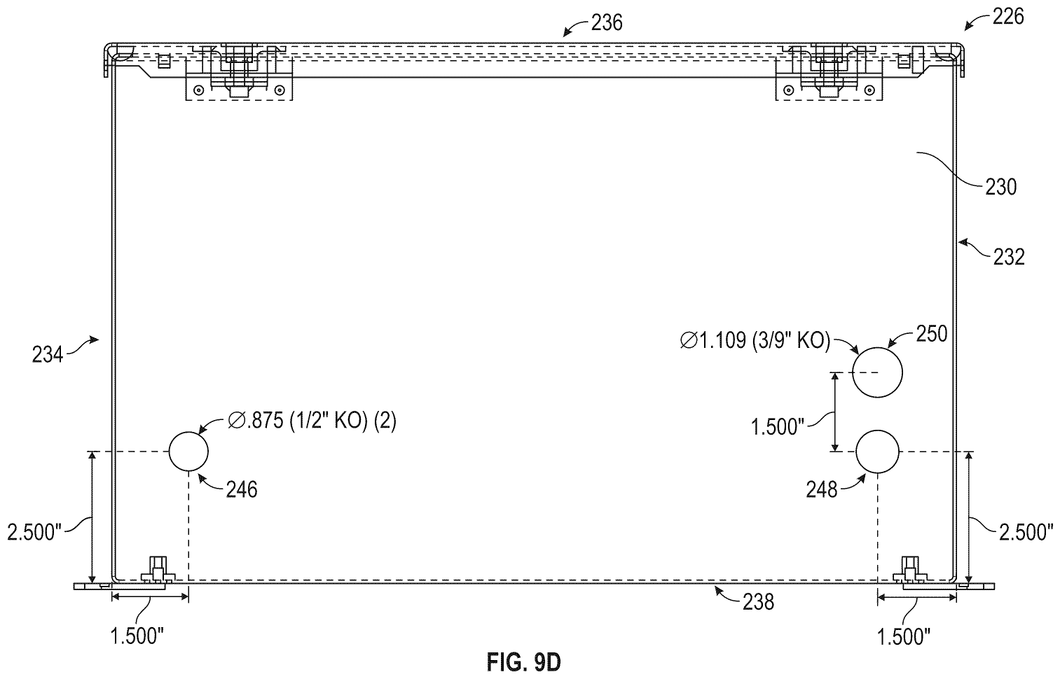

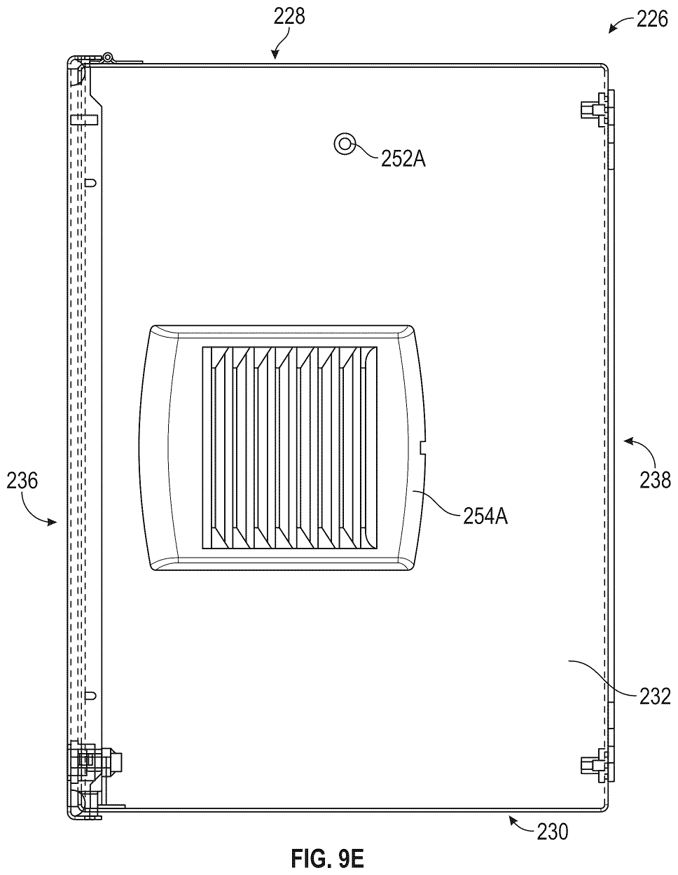

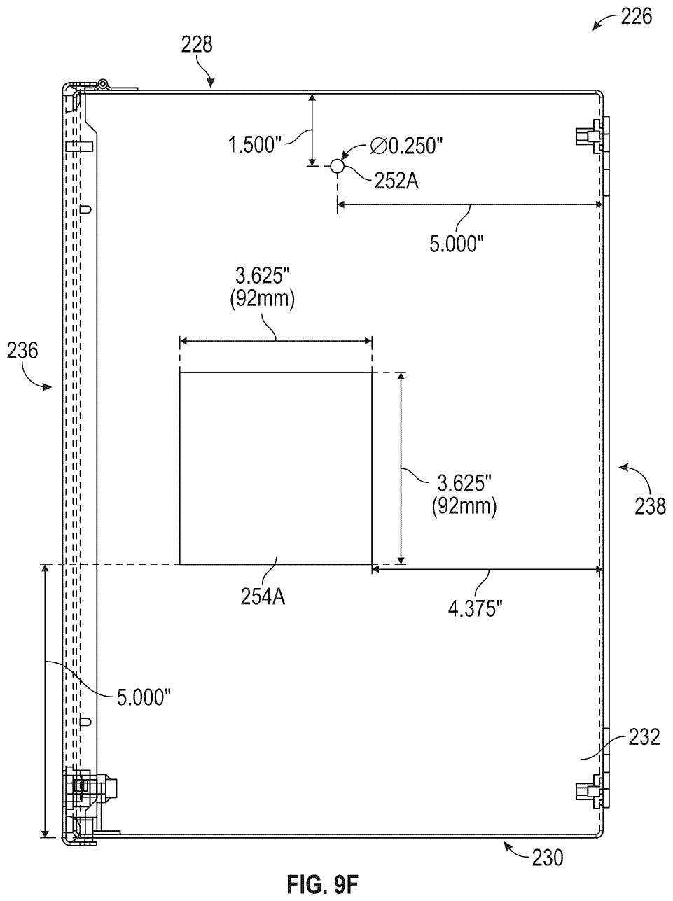

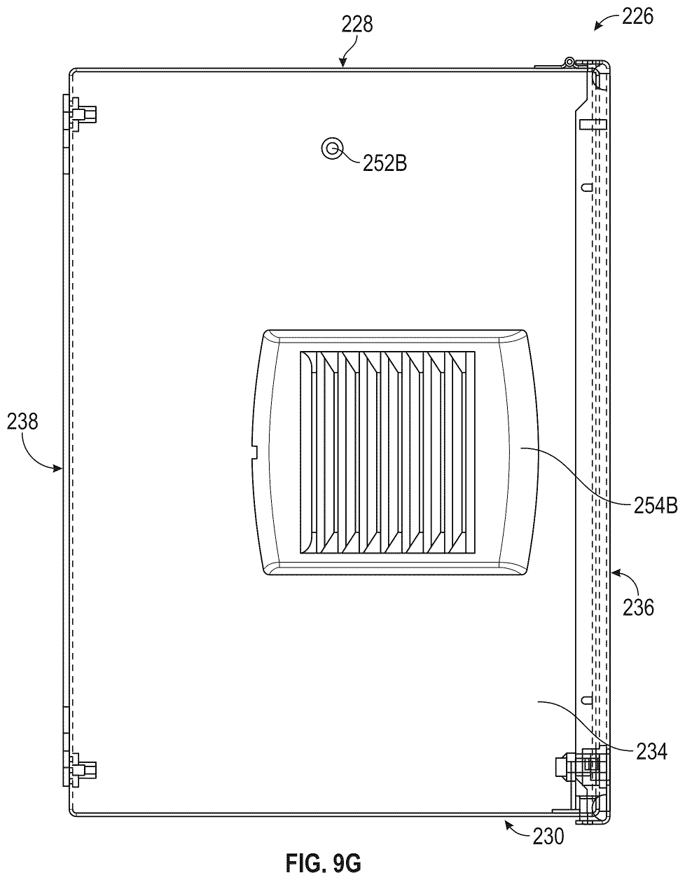

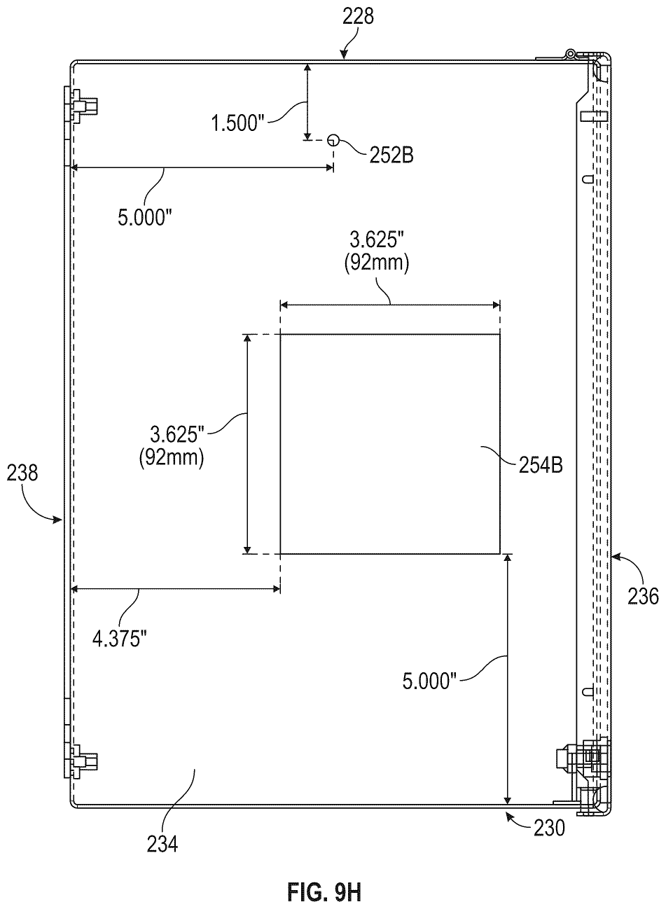

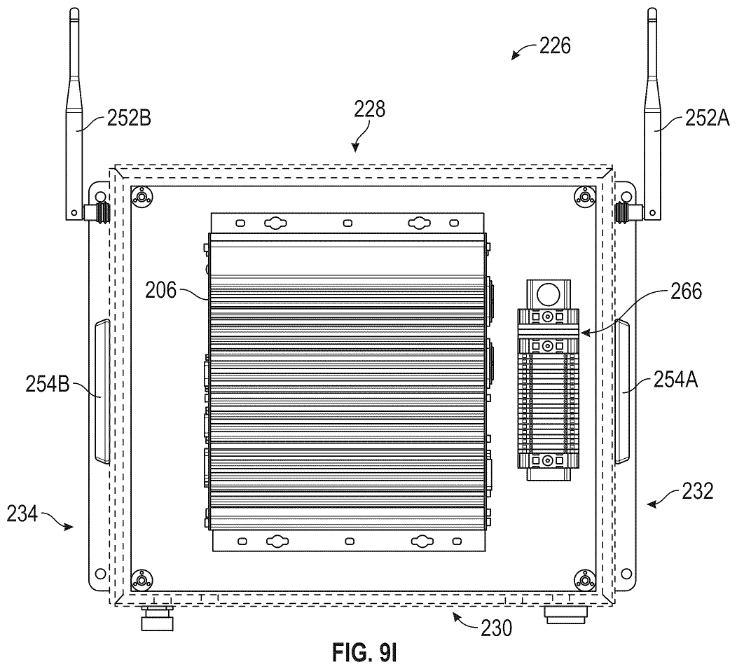

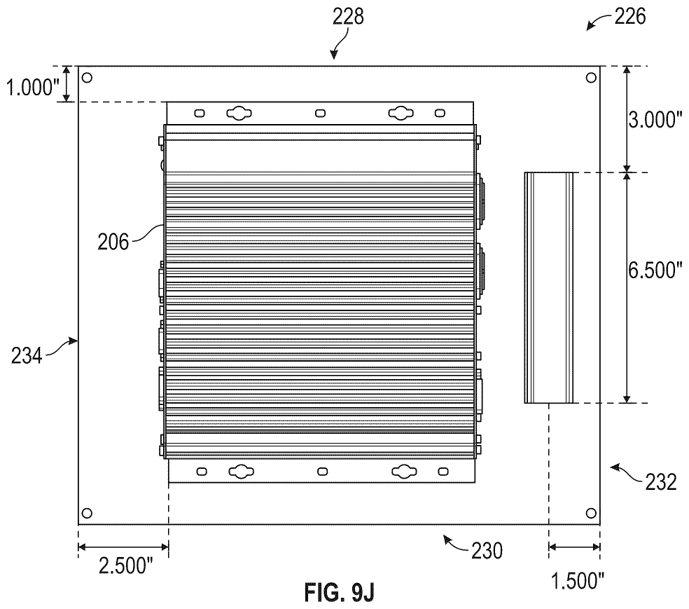

FIGS. 9A-9J show various views of an industrial enclosure 226, and components thereof, according to some embodiments. FIG. 9A shows a front elevation view of the industrial enclosure 226 according to some embodiments. According to some embodiments, the industrial enclosure 226 be and/or comprise the industrial enclosure 126 of the system 100. Additionally or alternatively, the industrial enclosure of FIGS. 9A-9J, and components thereof, can be used as part of the system 100. According to some embodiments, the industrial enclosure 226 can be related to voice control of aspect(s) of the system 200 and can comprise element(s) configured to provide voice control capabilities, such as those described herein regarding the system 100.

Components and/or aspects of the industrial enclosure 226 can be the same as and/or similar to and can function in the same and/or similar manner as corresponding and/or like components and/or aspects of any other industrial enclosure described herein such as the industrial enclosure 126, the industrial enclosure 426, the industrial enclosure 626, and/or the industrial enclosure 726.

According to some embodiments, the industrial enclosure 226 can comprise a top 228, a bottom 230, a right side 232, a left side 234, a front 236 and a back 238. According to some embodiments, the front 236 of the industrial enclosure 226 can be hingedly connected to the rest of the industrial enclosure 226 (including the top 228, bottom 230, right side 232 and/or left side 234) via a hinge 240. While a hinge 240 is shown in FIG. 9A as operatively connecting the front 236 of the industrial enclosure 226 to the rest of the industrial enclosure 226, the front 236 can be operatively connected to the rest of the industrial enclosure 226 by any suitable means. According to some embodiments, the industrial enclosure 226 can be made of steel and/or can be gray in color. According to some embodiments, the industrial enclosure 226 can have a width of about 16 inches, a height of about 14 inches, and a depth of about 10 inches.

As shown in FIG. 9A, according to some embodiments, the front 236 can comprise an emergency stop button 242. The emergency stop button 242 can be used by a user to initiate an emergency stop feature of any aspect of the system 200. As an example, the emergency stop feature can cause any positioning equipment, such as the positioner 202, from performing whatever action it is currently performing. While stopping positioning equipment from performing its current action is one example of the emergency stop feature, the emergency stop feature can generally cause any action, task, or process of the system 200 to immediately stop, cease, halt, and the like. For example, according to some embodiments, the emergency stop button 242 can cause the voice control aspect of the system 200 to cease. While a button is shown in FIG. 9A, the emergency stop feature can be triggered by any suitable means including, but not limited to, voice activation, via a touchscreen, via a dial, via a computer and/or computer mouse, and the like. According to some embodiments, the emergency stop button 242 can be and/or comprise a mushroom twist button. As shown in FIG. 9A, according to some embodiments, the emergency stop button 242 can include an outer perimeter 243. The outer perimeter can surround the emergency stop button 242. The outer perimeter 243 can include text. For example, as shown in FIG. 9A, the outer perimeter 243 can read “EMERGENCY STOP”. However, any suitable text or no text could be included in/on the outer perimeter 243. According to some embodiments, and as shown in FIG. 9A, the emergency stop button 242 can be generally circular. Furthermore, the emergency stop button 242 can include a ridge 245 at or near the top of the emergency stop button 242.

As shown in FIG. 9A, according to some embodiments, the front 236 can comprise a display 244. The display 244 can be a touchscreen according to some embodiments. The display 244 can be configured for input and output capabilities. For example, the display 244 can be configured such that a user can provide input to the display 244 via any suitable input means such as via touchscreen. While a display 244 is shown in FIG. 9A, the front 236 can comprise any suitable input means including, but not limited to, computer mouse or mice, keyboard(s), touchscreen(s), knob(s), dial(s), switch(es), button(s), speaker(s), microphone(s), printer(s), LIDAR, RADAR, and the like. Any input received by the display 244 can be used by the system 200 to perform any action and/or complete any task associated with the system 200 and/or any component thereof such as the positioner 202. The display 244 can also be configured to provide output. For example, the display 244 can be configured to display output. The output can comprise any information related to the system 200 and/or components thereof. For example, the output can comprise selectable options for a user such as to perform task(s), stop task(s), connect or disconnect component(s) via Bluetooth or other means, turn ON or OFF the system 200 and/or positioner 202, and the like; information related to the positioner 202 such as current task, future task(s), performed task(s), a queue of task(s) to be performed, and the like; options for a user to enter personalization settings; and the like.

According to some embodiments, the display 244 can be the same as and/or similar to the HMI described above in reference to the system 100. According to some embodiments, the display 244 can be and/or comprise the B-Series 10.1″ Industrial Touchscreen and/or the I-Series 10.1″ Industrial Touchscreen, both produced by Industrial Monitor Direct (model number IMD101-M520).

FIG. 9B shows a modified front elevation view of the industrial enclosure 226 showing example dimensions. The dimensions shown in FIG. 9B are for example purposes only. Various embodiments may have different dimensions. As noted, the emergency stop button 242 can be generally circular. As shown in FIG. 9B, the emergency stop button 242 can be installed on a cutout in the front 236 of the enclosure 226 wherein the cutout has a circumference or a diameter of about 0.875 inches. Furthermore, the ridge 245 can have a width of 0.126 inches. The distance measured from the top of the ridge 245 to the bottom of the emergency stop button 242 can be about 0.950 inches. The width of the industrial enclosure 226 (i.e., the length of the top 228 and bottom 230) can be about 16.25 inches. The emergency stop button 242 can be positioned in the center of the front 236 of the industrial enclosure 226 in terms of width. The display 244 can be installed in a cutout in the front 236 of the enclosure 226 wherein the cutout is about 10.138 inches in width and 6.940 inches in height. The distance from a top of the display 244 to the top 228 of the industrial enclosure 226 can be about 2.5 inches. The distance from a left side of the display 244 to the left side 234 of the industrial enclosure 226 can be about 3.125 inches. The distance from the middle of the emergency stop button 242 to the bottom 230 of the industrial enclosure 226 can be about 1.75 inches. Again, all dimensions shown in FIG. 9B and/or described herein are for example purposes only. Any suitable dimensions could be used.

FIG. 9C shows a bottom elevation view of the industrial enclosure 226. As shown in FIG. 9C, according to some embodiments, the bottom 230 of the industrial enclosure 226 can comprise a wiring aperture 246 to allow wiring to enter and exit the industrial enclosure 226. The wiring aperture 246 can be and/or comprise a hole or aperture in the bottom 230 of the industrial enclosure 226. According to some embodiments, the wiring aperture 246 can be generally circular and can be 0.5 inches in diameter. The wiring aperture 246 can include a sealing lock nut. The wiring that enters and/or exits the industrial enclosure 226 via the wiring aperture 246 can be wiring related to power, data communication, and/or any other sort of wiring.

As shown in FIG. 9C, the bottom 230 can comprise a cable port 248, such as an ethernet port. The cable port 248 is configured such that a cable, such as an ethernet cable, can be plugged in thereto. The cable port 248 allows the industrial enclosure 226, and components thereof, to be connected to ethernet. While only one cable port 248 is shown in FIG. 9C, the industrial enclosure 226 can include any number of cable ports ranging from zero to N where N is any number greater than zero.

As shown in FIG. 9C, the bottom 230 can comprise a USB port 250. The USB port 250 is configured such that a USB-compatible cable and/or device can be plugged in thereto. The USB port 250 allows the industrial enclosure 226, and components thereof, to be able to interact with another device and/or entity. The USB port 250 can be a dual USB port wherein the USB port 250 comprises two USB ports and is capable of connecting with two USB-compatible cables and/or devices. While only one USB port 250 is shown in FIG. 9C, the industrial enclosure 226 can include any number of USB ports ranging from zero to N where N is any number greater than zero. According to some embodiments, the hands-free interface device 304 is chargeable via the USB port 250 of the enclosure 226.

According to some embodiments, not only do the wiring aperture 246, cable port 248, and/or USB port 250 allow the internal components of the enclosure 226, including the AI-enabled intelligence control module 206 and the PLC 216, to be able to be charged. Further, the wiring aperture 246, cable port 248, and/or USB port 250 eliminate the need for wireless internet for any aspect of the system 200 to work properly. Thus, all aspects of the system 200, including voice control aspects, can operate properly without the need for wireless internet.

FIG. 9D shows a modified bottom elevation view of the industrial enclosure 226 showing example dimensions. The dimensions shown in FIG. 9D are for example purposes only. Various embodiments may have different dimensions. As noted, the wiring aperture 246 can be generally circular. As shown in FIG. 9D, the wiring aperture 246 can have a circumference or a diameter of about 0.875 inches or about 0.5 inches. The distance from the back 238 of the industrial enclosure 226 and the center of the wiring aperture 246 can be about 2.5 inches. The distance from the left side 234 of the industrial enclosure 226 to the center of the wiring aperture 246 can be about 1.5 inches. As shown in FIG. 9D, the USB port 250 can be installed on a cutout in the bottom 230 of the enclosure 226 wherein the cutout has a circumference or a diameter of about 1.109 inches or about 0.75 inches. The distance from the right side 232 of the industrial enclosure 226 to the center of each of the USB port 250 and cable port 248 can be about 1.5 inches. The distance from the back 238 of the industrial enclosure 226 to the center of the cable port 248 can be about 2.5 inches. The distance from the center of the cable port 248 to the center of the USB port 250 can be about 1.5 inches. Again, all dimensions shown in FIG. 9D and/or described herein are for example purposes only. Any suitable dimensions could be used.

FIG. 9E shows a right-side elevation view of the industrial enclosure 226. As shown in FIG. 9E, the right side 232 of the industrial enclosure can comprise a right-side antenna 252A and a right-side ventilation outlet 254A. The right-side antenna 252A can be and/or comprise any sort of antenna configured to facilitate wireless connectivity between components. For example, the right-side antenna 252A can be configured to facilitate wireless connection between components of the industrial enclosure 226, such as the AI-enabled intelligence control module 206 and/or the PLC 216, with another part of the system 200, such as the hands-free interface device 304, and/or an entity external of the system 200.

The right-side ventilation outlet 254A can be and/or comprise any sort of ventilation device and/or component such as a vent, grille, and the like. The right-side ventilation outlet 254A can be configured to vent air and/or heat from the industrial enclosure 226. According to some embodiments, the right-side ventilation outlet 254A can be and/or comprise the ClimaSys Forced Ventilation produced by Schneider Electric (model number NSYCVF38M24DPF).

FIG. 9F shows a modified right-side elevation view of the industrial enclosure 226 showing example dimensions. The dimensions shown in FIG. 9F are for example purposes only. Various embodiments may have different dimensions. According to some embodiments, the right-side ventilation outlet 254A can be installed on a cutout in the right side 232 of the enclosure 226 wherein the cutout has a width and a height of about 3.625 inches. A bottom of the right-side ventilation outlet 254A can be about 5 inches from the bottom 230 of the industrial enclosure 226. A right side of the right-side ventilation outlet 254A can be about 4.375 inches from the back 238 of the industrial enclosure 226. The base of the right-side antenna 252A can be installed on a cutout in the right side 232 of the enclosure 226 wherein the cutout is generally circular and has a diameter or circumference of about 0.25 inches. The center of the base of the right-side antenna 252A can be about 5 inches from the back 238 of the industrial enclosure 226. The center of the base of the side antenna 252A can be about 1.5 inches from the top 228 of the industrial enclosure 226. Again, all dimensions shown in FIG. 9F and/or described herein are for example purposes only. Any suitable dimensions could be used.

FIG. 9G shows a left-side elevation view of the industrial enclosure 226. According to some embodiments, the left side 234 of the industrial enclosure 226 can be a mirror image of the right side 232 thereof. For example, the left side 234 can comprise a left-side antenna 252B and a left-side ventilation outlet 254B. The left-side antenna 252B can be the same as and/or similar to the right-side antenna 252A. The left-side ventilation outlet 252B can be the same as and/or similar to the right-side ventilation outlet 254B.

FIG. 9H shows a modified left-side elevation view of the industrial enclosure 226 showing example dimensions. The dimensions shown in FIG. 9H are for example purposes only. Various embodiments may have different dimensions. According to some embodiments, the left-side ventilation outlet 254B can be installed on a cutout in the left side 234 of the enclosure 226 wherein the cutout has a width and a height of about 3.625 inches. A bottom of the left-side ventilation outlet 254B can be about 5 inches from the bottom 230 of the industrial enclosure 226. A left side of the left-side ventilation outlet 254B can be about 4.375 inches from the back 238 of the industrial enclosure 226. The base of the left-side antenna 252B can be installed on a cutout in the left side 234 of the enclosure 226 wherein the cutout is generally circular and has a diameter or circumference of about 0.25 inches. The center of the base of the left-side antenna 252B can be about 5 inches from the back 238 of the industrial enclosure 226. The center of the base of the left-side antenna 252B can be about 1.5 inches from the top 228 of the industrial enclosure 226. Again, all dimensions shown in FIG. 9H and/or described herein are for example purposes only. Any suitable dimensions could be used.

FIG. 9I shows a front internal elevation view of the industrial enclosure 226 wherein the internal components of the industrial enclosure 226 are visible. The front 236 of the industrial enclosure 226 can function as a sort of door wherein the industrial enclosure 226 can be opened and/or closed via its front 236. FIG. 9I shows a view wherein the front 236 is shown to be opened and/or removed. As shown in FIG. 9I, the AI-enabled intelligence control module 206 can be housed in the interior of the industrial enclosure 226. The AI-enabled intelligence control module 206 can be the same as and/or similar to the AI-enabled intelligence control module 106. The AI-enabled intelligence control module 206 can be included in the system 200. According to some embodiments, the AI-enabled control module 206 can be the Nuvo 9160GC computer produced by Neousys Technology (model number Nuvo-9160GC-i5TC-65W-4000sff). According to some embodiments, the AI-enabled intelligence control module 206 can be ruggedized.

As shown in FIG. 9I, the internal portion of the enclosure 226 can comprise a DIN rail 266. According to some embodiments, DIN rail 266 can comprise any suitable number of terminal block(s), grounding terminal block(s), and/or end cover(s) for said terminal block(s). According to some embodiments, the terminal block(s) and grounding terminal block(s) can be 2-hole terminal block(s) and 2-hole grounding terminal block(s). Additionally or alternatively, according to some embodiments, the DIN rail 266 can comprise any number of terminal end stops. The DIN rail 266 can be and/or comprise any sort of rail or structure capable of mounting electronic components and/or industrial control equipment. According to some embodiments, the DIN rail 266 can be made of metal.

FIG. 9J shows a modified front internal elevation view of the industrial enclosure 226 showing example dimensions. The dimensions shown in FIG. 9J are for example purposes only. Various embodiments may have different dimensions. According to some embodiments, the left side of the AI-enabled intelligence control module 206 can be about 2.5 inches from the left side 234 of the industrial enclosure 226, and the top of the AI-enabled intelligence control module 206 can be about 1 inch from the top 228 of the industrial enclosure 226. The DIN rail 266 can be about 6.5 inches in length, the top of the DIN rail 266 can be about 3 inches from the top 228 of the industrial enclosure 226, and the center of the DIN rail 266, in terms of its width, can be about 1.5 inches from the right side 232 of the industrial enclosure 226. Again, all dimensions shown in FIG. 9J and/or described herein are for example purposes only. Any suitable dimensions could be used. According to some embodiments, the enclosure 226 can house, or at least partially house, the AI-enabled intelligence control module 206 and/or the PLC 216. The PLC 216 can be the same as and/or similar to the PLC 106. Alternatively, according to some embodiments, the PLC 216 is not housed in the enclosure 226.

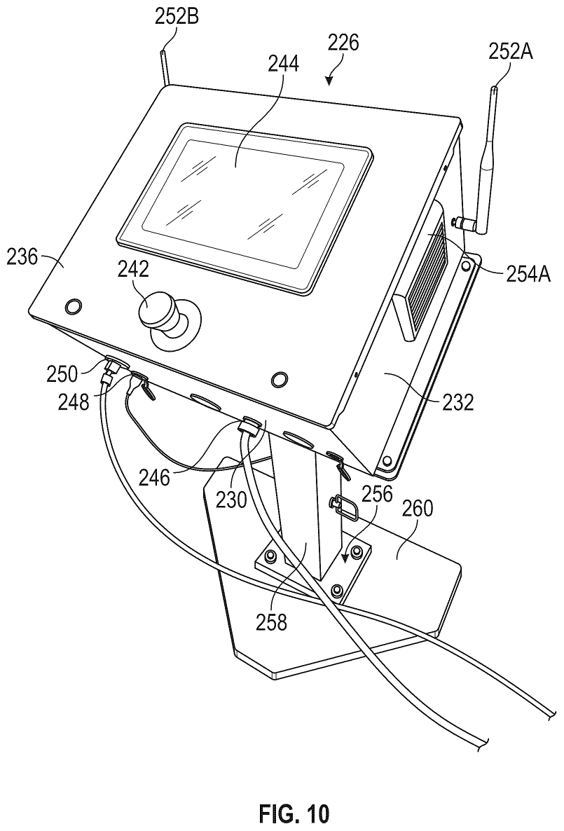

FIG. 10 shows a perspective view of the industrial enclosure 226 mounted on a stand 256. As shown in FIG. 10, the stand 256 can comprise an elongated member 258 and a base 260. The base 260 can be a generally flat surface and can be configured to rest on the ground and/or another flat surface. One end of the elongated member 258 can be operatively attached to the base 260, wherein the elongated member 258 can extend upward therefrom. The enclosure 226 can be mounted on the other end of the elongated member 258. As shown in FIG. 10, the industrial enclosure 226 can be operatively attached and/or mounted to the elongated member 258 at or near the top of the elongated member 258. By mounting the industrial enclosure 226 on the stand 256, the industrial enclosure is stabilized and secured at a specific location. Mounting the enclosure 226 also provides ergonomic benefits for a user.

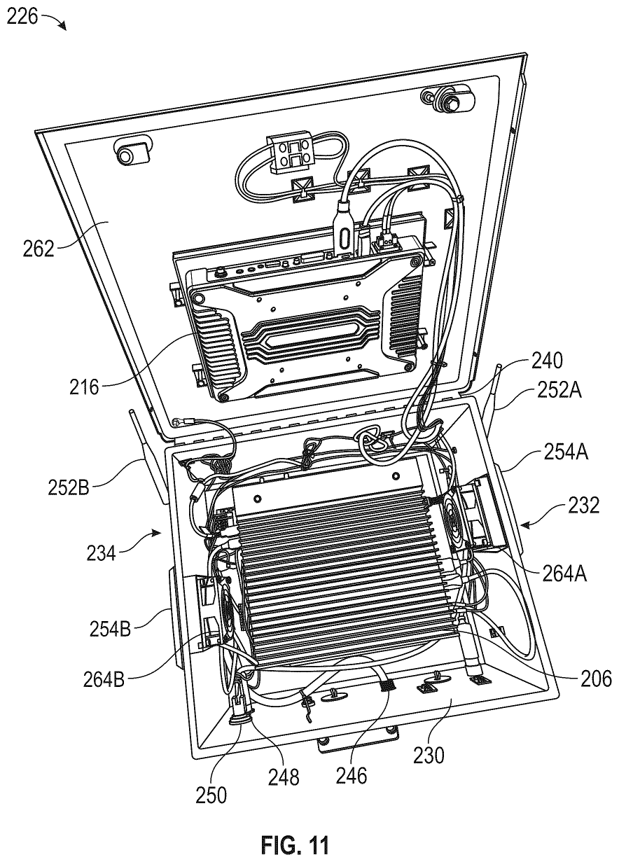

FIG. 11 shows a perspective view of the industrial enclosure 226 wherein the industrial enclosure is open such that the internal components of the industrial enclosure 226 are visible. FIG. 11 shows a view wherein the front 236 of the industrial enclosure 226 is opened, via the hinge 240, such that the internal components of the industrial enclosure 226 are visible. As shown in FIG. 11, the interior of the industrial enclosure 226 can house the AI-enabled intelligence control module 206. As shown in FIG. 11, according to some embodiments, the PLC 216 can be attached to the interior surface 262 of the front 236 of the industrial enclosure 262. However, according to some embodiments, the PLC 216 is not attached to the interior surface 262 of the front 236. As shown in FIG. 11, the AI-enabled intelligence control module 206 can be housed in the interior of the industrial enclosure 226. As shown in FIG. 11, the interior of the industrial enclosure 226 can comprise two ventilators, a right-side ventilator 264A and a left-side ventilator264B. The two ventilators 264A, 264B can be any suitable type of fan and/or ventilation device. The ventilators 264A, 264B can each be configured to help facilitate ventilation of air and/or heat from the interior of the industrial enclosure 226. The right-side ventilator 264A can be aligned with the right-side ventilation outlet 254A, and the left-side ventilator 264B can be aligned with the left-side ventilation outlet 254B. The ventilation apparatus(es), including the ventilation outlets 254A, 254B and the ventilators 264A, 264B are configured to keep the internal components of the enclosure 226 cool. Thus, because the internal components of the enclosure 226 are able to be charged and able to be kept cool, the enclosure 226, and components thereof, can function as a stand-alone device.

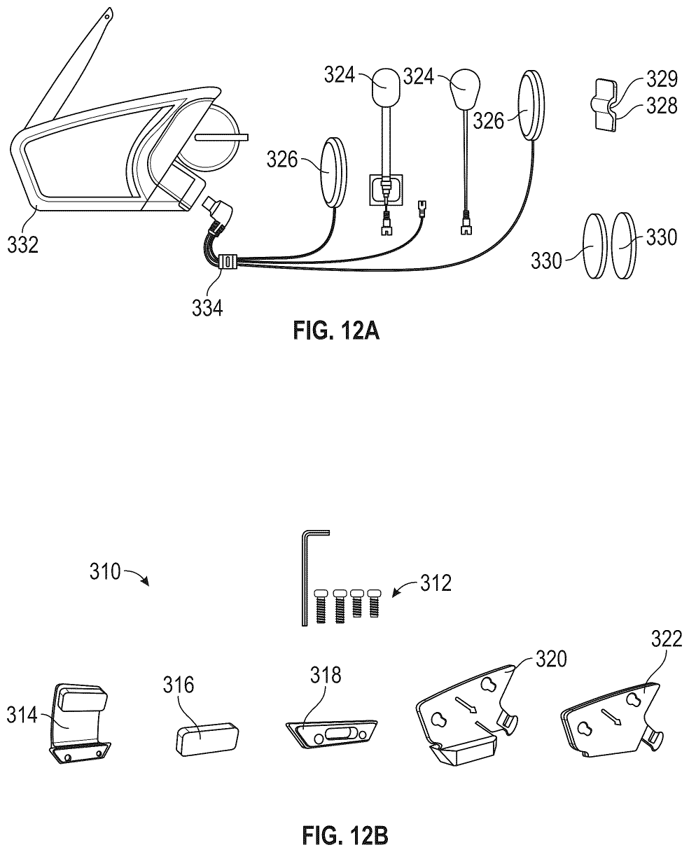

FIGS. 12A and 12B show perspective views of components of a hands-free interface device 304 according to some embodiments. As shown in FIG. 12A, the hands-free interface device 304 can comprise two transducers 324, two auditory mechanisms 326, a transducer holder 328, two auditory mechanism pads 330, a wearable communication mechanism 332, and operational connection means 334.

According to some embodiments, each transducer 324 can be and/or comprise a microphone and/or any other type of transducer mentioned herein. Each transducer 324 can be the same as and/or similar to the transducer 105. According to some embodiments, each transducer 324 can be and/or comprise a boom microphone. According to some embodiments, each transducer 324 can be and/or comprise a button microphone. While two transducers 324 are shown in FIG. 12A, the hands-free interface device 304 can comprise any number of transducers ranging from 1 to N where N is any number greater than 1.

According to some embodiments, each auditory mechanism 326 can be and/or comprise a LexinPulse speaker. According to some embodiments, each auditory mechanism 326 can be and/or comprise a 40 mm HD LexinPulse speaker. Each auditory mechanism 326 can be the same as and/or similar to the auditory mechanism 107. While two auditory mechanisms 326 are shown in FIG. 12A, the hands-free interface device 304 can comprise any number of auditory mechanisms ranging from 1 to N where N is any number greater than 1.

According to some embodiments, the transducer holder 328 can secure one or more transducers 324 in a particular location, arrangement, orientation, and the like, relative to other aspects of the hands-free interface device 304. As shown in FIG. 12A, the transducer holder 328 can comprise a raised portion 329 wherein a cord attached to one or both of the transducers 324 can fit snugly within the raised portion 329 such that the transducer holder 328 can hold and/or secure the transducer(s) 324 in place relative to the hands-free interface device 304. The transducer holder 328 can be secured relative to other aspects of the hands-free interface device 304 and can, therefore, secure the transducer(s) 324 relative to other aspects of the hands-free interface device 304. According to some embodiments, the transducer holder 328 can be secured relative to other aspects of the hands-free interface device 304 by attaching to a portion of the hands-free interface device 304 via adhesive(s) and/or any other suitable means of attachment. While one transducer holder 328 is shown in FIG. 12A, the hands-free interface device 304 can comprise any number of transducer holders ranging from zero to N where N is any number greater than zero.

According to some embodiments, the two auditory mechanism pads 330 can be configured such that one side of each auditory mechanism pad 330 can attach to a portion of the hands-free interface device 304 and the other side can attach to an auditory mechanism 326. For example, according to some embodiments, each auditory mechanism pad 330 can adhesively attach to a portion of the hands-free interface device 304 on one side and can adhesively attach to an auditory mechanism 326 on the other side. According to some embodiments, any other suitable form of attachment can be used alternatively or additionally to adhesive attachment. Each auditory mechanism pad 330 can be configured to be able to hold and/or secure each auditory mechanism 326 in place relative to other aspects of the hands-free interface device 304. Each auditory mechanism pad 330 can also be configured to protect each auditory mechanism 326 from damage, wear-and-tear, and the like. While one auditory mechanism pad 330 is shown in FIG. 12A, the hands-free interface device 304 can comprise any number of auditory mechanism pads ranging from zero to N where N is any number greater than zero.

According to some embodiments, the wearable communication mechanism 332 can comprise a Bluetooth mechanism and/or provide Bluetooth capabilities. However, the wearable communication mechanism 332 can communicate by any other means including, but not limited to, any other means of wireless and/or wired communication mentioned herein. For example, the wearable communication mechanism 332 can communicate, such as via data communication, in any manner as described herein related to the hands-free interface device 104. Thus, the wearable communication mechanism 332 is able to communicate wirelessly and/or in a wired manner with the AI-enabled intelligence control module 206 and/or the PLC 216. According to some embodiments, the wearable communication mechanism 332 can be the Lexin Novus Bluetooth Headset Intercom. According to some embodiments, the wearable communication mechanism 332 can comprise a radio, such as an FM and/or AM radio. According to some embodiments, the wearable communication mechanism 332 can pair simultaneously with multiple devices.

According to some embodiments, the operational connection means 334 can comprise wiring that operatively connects the wearable communication mechanism 332 with the transducer(s) 324 and auditory mechanism(s) 326. Thus, communication, such as data communication, can occur between the wearable communication mechanism 332, transducer(s) 324 and auditory mechanism(s) 326. While the operational connection means 334 are shown in FIG. 12A to comprise wiring, the operational connection means can comprise any mechanism and/or device configured to facilitate communication wherein such communication can occur in a wired and/or wireless fashion. Any wireless and/or wired connection means mentioned herein can be used to the operatively connect the wearable communication mechanism 332, transducer(s) 324, and auditory mechanism(s) 326.

FIG. 12B shows a perspective view of further components of the hands-free interface device 304. FIG. 12B shows a perspective view of securing means 310 related to the hands-free interface device 304. The securing means 310 are configured such that the securing means 310 can secure the wearable communication mechanism 332 onto a wearable item such as a helmet, headset, necklace, armband, wristband, and/or any other suitable wearable item. As shown in FIG. 12B, the securing means 310 can comprise screw(s) 312, a first mounting bracket 314, cushion pad(s) 316, a mounting pad 318, a second mounting bracket 320, and an adhesive bracket 322.

According to some embodiments, the screw(s) 312 can comprise four screws and the cushion pad(s) 316 can comprise two rubber pads. However, according to some embodiments, any number of screws and/or cushion pads ranging from zero to N where N is any number greater than zero could be included as part of the securing means 310. According to some embodiments, the cushion pad(s) 316 can be rubber pad(s). The securing means 310, including the screw(s) 312, first mounting bracket 314, rubber pad(s) 316, mounting pad 318, second mounting bracket 320, and adhesive bracket 322, can be configured to work in conjunction to secure the wearable communication mechanism 332 and other components such as the transducer(s) 324, auditory mechanism(s) 326, transducer holder(s) 328, auditory mechanism pad(s) 330, and operational connection means 334, to a wearable item such as a helmet, headset, necklace, armband, wristband, and the like.

Any suitable manner of installing component(s) of the hands-free interface device 304 onto a wearable item could be used. According to some embodiments wherein the wearable item is a helmet, component(s) of the hands-free interface device 304 can be installed onto the wearable item by mounting one of the first or second mounting brackets 314, 320 between internal padding and an external shell of the wearable item. Two screws 312 can then be tightened between the first and/or second mounting brackets 314, 320 such that the first and second mounting brackets 314, 320 are effectively secured in place relative to each other. According to some embodiments, based on the thickness of the wearable item, two cushion pads 316 and a mounting pad 318 can be added to the first mounting bracket 314. If a user is not using the cushion pads 316 and mounting pad 318, shorter screws can be used. If a user is using the cushion pads 316 and mounting pad 318, longer screws can be used. An alternative approach to mounting a bracket onto the wearable device involves the adhesive bracket 322 being attached to the wearable item rather than the second mounting bracket 320. When using the adhesive bracket 322, the adhesive portion can be placed in a suitable position on the wearable item. Once placed, the adhesive bracket 322 can be pressed for an amount of time and then can be left to dry for another amount of time. For example, according to some embodiments, the adhesive bracket can be pressed for 15 seconds and then can be left to dry for 24 hours.

Once the second mounting bracket 320 is mounted onto the wearable device, the wearable communication mechanism 332 can be slid onto the second mounting bracket 320 until the wearable communication mechanism 332 clicks firmly into the bottom portion of the second mounting bracket 320. According to some embodiments wherein the second mounting bracket 320 includes a tab, the tab can be released lightly and then the wearable communication mechanism 332 can be clicked to remove.

According to some embodiments, each auditory mechanism 326 can include an adhesive portion wherein such adhesive portion can be used to place each auditory mechanism 326 in a suitable location in/on the wearable item. For example, in embodiments wherein the wearable item is a helmet, each auditory mechanism 326 can be adhesively stuck into the helmet's inner padding. Additionally or alternatively, according to some embodiments, each auditory mechanism pad 330 can include an adhesive portion wherein such adhesive portion can be used to place each auditory mechanism pad 330 in a suitable location in/on the wearable item. For example, in embodiments wherein the wearable item is a helmet, each auditory mechanism pad 330 can be adhesively stuck into the helmet's inner padding. Then, an auditory mechanism 326 can be clicked and/or pressed firmly against a portion of each auditory mechanism pad 330, such as a hook-and-loop or adhesive portion, to secure the auditory mechanism 326 to the auditory mechanism pad 330. If the wearable item is a helmet that has deep ear pockets, additional auditory mechanism pad(s) 330 can be used and/or combined to position the auditory mechanism(s) 326 closer to the user's ear(s). Any wiring can be hidden between the liner and shell of the wearable item, and/or in any other suitable place. According to some embodiments, one of the auditory mechanisms 326 includes a shorter wire and the other auditory mechanism 326 includes a longer wire. The auditory mechanism 326 with the shorter wire can be positioned at and/or near the user's ear closer to the position of the wearable communication mechanism 332, and the auditory mechanism 326 with the longer wire can be positioned at and/or near the user's ear farther from the wearable communication mechanism 332.

To install a transducer 324, a transducer pad can be positioned and secured at and/or near a center of a mouth section of the wearable item. According to some embodiments, the transducer pad can comprise hook-and-loop. According to some embodiments, the transducer pad can be positioned and/or secured on the wearable item via adhesive. According to some embodiments, half of the transducer pad can be adhered to the wearable item. The transducer 324 can then be placed onto the transducer pad via hook-and-loop and/or any other suitable means. The transducer 324 can then be operatively connected to the wearable communication mechanism 332 wirelessly and/or via a wired connection.

According to some embodiments wherein the wearable item is an open-face helmet, one half of a transducer pad can be adhered to a base of a transducer 324, and the other half of the transducer pad can be adhered inside of underpadding of the wearable item. The direction of the transducer 324 can be adjusted such that a triangular mark on the transducer 324 points towards a user's mouth when the transducer 324 is positioned and secured. According to some embodiments, a transducer holder 328 can be used to help secure and/or provide additional support to the transducer 324 if necessary.

According to some embodiments, the components of FIGS. 12A-B can be and/or comprise a headset produced by Lexin, such as the Lexin B4FM headset, the Lexin FT4headset, the Lexin FT4Pro headset, the Lexin G1 headset, the Lexin G16 headset, the Lexin G2 headset, the Lexin G2P headset, the Lexin GTX headset, the Lexin MODEL S headset, the Lexin MeshCom headset, and/or the Lexin Novus headset.

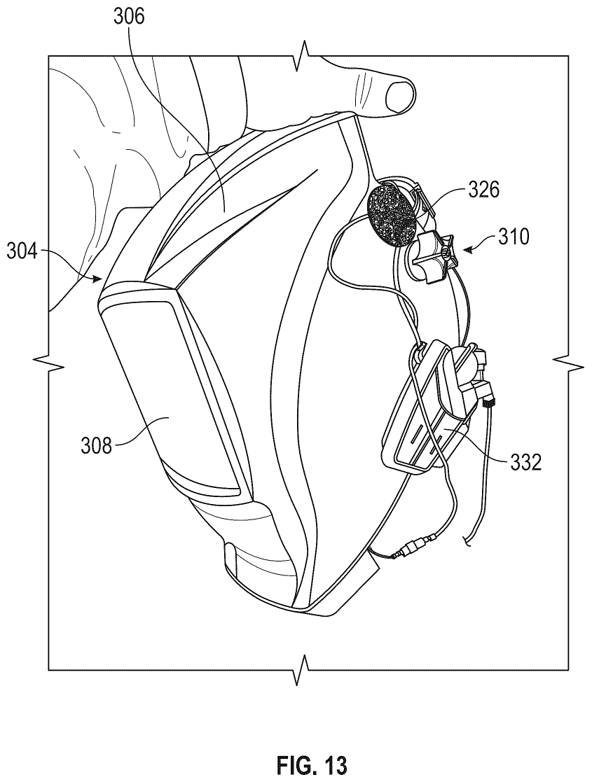

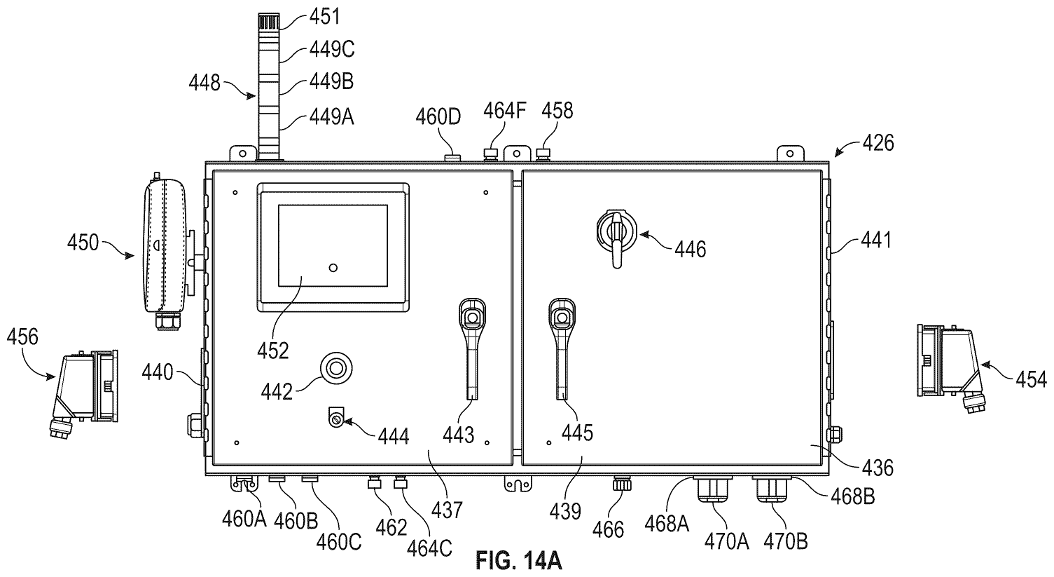

FIG. 13 shows a perspective view of the hands-free interface device 304 according to some embodiments. As shown in FIG. 13, according to some embodiments, in addition and/or alternative to some or all of the components shown in FIGS. 12A and 12B, the hands-free interface device 304 can comprise a helmet 306 wherein said helmet 306 comprises a face shield 308. According to some embodiments, the hands-free interface device 304 can comprise any components shown in any of FIGS. 12A-13.

According to some embodiments, the helmet 306 can be any sort of industrial helmet. For example, according to some embodiments, the helmet 306 can be a welder's helmet and/or mask. The helmet 306 can be configured to fit onto a user's head such that the user wears the helmet 306. The helmet 306 can be configured to shield and/or protect a user's head from potentially harmful objects and/or materials.

As shown in FIG. 13, the helmet 306 can comprise a face shield 308. The face shield can be and/or comprise any sort of transparent material configured to cover, shield, and/or protect the user's face from potentially harmful objects and/or materials.

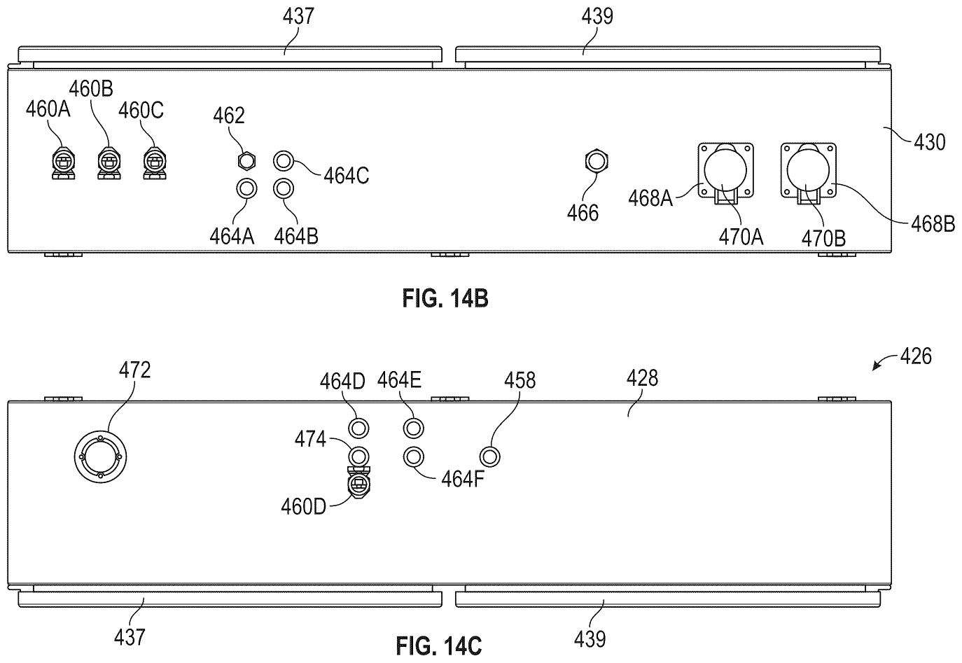

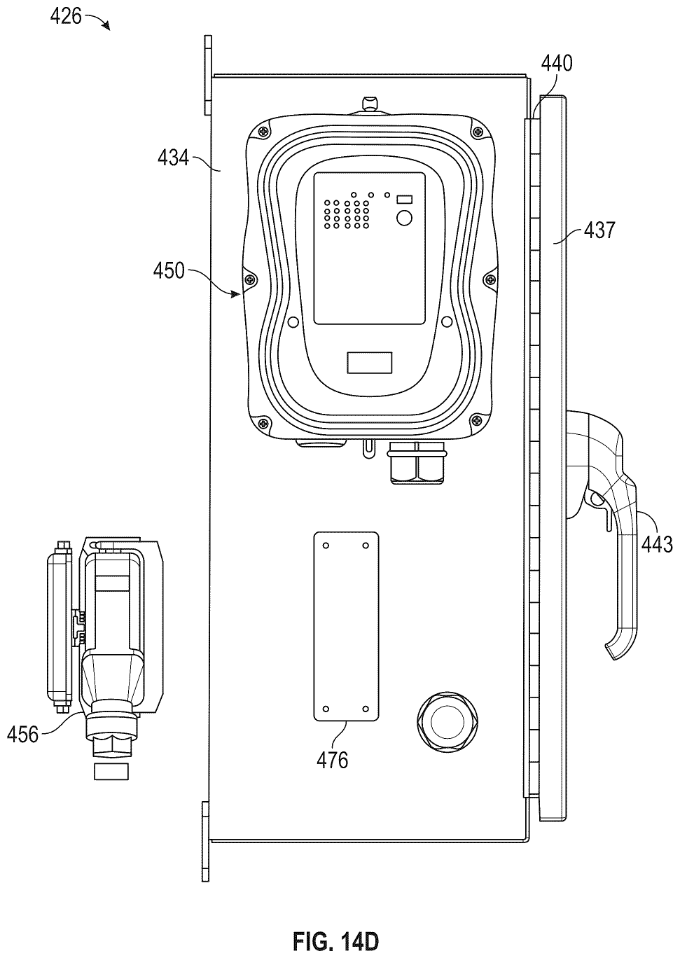

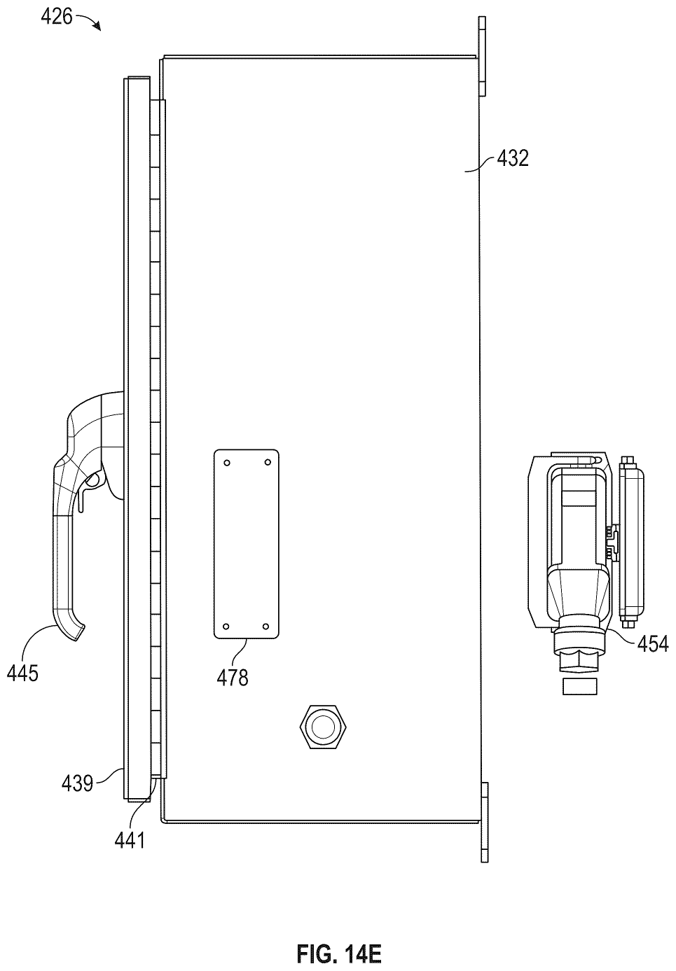

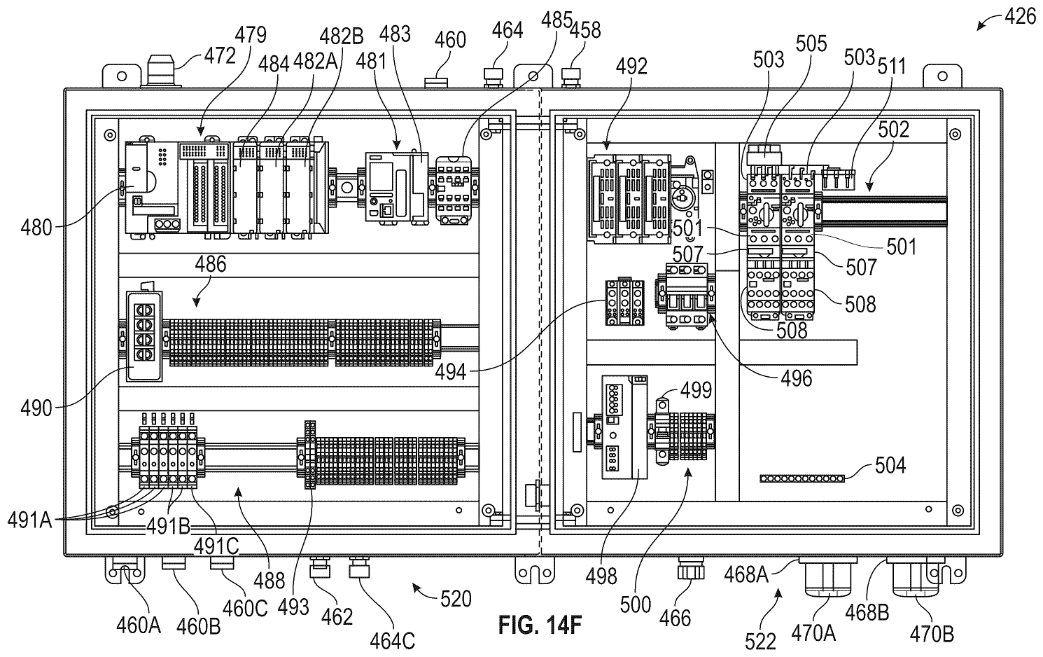

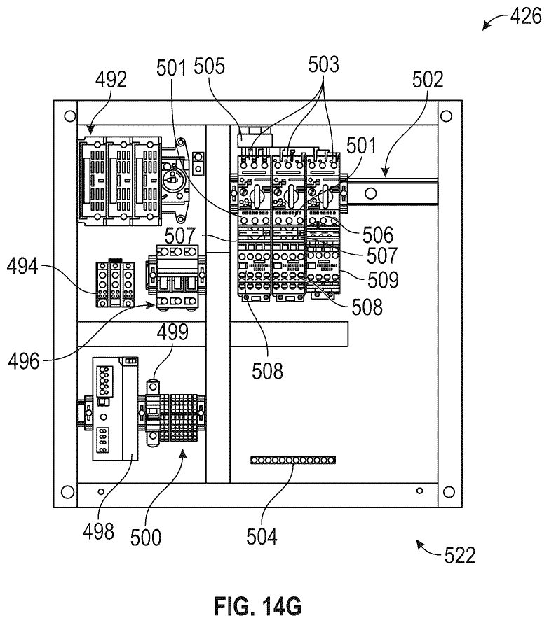

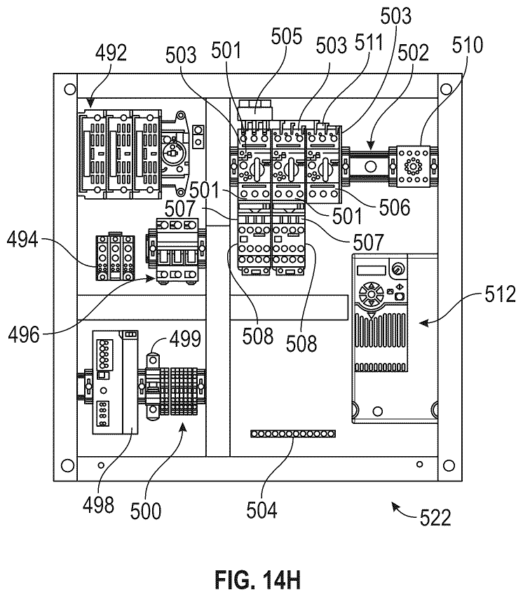

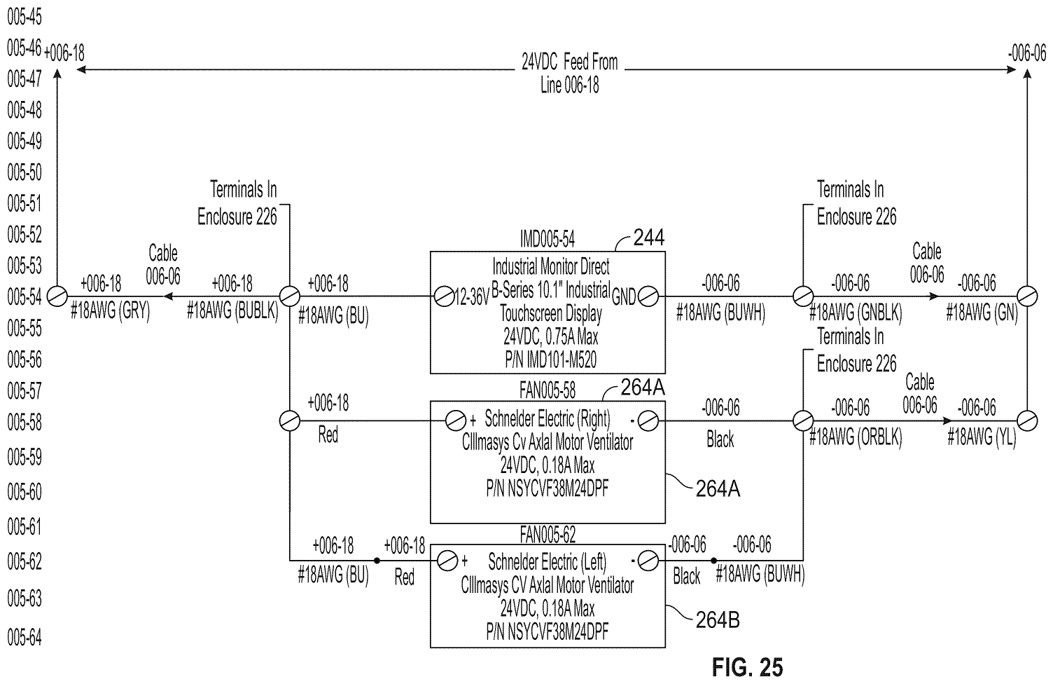

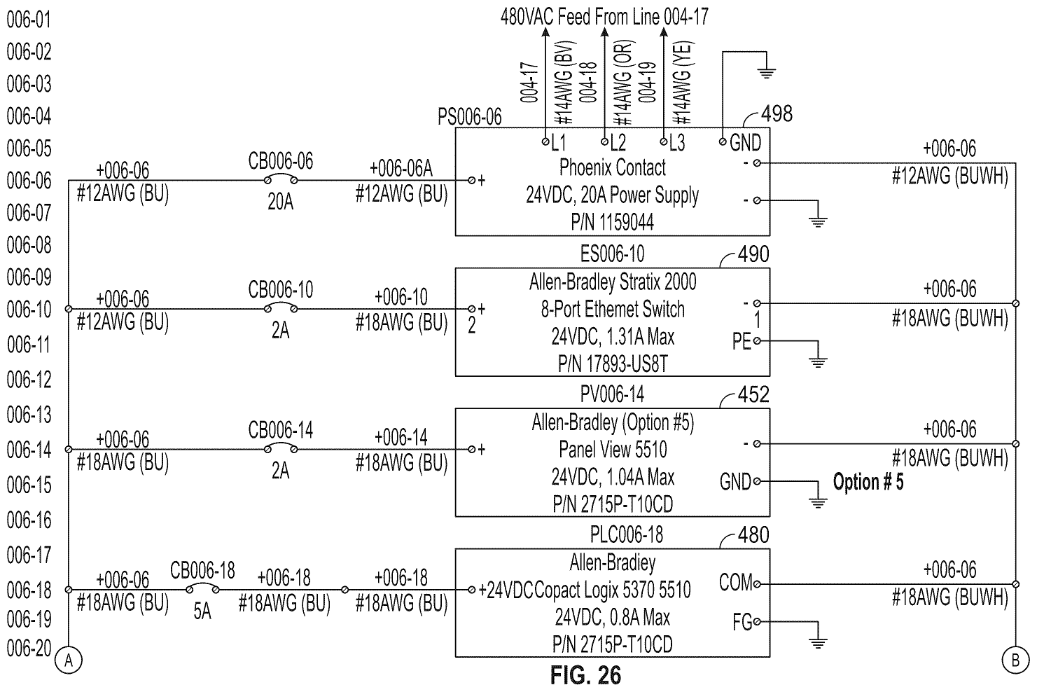

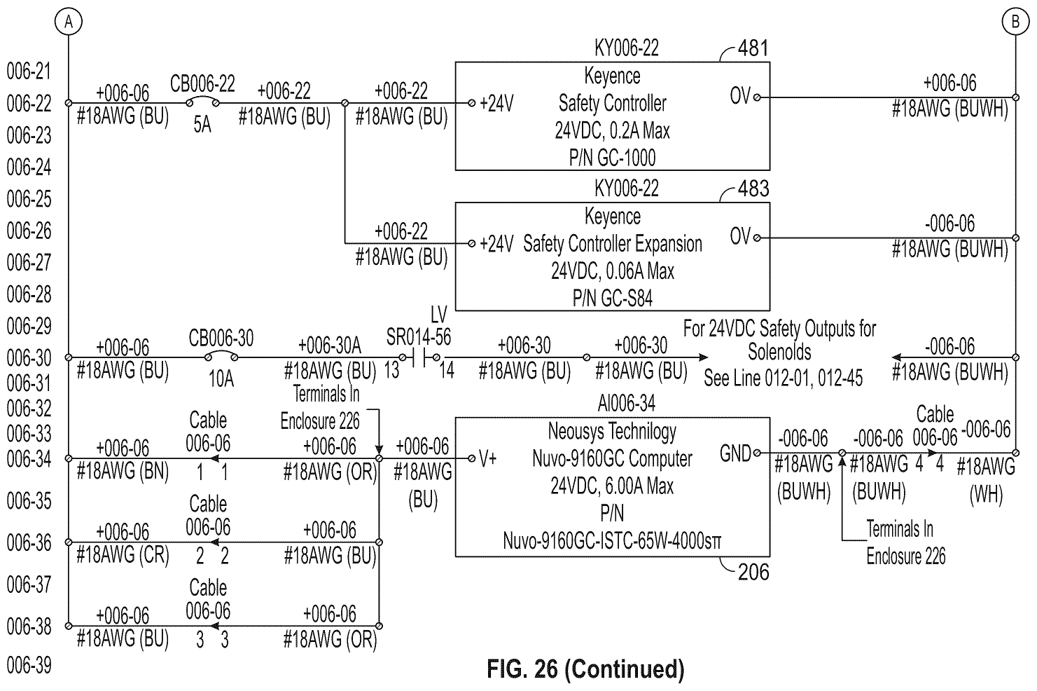

FIGS. 14A-40 show components that can be included as part of and/or be associated with the system 200 and/or a similar system. Further, the components shown in FIGS. 14A-40 can be used in conjunction with the industrial enclosure 226. FIGS. 14A-40 show components including an industrial enclosure 426 associated with a main control panel, an industrial enclosure 626 associated with controlling the tailstock portion 205 of the positioner 202, an industrial enclosure 726 associated with controlling an external hydraulic power unit (HPU), and operative connection means between each of the industrial enclosures.

The system 200, including industrial enclosures 226, 426, 626, and 726, and associated functionality thereof can implement several different functionality options. A first option (option #1) involves connection of the enclosure 426 to the enclosure 626, a second option (option #2) involves connection of the enclosure 426 to an external hydraulic power unit (HPU), a third option (option #3) involves utilizing tilt electric drive, a fourth option (option #4) utilizes rotary digital encoder(s), and a fifth option (option #5) that utilizes a human-machine interface (HMI). FIGS. 14A-40 show each of the five options wherein some components are only utilized and/or are only included when using a particular option. Some components shown in FIGS. 14A-40 can be utilized and/or included only for particular option(s). According to some embodiments, a user is able to select which option (i.e., one of options #1-5) to operate the system 200 and/or aspect(s) thereof.

FIGS. 14A-14H show several elevation views of an industrial enclosure 426 for a main control panel according to at least some embodiments of the present disclosure.

According to some embodiments, the enclosure 426 can be associated with controlling the headstock portion 204 of the positioner 202. The industrial enclosure 426 can comprise and/or embody any component and/or aspect of any other industrial enclosure described herein such as the industrial enclosure 126, the industrial enclosure 226, the industrial enclosure 626, and /r the industrial enclosure 726. Further, components and/or aspects of the industrial enclosure 426 can be the same as and/or similar to and can function in the same and/or similar manner as corresponding and/or like components and/or aspects of any other industrial enclosure described herein such as the industrial enclosure 126, the industrial enclosure 226, the industrial enclosure 626, and/or the industrial enclosure 726.

FIG. 14A shows an external front elevation view of the industrial enclosure 426. As shown in FIG. 14A, according to some embodiments, the industrial enclosure 426 can comprise a front 436, wherein the front 436 comprises a left door 437 having a left hinge 440 and a right door 439 having a right hinge 441. Further, as shown in FIG. 14A, the left door 437 can comprise an emergency stop button 442, a left handle 443, a safety override 444, and a display 452. Further, as shown in FIG. 14A, the right door 439 can comprise a right handle 445 and a lockable handle 446.

Each door 437, 439 can be hinged toward the outer portion of the front 436 of the enclosure 426 and can swing open from a center portion of the front 436 of the enclosure 426. Each hinge 440, 441 can be the same as and/or similar to the hinge 240. Each hinge 440, 441 can be configured to facilitate opening of its respective door 437, 439. The left handle 443 can be configured to be manipulable by a user to open and/or close the left door 437. The right handle 445 can be configured to be manipulable by a user to open and/or close the right door 439. The lockable handle 446 can be configured such that a user can attach a padlock or any other sort of suitable lock to the lockable handle 446 to effectively lock the doors 437, 439 shut. According to some embodiments, the lockable handle 446 can be installed on a cutout in the right door 439 of the enclosure 426, wherein the cutout is about 1.375 inches in diameter or in circumference. However, the lockable handle 446 could be installed on a cutout of any suitable size. The emergency stop button 442 can be the same as and/or similar to the emergency stop button 242. According to some embodiments, the center of the emergency start button 442 can be located about 7.5 inches from the bottom 430 of the enclosure 426, however, the emergency start button 442 could be positioned in any suitable location. According to some embodiments, the emergency stop button 442 can be installed on a cutout in the left door 437 of the enclosure 426, wherein the cutout is generally circular and is about 0.875 inches in diameter or circumference. The safety override 444 can comprise a key hole wherein a user can insert a key to perform a safety override of the system 200. Performing a safety override can comprise shutting down the system 200 and/or aspects thereof. Additionally and/or alternatively, performing a safety override can comprise immediately stopping any task being performed by the system 200, or aspects thereof such as the positioner 202. According to some embodiments, the center of the safety override 444 can be located about 3.5 inches from the bottom 430 of the enclosure 426 and about 9.5 inches from the left side 434 of the enclosure 426, however, the safety override 444 could be positioned in any suitable location. According to some embodiments, the safety override 444 can be installed on a cutout in the left door 437 of the enclosure 426, wherein the cutout is generally circular and has a diameter or circumference of about 0.875 inches. The display 452 can be the same as and/or similar to the display 244. According to some embodiments, the display 452 can be and/or comprise the PanelView 5510 produced by Allen-Bradley (model number 2715P-T10CD). According to some embodiments, the display 452 is and/or comprises a touchscreen. According to some embodiments, the display 452 is only included and/or utilized when the system 200 is operating under option #5. According to some embodiments, the display 452 can be installed on a cutout in the left door 437 wherein the cutout is about 8.875 inches in height and 10.625 inches in width and can be positioned such that a top of the display 452 is about 1.5 inches from the top 428 of the enclosure 426 and a left side of the display 452 is about 4 inches from the left side 434 of the enclosure 426. However, the display 452 could be of any suitable size and could be positioned in any suitable location.

As shown in FIG. 14A, the enclosure 426 can further comprise a sound and light tower 448. The sound and light tower 448 can comprise one or more modules comprising illuminating members. For example, according to some embodiments, the sound and light tower can comprise one or more modules comprising light emitting diodes (LEDs). Such modules can comprise steady and/or flashing LEDs. Such modules can comprise any color of LEDs including, but not limited to, red, green, and amber. For example, the sound and light tower 448 can comprise a first light module 449A, a second light module 449B, and a third light module 449C. According to some embodiments, the first light module 449A can comprise flashing red LEDs, the second light module 449B can comprise flashing amber LEDs, the third light module 449C can comprise steady green LEDs. According to some embodiments, the first light module 449A can be the Bulletin 854J 40 mm Stack Light produced by Allen-Bradley (model number 854J-24GL4). According to some embodiments, the second light module 449B can be another Bulletin 854J 40 mm Stack Light produced by Allen-Bradley (model number 854J-24GL5). According to some embodiments, the third light module 449C can be another Bulletin 854J 40 mm Stack Light produced by Allen-Bradley (model number 854J-24TL3). The sound and light tower 448 can further comprise a sound emitting mechanism 451. The sound emitting mechanism 451 can be steady and/or pulsing and can comprise a switch. According to some embodiments, the sound emitting mechanism 451 can be the Sound Module 40 mm Stack Light produced by the Allen-Bradley (model number 854J-B24SA3). The sound and light tower 448 can be configured to emit sound and/or light based on operating features of component(s) of the enclosure 426. For example, according to some embodiments, the sound and light tower can be configured to emit sound and/or light when an alert occurs.

As shown in FIG. 14A, the enclosure 426 can comprise a radio control 450. The radio control 450 can be configured to be able to transmit and receive data, messages, and the like via radio communication. According to some embodiments, the radio control 450 can be a Flex 8EX2 Radio Remote Control and/or the Flex 8EX2 Wireless Pendant produced by Magnetek (model number FLEX-8EX2-15-2T). According to some embodiments, the radio control 450 can further comprise the Flex 8EX2 Accessory Kit produced by Magnatek (model number FLEX-8EX2-COMBO).

As shown in FIG. 14A, the enclosure 426 can comprise a connector 454 configured to operatively connect the enclosure 426 to the industrial enclosure 626 associated with controlling the tailstock portion 205 of the positioner 202. According to some embodiments, the connector 454 is only included and/or utilized when the system 200 is operating under option #1. The connector 454 can comprise male and/or female pin insert(s). According to some embodiments, the connector 454 can have 24 pin inserts. According to some embodiments, the connector 454 comprises a cable capable of facilitating operative connection between electronic components. The cable can be a SOOW cable.

As shown in FIG. 14A, the enclosure 426 can comprise a connector 456 configured to operatively connect the enclosure 426 to the industrial enclosure 726 associated with controlling an HPU. The connector 456 can be the same as and/or similar to the connector 454. According to some embodiments, the connector 456 is only included and/or utilized when the system 200 is operating under option #2.

FIG. 14B shows an external bottom elevation view of the enclosure 426 according to some embodiments. As shown in FIG. 14B, the bottom 430 of the enclosure 426 can comprise three cable ports 460A, 460B, and 460C. While three cable ports 460A, 460B, and 460C are shown in FIG. 14B, the bottom 430 could comprise any number of cable ports ranging from 1 to N where N is any number greater than 1. According to some embodiments, each cable port 460A, 460B, and/or 460C can be configured to facilitate ethernet connection. According to some embodiments, one or more of the cable ports 460A, 460B, and/or 460C can be RJ45 ports. According to some embodiments, one or more of the cable ports 460A, 460B, and/or 460C are the same as and/or similar to the cable port 248. According to some embodiments each of the cable ports 460A, 460B, and/or 460C can be located about 5 inches from the back of the enclosure 426, the cable port 460A can be positioned about 3 inches from the left side 434 of the enclosure 426, the cable port 460B can be positioned about 5.5 inches from the left side 434, and the cable port 460C can be positioned about 8 inches from the left side 434. However, the cable ports 460A, 460B, and/or 460C could be positioned in any suitable location.

As shown in FIG. 14B, the bottom 430 can comprise a connector port 462. The connector port 462 can be configured to operatively connect the enclosure 226 and the enclosure 426. According to some embodiments, the connector port 462 can be configured to comprise a 12-pin female receptacle. However, any suitable port could be included. According to some embodiments, the center of the connector port 462 can be located about 13 inches from the left side 434 and about 5 inches from the back of the enclosure 426. However, the connector port 462 could be positioned in any suitable location.

As shown in FIG. 14B, the bottom 430 can comprise three cord inlets/outlets 464A, 464B, and 464C. While three cord inlets/outlets are shown in FIG. 14B, any number of cord inlet(s)/outlet(s) ranging from zero to N wherein N is any number greater than zero could be included. Each cord inlet/outlet 464A, 464B, and 464C can comprise an aperture through the bottom 430 of the enclosure 426. Each cord inlet/outlet 464A, 464B, and 464C can be configured such that a cord and/or wiring can extend through the cord inlet/outlet 464A, 464B, and/or 464C. According to some embodiments, each cord inlet/outlet 464A, 464B, and/or 464C can be about 0.5 inches in diameter or circumference. According to some embodiments, each cord inlet/outlet has 0.25-0.35 white cord grip or 0.35-0.45 blue cord grip. According to various embodiments, the cord inlets/outlets 464A, 464B, and 464C can allow any sort of cord and/or wire to pass through such as a power cord, data communication cord, and the like. According to some embodiments, one or more cord inlets/outlets 464A, 464B, and 464C could have 0.25-0.35 white cord grip and one or more inlets/outlets 464A, 464B, and 464C could have 0.35-0.45 blue cord grip. According to some embodiments, the center of the cord inlet/outlet 464A can be located about 13 inches from left side 434 and about 3.5 inches from the back of the enclosure 426, the center of the cord inlet/outlet 464B can be located about 15 inches from the left side 434 and about 3.5 inches from the back of the enclosure 426, and the center of the cord inlet/outlet 464C can be located about 15 inches from the left side 434 and about 5 inches from back of the enclosure 426. However, the cord inlets/outlets 464A, 464B, and 464C could be positioned in any suitable location.

As shown in FIG. 14B, the bottom 430 can comprise a cable inlet/outlet 466. While one cable inlet/outlet 466 is shown in FIG. 14B, any number of cable inlet(s)/outlet(s) ranging from zero to N where N is any number greater than zero could be included on the bottom 430 of the enclosure 426. The cable inlet/outlet 466 can comprise an aperture through the bottom 430 of the enclosure 426. The cable inlet/outlet 466 can be configured such that a cable, cord, and/or wiring can extend through the cable inlet/outlet 466. According to some embodiments, the cable inlet/outlet 466 is about 0.5 inches in diameter or circumference and has 0.5-0.75 cord grip. According to some embodiments, the center of the cable inlet/outlet 466 can be located about 16 inches from the right side 432 and about 5 inches from the back of the enclosure 426. However, the cable inlet/outlet 466 could be positioned in any suitable location.

As shown in FIG. 14B, the bottom 430 can comprise two receptacles 468A, 468B. While two receptacles 468A, 468B are shown in FIG. 14B, any number of receptacles ranging from zero to N where N is any number greater than zero could be included on the bottom 430. Each receptacle 468A, 468B can be an electrical, female receptacle configured to create and/or facilitate an operative connection between electronic components when paired with a male plug. According to some embodiments, each receptacle 468A, 468B can be a 4-wire receptacle. According to some embodiments, a first receptacle 468A is configured to establish connection between the enclosure 426 and the enclosure 626. According to some embodiments, this first receptacle 468A is only included and/or utilized when the system 200 is operating under option #1. According to some embodiments, a second receptacle 468B is configured to establish connection between the enclosure 426 and the enclosure 726 and/or another component. According to some embodiments, this second receptacle 468B is only included and/or utilized when the system 200 is operating under options #2 or #3. According to some embodiments, the center of the receptacle 468A can be located about 9 inches from right side 432 and about 4.5 inches from the back of the enclosure 426. However, the receptacle 468A could be positioned in any suitable location. According to some embodiments, the center of the receptacle 468B can be located about 4.5 inches from right side 432 and about 4.5 inches from the back of the enclosure 426. However, the receptacle 468B could be positioned in any suitable location. According to some embodiments, each of the receptacles 468A, 468B can be installed on a cutout in the bottom 430, wherein each cutout is generally circular and has a diameter of about 2.36 inches.

As shown in FIG. 14B, the bottom 430 can comprise two plugs 470A, 470B. While two plugs 470A, 470B are shown in FIG. 14B, any number of plugs ranging from zero to N where N is any number greater than zero could be included on the bottom 430. Each plug 470A, 470B can be an electrical, male plug configured to create and/or facilitate an operative connection between electronic components when paired with a female receptacle. According to some embodiments, each plug 470A, 470B can be a 4-wire plug. According to some embodiments, a first plug 470A is configured to establish connection between the enclosure 426 and the enclosure 626 by plugging into and/or mating with the receptacle 468A. According to some embodiments, this first plug 470A is only included and/or utilized when the system 200 is operating under option #1. According to some embodiments, a second plug 470B is configured to establish connection between the enclosure 426 and the enclosure 726 and/or another component by plugging into and/or mating with the receptacle 468B. According to some embodiments, this second plug 470B is only included and/or utilized when the system 200 is operating under options #2 or #3. According to some embodiments, the first plug 470A is configured to mate with the first receptacle 468A to establish an operative connection between electronic components. According to some embodiments, the second plug 470B is configured to mate with the second receptacle 468B to establish an operative connection between electronic components.

FIG. 14C shows an external top elevation view of the industrial enclosure 426. FIG. 14C shows the top 428 of the enclosure 426. As shown in FIG. 14C, the top 428 of the enclosure 426 can comprise a cable connector 458. While one cable connector 458 is shown in FIG. 14C, any number of cable connector(s) ranging from zero to N where N is any number greater than zero could be included on the top 428 of the enclosure 426. The cable connector 458 can comprise an aperture through the top 428 of the enclosure 426. The cable connector 458 can be configured such that a cable, cord, and/or wiring can extend through the cable connector 458. According to some embodiments, the cable connector 458 is about 0.5 inches in diameter or circumference and has 0.15-0.25 red cord grip. According to some embodiments, the cable connector 458 is configured such that it can be used to secure a 4-conductor cable. According to some embodiments, the cable connector 458 is configured such that it can be used with a cable that is about 15 feet long. According to some embodiments, the cable connector 458 is only included and/or utilized when the system 200 is operating under option #3. According to some embodiments, the center of the cable connector 458 can be located about 22 inches from right side 432 and about 3 inches from the back of the enclosure 426. However, the cable connector 458 could be positioned in any suitable location.

As shown in FIG. 14C, the top 428 can comprise a cable port 460D that can be the same as any of the cable port(s) 460A, 460B, and 460C on the bottom 430 of the enclosure 426. While one cable port 460D is shown in FIG. 14C, any number of cable port(s) ranging from zero to N where N is any number greater than zero could be included on the top 428 of the enclosure 426. According to some embodiments, the center of the cable port 460D can be located about 19 inches from left side 434 and about 4.5 inches from the back of the enclosure 426. However, the cable port 460D could be positioned in any suitable location.

As shown in FIG. 14C, the top 428 can comprise three cord inlets/outlets 464D, 464E, and 464F. These cord inlets/outlets 464D, 464E, and 464F can be the same as and/or similar to any of the cord inlets/outlets 464A, 464B, and 464C on the bottom 430 of the enclosure 426. While three cord inlets/outlets 464D, 464E, and 464F are shown in FIG. 14C, any number of cord inlets/outlets ranging from zero to N where N is any number greater than zero could be included on the top 428 of the enclosure 426. According to some embodiments, the cord inlets/outlets 464D is only included and/or utilized when the system 200 is operating under option #4. According to some embodiments, the center of the cord inlet/outlet 464D can be located about 19 inches from left side 434 and about 1.5 inches from the back of the enclosure 426, the center of the cord inlet/outlet 464E can be located about 22 inches from the left side 434 and about 1.5 inches from the back of the enclosure 426, and the center of the cord inlet/outlet 464F can be located about 22 inches from the left side 434 and about 3 inches from back of the enclosure 426. However, the cord inlets/outlets 464D, 464E, and 464F could be positioned in any suitable location.

As shown in FIG. 14C, the top 428 can comprise a jacket cable port 474. While one jacket cable port 474 is shown in FIG. 14C, any number of jacket cable port(s) ranging from zero to N where N is any number greater than zero could be included on the top 428 of the enclosure 426. The jacket cable port 474 can comprise an aperture through the top 428 of the enclosure 426. Each jacket cable port 474 can be configured such that a cable, cord, and/or wiring can extend through the jacket cable port 474. According to some embodiments, the jacket cable port 474 can be about 0.5 inches in diameter or circumference. According to some embodiments, the jacket cable port 474 has 0.25-0.35 white cord grip or 0.35-0.45 blue cord grip. According to various embodiments, the jacket cable port 474 can allow any sort of cable, cord, and/or wire to pass through such as a power cord, data communication cord, and the like. According to some embodiments, the jacket cable port 474 can comprise a port and/or receptacle wherein a cable, cord, or wire can be plugged into the jacket cable port 474. According to some embodiments, the jacket cable port 474 can be an RS232 port. According to some embodiments, the jacket cable port 474 can be configured to be able to receive and/or accept a jacket cable and/or an RS232 cable. According to some embodiments, the center of the jacket cable port 474 can be located about 19 inches from left side 434 and about 3 inches from the back of the enclosure 426. However, the jacket cable port 474 could be positioned in any suitable location.

As shown in FIG. 14C, the top 428 can comprise a tower base 472. The tower base 472 can be attached to the top 428 of the enclosure 426 and can be configured to stabilize and secure the sound and light tower 448 to the top 428 of the enclosure 426. According to some embodiments, the center of the tower base 472 can be located about 5 inches from the left side 434 and about 3 inches from the back of the enclosure 426. However, the tower base 472 could be positioned in any suitable location.

FIG. 14D shows an external left-side elevation view of the enclosure 426. FIG. 14D shows the left side 434 of the enclosure 426. As shown in FIG. 14D, the left side 434 can comprise the radio control 450. As shown in FIG. 14D, the left side 434 can comprise a left cover plate 476. The left cover plate 476 can be configured to be able to be secured to the left side 434 by any sort of suitable securing means such as screw(s), nail(s), nut(s) and bolt(s), friction fit, and the like. According to some embodiments, the left cover plate 476 can be for a B24 cutout. The left cover plate 476 can be configured to be installed on the left side 434 to protect and/or enclose internal components within the enclosure 426 when the connector 456 is not installed on the left side 434. When the connector 456 is installed on the left side 434, the connector 456 replaces the left cover plate 476 such that the left cover plate 476 is removed before installing the connector 456. According to some embodiments, the left cover plate 476 can be mounted on a cutout in the left side 434, wherein the cutout is generally rectangular having a length of about 4.449 inches, a width of about 1.26 inches, and wherein the a left side of the cutout is about 4.5 inches from the back of the enclosure 426 and a right side of the cutout is about 5 inches from the front 436 of the enclosure 426. However, the cutout could be of any suitable size and location.

FIG. 14E shows an external right-side elevation view of the enclosure 426. FIG. 14E shows the right side 432 of the enclosure 426. As shown in FIG. 14E, the right side 432 can comprise a right cover plate 478. The right cover plate 478 can be the same as and/or similar to the left cover plate 476. The right cover plate 478 can be configured to be installed on the right side 432 to protect and/or enclose internal components within the enclosure 426 when the connector 454 is not installed on the right side 432. When the connector 454 is installed on the right side 432, the connector 454 replaces the right cover plate 478 such that the right cover plate 478 is removed before installing the connector 454. According to some embodiments, the right cover plate 478 can be mounted on a cutout in the right side 432, wherein the cutout is generally rectangular having a length of about 4.449 inches, a width of about 1.26 inches, and wherein a left side of the cutout is about 2 inches from the front 436 of the enclosure 426 and a bottom of the cutout is about 6.5 inches from the bottom 430 of the enclosure 426. However, the cutout could be of any suitable size and location.

FIGS. 14F-14H show an elevation view of the internal components of the industrial enclosure 426 according to various embodiments. FIG. 14F shows an elevation view of the left side 520 and right side 522 of the internal portion of the enclosure 426. According to some embodiments, a divider panel can separate the left side 520 and the right side 522. As shown in FIG. 14F, the left side 520 can comprise three DIN rails: a first DIN rail 479, a second DIN rail 486, and a third DIN rail 488. Each DIN rail can be and/or comprise any sort of rail or structure capable of mounting electronic components and/or industrial control equipment. According to some embodiments, each DIN rail can be made of metal. According to some embodiments, the center of the first DIN rail 479 can be located about 3.5 inches from top 428 of the enclosure 426, the center of the second DIN rail 486 can be located about 11.25 inches from the top 428 of the enclosure 426, and the center of the third DIN rail 488 can be located about 17.25 inches from the top 428 of the enclosure 426. However, the DIN rails 479, 486, and 488 could be positioned in any suitable location.

As shown in FIG. 14F, the first DIN rail 479 can comprise a controller 480. According to some embodiments, the controller 480 can be the CompactLogix 5370 Controller produced by Allen-Bradley (model number 1769-L27ERM-QBFC1B). The controller 480 can comprise processing unit(s) and/or other subcomponents of computing devices. The controller 480 can be configured to control aspects of the system 200.

As shown in FIG. 14F, the first DIN rail 479 can comprise two outlet modules 482A, 482B. Each of the outlet modules 482A, 482B can be and/or comprise the CompactLogix 8 Pt D/O Relay Module produced by Allen-Bradley (model number 1769-OW8). Each output module 482A, 482B can be configured to manage communication between components of the system 200 including, but not limited to, management of data transfer, management of power loads, and controlling components of the system 200. According to some embodiments, each output module 482A, 482B can be and/or comprise a relay module. A relay module can be a switching device that can operate with low power signals, which enables a low power supply circuit to operate, regulate, or control a higher power supply circuit. According to some embodiments, the output module 482B is only included and/or utilized when the system 200 is operating under option #2.

As shown in FIG. 14F, the first DIN rail 479 can comprise a specialty module 484. According to some embodiments, the specialty module 484 can be and/or comprise the CompactLogix Address Reserve Module produced by Allen-Bradley (model number 1769-ARM). According to some embodiments, the specialty module 484 can be an input/output module, wherein the specialty module can be configured to manage communication between components of the system 200 including, but not limited to, management of data transfer, management of power loads, and controlling components of the system 200. According to some embodiments, when the system 200 is operating under option #2, the specialty module 484 can be replaced by another output module. According to some embodiments, this other output module can be and/or comprise a CompactLogix 2 Pt A/O C and V Module produced by Allen-Bradley (model number 1769-OF2). According to some embodiments, this other output module can be an analog output module. This other output module can be configured to manage communication between components of the system 200 including, but not limited to, management of data transfer, management of power loads, and controlling components of the system 200. According to some embodiments, this other output module can be and/or comprise a relay module.

As shown in FIG. 14F, the first DIN rail 479 can comprise a safety controller 481. According to some embodiments, the safety controller 481 can be and/or comprise the Safety Controller produced by Keyence (model number GC-1000). The safety controller 481 can be compatible with ethernet and can comprise 16 inputs and 6 outputs. The safety controller 481 can be configured to control safety aspects of the system 200. According to some embodiments, the safety controller 481 is configured to cause aspects of the system 200 to perform tasks and/or to cease performing tasks.

As shown in FIG. 14F, the first DIN rail 479 can comprise a safety expansion 483. According to some embodiments, the safety expansion can be the Safety Input/Output Unit produced by Keyence (model number GC-S84). The safety expansion 483 can comprise 8 inputs and 4 inputs. The safety expansion 483 can be compatible with the safety controller 481 and can provide additional inputs and outputs for the safety controller 481. The safety expansion 483 can help the safety controller function.

As shown in FIG. 14F, the first DIN rail 479 can comprise a safety control relay 485. According to some embodiments, the safety control relay 485 can be and/or comprise the Safety IEC Control Relay produced by Allen-Bradley (model number 700S-EF620EJC). According to some embodiments, the safety control relay 485 can function as a relay switch for the safety controller 481. According to some embodiments, the first DIN rail 479 can comprise zero or more end bracket(s) and/or zero or more terminal end stop(s).

As shown in FIG. 14F, the left side 520 of the internal portion of the enclosure 426 can comprise a second DIN rail 486. As shown in FIG. 14F, the second DIN rail 486 can comprise a switch 490. According to some embodiments, the switch 490 can be a Stratix 2000 8T Port Unmanaged Switch produced by Allen-Bradley (model number 1783-US8T). However, any suitable switch with any suitable number of ports could be included. The switch 490 can be configured to disconnect and/or connect different conducting path(s) related to the components of the system 200. Further, the second DIN rail 486 can comprise any suitable number of terminal block(s), grounding terminal block(s), end cover(s), and/or terminal end stop(s). According to some embodiments, the terminal block(s) and grounding terminal block(s) can be 3-hole terminal block(s) and 3-hole grounding terminal block(s).

As shown in FIG. 14F, the left side 520 of the internal portion of the enclosure 426 can comprise a third DIN rail 488. The third DIN rail 488 can comprise any suitable number of terminal block(s), grounding terminal block(s), end cover(s), and/or terminal end stop(s). According to some embodiments, the terminal block(s) and grounding terminal block(s) can be 3-hole terminal block(s) and 3-hole grounding terminal block(s). The third DIN rail 488 can comprise zero or more circuit breaker(s). For example, as shown in FIG. 14F, the third DIN rail 488 can comprise three 2.0 amp circuit breakers 491A, two 5.0 amp circuit breakers 491B, and a 10.0 amp circuit breaker 491C. The circuit breakers 491A can be produced by Allen-Bradley (model number 1492-GH020). The circuit breakers 491B can be produced by Allen-Bradley (model number 1492-GH050). The circuit breakers 491C can be produced by Allen-Bradley (model number 1492-GH100). The third DIN rail 488 can comprise a terminal block relay 493. According to some embodiments, the terminal block relay 493 can be and/or comprise the 24V DC GP Terminal Block Relay produced by Allen-Bradley (model number 700-HLT1Z24).

Depending on which option the system 200 is operating under, the right side 522 of the internal portion of the enclosure 426 can include different components and/or utilize different components. FIG. 14F shows the right side 522 when the system 200 is operating under option #1. As shown in FIG. 14F, according to some embodiments, the right side 522 can comprise a switch and cartridge body 492. According to some embodiments, the switch and cartridge body 492 can comprise a disconnect switch, an operating handle, a 35A fuse, and/or a 40A fuse. According to some embodiments, the disconnect switch can be and/or comprise the 194R Disconnect Switch produced by Allen-Bradley (model number 194R-J60-1753), the operating handle can be and/or comprise the 194R Internal Operating Handle produced by Allen-Bradley (model number 194R-N1), the 35A fuse can be and/or comprise the Class J fuse with an ampere rating of 35 with cartridge-style construction produced by Littelfuse (model number JTD035ID), and the 40A fuse can be and/or comprise the Class J fuse with an ampere rating of 40 with cartridge-style construction produced by Littelfuse (model number JTD040).

As shown in FIG. 14F, the right side 522 can comprise a power distribution block 494. According to some embodiments, the power distribution block 494 can comprise the 3-Pole Power Distribution Block produced by Littelfuse (model number LFD14003Z). Alternatively or additionally, the power distribution block 494 can comprise a cover. According to some embodiments, the cover can be and/or comprise the Cover for Distribution Block produced by Littelfuse (model number LPBC13). According to some embodiments, the power distribution block 494 can have 1 to 4 poles.

As shown in FIG. 14F, the right side 522 can comprise a fuse holder and fuse 496. According to some embodiments, the fuse holder and fuse 496 can comprise the 3 Pole Fuse Holder produced by Allen-Bradley (model number 1492-FB3C30-L) and the Class CC fuse with an ampere rating of 2 produced by Littelfuse (model number CCMR002). However, any fuse holder and fuse could be included. According to some embodiments, the fuse holder and fuse 496 can be mounted on a DIN rail wherein the DIN rail comprises a terminal end stop. According to some embodiments, this DIN rail can be about 3 inches in length and its center can be located about 9 inches from the top 428 of the enclosure 462. However, this DIN rail could be positioned in any suitable location and could be of any suitable size

As shown in FIG. 14F, the right side 522 can comprise a fourth DIN rail 500 and a fifth DIN rail 502. As shown in FIG. 14F, the fourth DIN rail 500 can comprise a power supply 498. According to some embodiments the power supply 498 can be and/or comprise the TRIO3-PS/3AC/24DC/20 power supply produced by Phoenix Contact (model number 1159044). However, the power supply 498 could be any suitable power supply. According to some embodiments, the power supply 498 can include a 3-phase input and a 24 V DC/20 A output. The fourth DIN rail 500 can comprise a protector 499. According to some embodiments, the protector 499 can be and/or comprise MCB Supplementary Protector 20 A produced by Allen-Bradley (model number 1492-SPM1B200). However, the protector 499 can be any suitable circuit protector. The protector 499 can be configured to provide overcurrent protection for aspect(s) of a circuit. According to some embodiments, the fourth DIN rail 500 can be about 6.5 inches in length and the center of the fourth DIN rail 500 can be located about 16 inches from top 428 of the enclosure 426 and the fifth DIN rail 502 can be about 10.5 inches in length and the center of the fifth DIN rail 502 can be located about 4.75 inches from the top 428 of the enclosure 426. However, the DIN rails 500 and 502 could be positioned in any suitable location and could be of any suitable size.

According to some embodiments, the fourth DIN rail 500 can comprise any suitable number of terminal block(s), grounding terminal block(s), end cover(s), and/or terminal end stop(s). According to some embodiments, the terminal block(s) and grounding terminal block(s) can be 3-hole terminal block(s) and 3-hole grounding terminal block(s).

As shown in FIG. 14F, according to some embodiments, the fifth DIN rail 502 can comprise a circuit breaker 501. According to some embodiments, the circuit breaker 501 can be and/or comprise the Motor Protection Circuit Breaker produced by Allen-Bradley (model number 140MT-C3E-C10). However, the circuit breaker 501 could be any suitable circuit breaker. According to some embodiments, the circuit breaker 501 can be a 6.3 to 10 A motor protection circuit breaker. As shown in FIG. 14F, according to some embodiments, the fifth DIN rail 522 can comprise two circuit breakers 501.

As shown in FIG. 14F, according to some embodiments, the fifth DIN rail 502 can comprise a busbar 503. According to some embodiments, the busbar 503 can be and/or comprise the Compact Bus Bar-64 A produced by Allen-Bradley (model number 140M-C-W453N). However, the busbar 503 could be any suitable busbar. According to some embodiments, the busbar 503 can be suitable for a maximum current of 64 A and can be a 3-position busbar. According to some embodiments, the busbar 503 can comprise multiple busbars.

As shown in FIG. 14F, according to some embodiments, the fifth DIN rail 502 can comprise a terminal 505 for the busbar 503. According to some embodiments, the terminal 505 can be and/or comprise the Compact Bus Bar Feeder Terminal produced by Allen-Bradley (model number 140M-C-WTEN). However, the terminal 505 could be any suitable terminal, such as any suitable feeder terminal. According to some embodiments, the terminal 505 an be a 3-pole feeder terminal.

As shown in FIG. 14F, according to some embodiments, the fifth DIN rail 502 can comprise a connecting module 507. According to some embodiments, the connecting module 507 can be and/or comprise the 16A Eco Connecting Module produced by Allen-Bradley (model number 140MT-C-PE16). However, the connecting module 507 could be any suitable connecting module. According to some embodiments, the connecting module 507 can be an 18 A connecting module. As shown in FIG. 14F, according to some embodiments, the fifth DIN rail 522 can comprise two connecting modules 507.

As shown in FIG. 14F, according to some embodiments, the fifth DIN rail 502 can comprise a safety contactor 508. According to some embodiments, the safety contactor 508 can be and/or comprise the IEC 9 A Safety Contactor produced by Allen-Bradley (model number 100S-E09EJ14C). However, the safety contactor 508 could be any suitable safety contactor. According to some embodiments, the safety contactor 508 can be 9 A, 24 V DC low consumption safety contactor. As shown in FIG. 14F, according to some embodiments, the fifth DIN rail 522 can comprise two safety contactors 508. According to some embodiments, each connecting module 507 can be configured to connect a circuit breaker 501 to a safety contactor 508.

As shown in FIG. 14F, according to some embodiments, the fifth DIN rail 502 can comprise a cover 511. According to some embodiments, the cover 511 can be and/or comprise the Compact Busbar Terminal Cover produced by Allen-Bradley (model number 140M-C-WSN). However, the cover 511 could be any suitable cover. According to some embodiments, the cover 511 can be configured to act as a terminal cover for the busbar 503 and/or the terminal 505.

As shown in FIG. 14F, according to some embodiments, the right side 522 can comprise a ground bar 504. According to some embodiments, the ground bar 504 can be and/or comprise the 10-Terminal Ground Bar Kit produced by Cutler Hammer (model number GBK10). However, the ground bar 504 can comprise any suitable ground bar. According to some embodiments, the ground bar 504 can be a 10-terminal ground bar. According to some embodiments, the ground bar 504 can be located about 1 inch from the bottom 430 of the enclosure 426. However, the ground bar 504 could be positioned in any suitable location.

FIG. 14G shows an internal elevation view of the right side 522 of the enclosure 426 when the system 200 is operating under option #2. As shown in FIG. 14G, the fifth DIN rail 502 can include and/or utilize different components than when the system 200 is operating under option #1. As shown in FIG. 14G, the fifth DIN rail 502, when operating under option #2, can comprise a circuit breaker 506 in addition to the circuit breakers 501. The circuit breaker 506 can be and/or comprise the Motor Protection Circuit Breaker produced by Allen-Bradley (model number 140MT-C3E-C20). However, the circuit breaker 506 can be and/or comprise any suitable circuit breaker. According to some embodiments, the circuit breaker 506 can be a 14.5 to 20 A motor protection circuit breaker.

As shown in FIG. 14G, the fifth DIN rail 502, when the system 200 is operating under option #2, can comprise another safety contactor 509. The safety contactor 509 can be and/or comprise the 23 A Safety Contactor produced by Allen-Bradley (model number 100S-C23EJ14BC). However, the safety contactor 509 can be and/or comprise any suitable safety contactor. According to some embodiments, the safety contactor 509 can be a 23 A, 24 V DC safety contactor and can comprise an electric coil.

As shown in FIG. 14G, the DIN rail 502 when operating under option #2 can comprise some of the components shown on the DIN rail 502 in FIG. 14F.

FIG. 14H shows an internal elevation view of the right side 522 of the enclosure 426 when the system 200 is operating under option #3. As shown in FIG. 14H, the right side 522 can include and/or utilize different components than when the system 200 is operating under either option #1 or #2. As shown in FIG. 14H, the fifth DIN rail 502 can comprise a pin relay and socket 510. According to some embodiments, the pin relay and socket 510 can comprise a pin relay socket and a pin relay. According to some embodiments, the pin relay socket can be and/or comprise the 3-pole Track-Mounted Relay Socket produced by Omron (model number PF113A-E) and the pin relay can be and/or comprise the Pin Relay produced by Omron (model number MKS3PI-DC24). However, the pin relay and socket 510 could comprise any suitable pin relay socket and pin relay. According to some embodiments, the pin relay and socket 510 can comprise an 11-pin pin relay socket and an 11-pin 24 V DC pin relay.

As shown in FIG. 14H, the right side 522, when the system 200 is operating under option #3, can comprise and/or utilize a drive 512. According to some embodiments, the drive 512 can be and/or comprise the PowerFlex 525 5.5 kW (7.5 Hp) AC Drive produced by Allen-Bradley (model number 25B-D013N104). However, the drive 512 could comprise any suitable drive, such as any electronic drive. According to some embodiments, the drive 512 can be compatible with ethernet, 480 VAC, 3-phase, and 7.5 Hp.

As shown in FIG. 14H, the DIN rail 502 when operating under option #3 can comprise some of the components shown on the DIN rail 502 in FIGS. 14F and/or 14G.

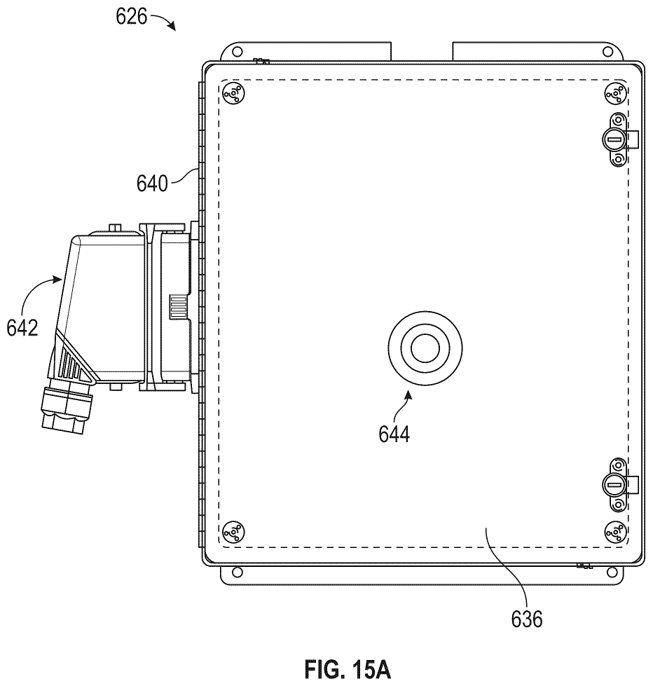

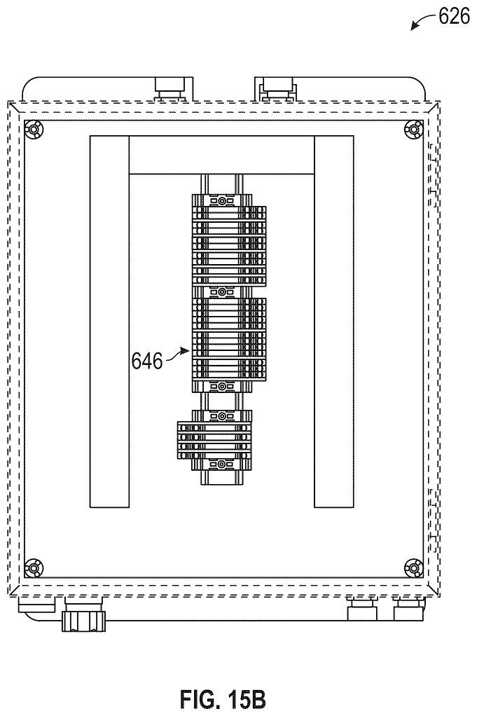

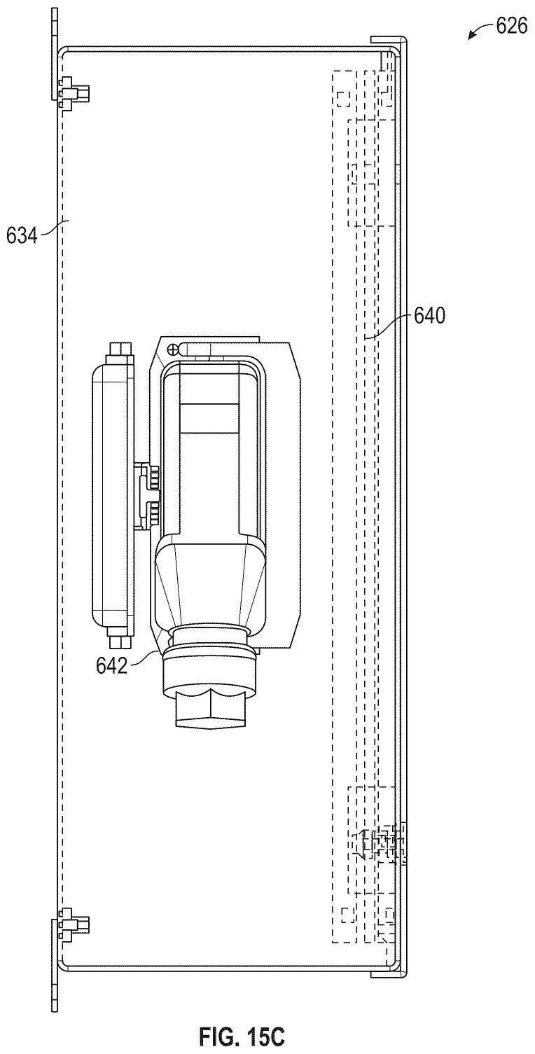

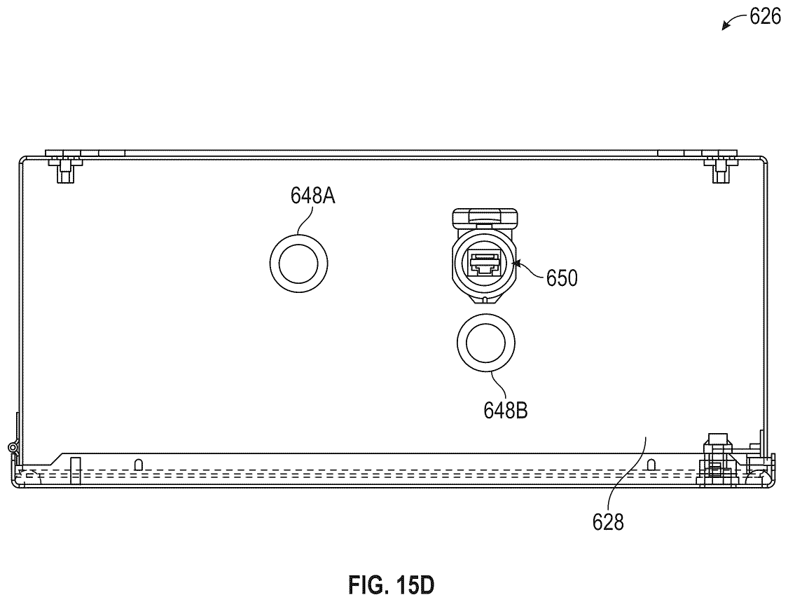

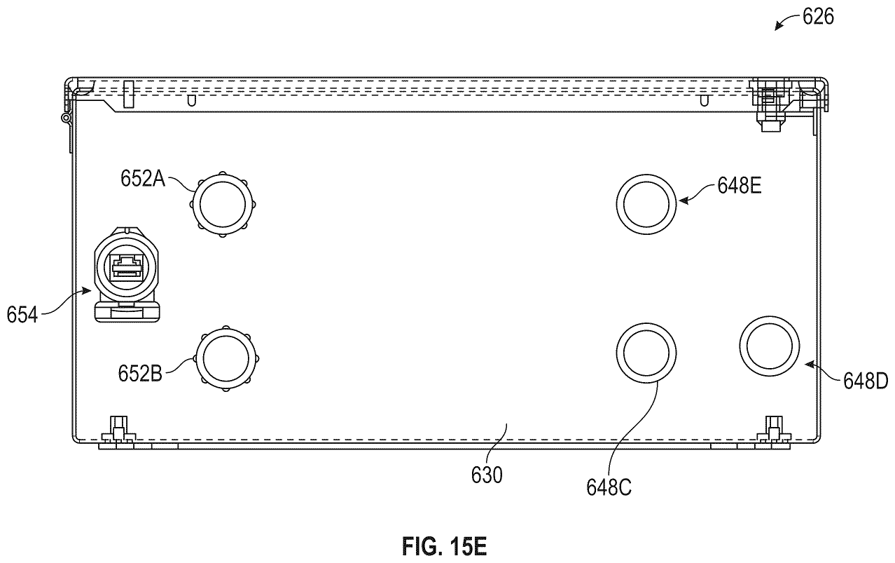

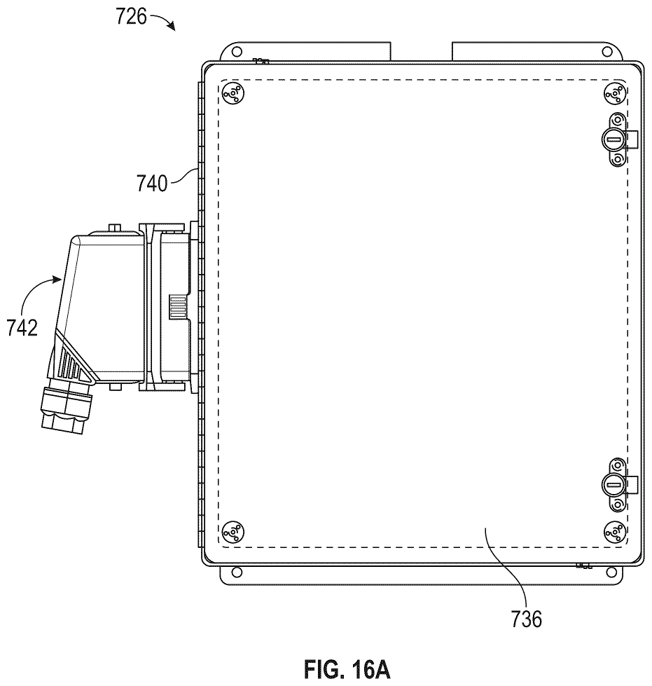

FIGS. 15A-E show various elevation views of the industrial enclosure 626 associated with controlling the tailstock portion 205 of the positioner 200. Components and/or aspects of the industrial enclosure 626 can be the same as and/or similar to and can function in the same and/or similar manner as corresponding and/or like components and/or aspects of any other industrial enclosure described herein such as the industrial enclosure 126, the industrial enclosure 226, the industrial enclosure 426, and /r the industrial enclosure 726.

FIG. 15A shows a front elevation view of the enclosure 626. As shown in FIG. 15A, the enclosure 626 can comprise a front 636 wherein the front 636 comprises an emergency stop button 644. The front 636 can be hingedly connected to the rest of the enclosure 626 via a hinge 640. The hinge 640 can be the same and/or similar as any hinge described herein. The emergency stop button 644 can be the same as and/or similar to either of the emergency stop buttons 242 or 442. According to some embodiments, the center of the emergency stop button 644 can be located about 7.125 inches from the right side of the enclosure 626 and about 7 inches from the bottom 630 of the enclosure 626. However, the emergency stop button 644 could be positioned in any suitable location.

FIG. 15B shows an internal elevation view of internal components of the enclosure 626. As shown in FIG. 15B, the internal portion of the enclosure 626 can comprise a DIN rail 646. According to some embodiments, the DIN rail 646 can be about 10 inches in length and the mid-point of the width of the DIN rail 646 can be positioned about 6.5 inches from the right side of the enclosure 626, however, the DIN rail 646 could be any suitable length and could be positioned in any suitable location. According to some embodiments, the DIN rail 646 can comprise any suitable number of terminal block(s), grounding terminal block(s), end cover(s), and/or terminal end stops. According to some embodiments, the terminal block(s) and grounding terminal block(s) can be 3-hole terminal block(s) and 3-hole grounding terminal block(s) and the end cover(s) can be configured to cover the terminal block(s).

FIG. 15C shows left-side elevation view of the enclosure 626. As shown in FIG. 15C, the enclosure 626 can comprise a left side 634 wherein the left side 634 comprises a connector 642. According to some embodiments, the connector 642 is operatively attached to the connector 454 such that the two connectors 642, 454 are operatively connected via a cable, or other suitable means, wherein each connector 642, 454 are on opposite ends of the cable. The connectors 642, 454 serve to operatively connect the enclosure 426 and the enclosure 626 such that the enclosures 426, 626, and their respective components, are in communication with each other. According to some embodiments, the connector 642 is the same as and/or similar to the connector 454. According to some embodiments, the connector 642 can be mounted on a cutout in the left side 634, wherein the cutout is generally rectangular having a length of about 4.449 inches and a width of about 1.26 inches, and wherein a left side of the cutout is about 2 inches from the back of the enclosure 626 and a bottom of the cutout is about 6 inches from the bottom 630 of the enclosure 626. However, the cutout could be of any suitable size and location.

FIG. 15D shows a top elevation view of the enclosure 626. As shown in FIG. 15D, the enclosure 626 can comprise a top 628, wherein the top 628 can comprise two cord inlets/outlets 648A, 648B and a cable port 650. Each cord inlet/outlet 648A, 648B can be the same as and/or similar to any of the cord inlets/outlets 464A, 464B, 464C, 464D, 464E, and/or 464F. The cable port 650 can be the same as and/or similar to any of the cable ports 460A, 460B, 460C, and/or 460D. While two cord inlets/outlets 648A, 648B and one cable port 650 are shown in FIG. 15D, any suitable number of cord inlet(s)/outlet(s) and/or cable ports(s) could be included on the top 628. According to some embodiments, the center of the cord inlet/outlet 648A can be located about 2 inches from the back and about 5.25 inches from the left side 634 of the enclosure 626, the center of the cord inlet/outlet 648B can be located about 3.5 inches from the back and about 5.25 inches from the right side of the enclosure 626, and the center of the cable port 650 can be located about 2 inches from the back and about 5.25 inches from the right side of the enclosure 626. However, the cord inlets/outlets 648A, 648B and cable port 650 could be positioned in any suitable location.

FIG. 15E shows a bottom elevation view of the enclosure 626. As shown in FIG. 15E, the enclosure 626 can comprise a bottom 630, wherein the bottom 630 can comprise three cord inlets/outlets 648C, 648D, and 648E, a cable port 654, and two cord inlets/outlets 652A, 652B. Each cord inlet/outlet 648C, 648D, and 648E can be the same as and/or similar to any of the cord inlets/outlets 464A, 464B, 464C, 464D, 464E, 464F, 648A, and/or 648B. Each cord inlet/outlet 652A, 652B can be the same as and/or similar to the cord inlet/outlet 466. The cable port 654 can be the same as and/or similar to any of the cable ports 460A-D or 650. While three cord inlets/outlets 648C, 648D, and 68E, one cable port 654, and two cord inlets/outlets 652A, 652B are shown in FIG. 15E, any suitable number of cord inlet(s)/outlet(s) or cable ports(s) could be included on the top 628. According to some embodiments, the center of the cord inlet/outlet 648C can be located about 1.75 inches from the back and about 2.5 inches from the left side 634 of the enclosure 626, the center of the cord inlet/outlet 648D can be located about 1.75 inches from the back and about 1 inch from the left side 634 of the enclosure 626, and the center of the cord inlet/outlet 648E can be located about 4 inches from the back and about 2.5 inches from the left side 634 of the enclosure 626. However, the cord inlets/outlets 648C, 648D, 648E could be positioned in any suitable location. According to some embodiments, the center of the cord inlet/outlet 652A can be located about 4 inches from the back and about 2.5 inches from the right side of the enclosure 626, the center of the cord inlet/outlet 652B can be located about 1.75 inches from the back and about 2.5 inches from the right side of the enclosure 626, and the center of the cable port 654 can be located about 2.875 inches from the back and about 1 inch from the right side of the enclosure 626. However, the cord inlets/outlets 652A, 652B and the cable port 654 could be positioned in any suitable location.

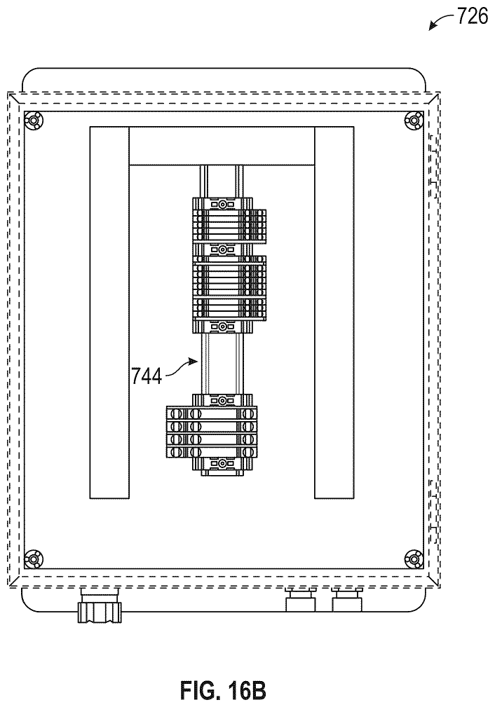

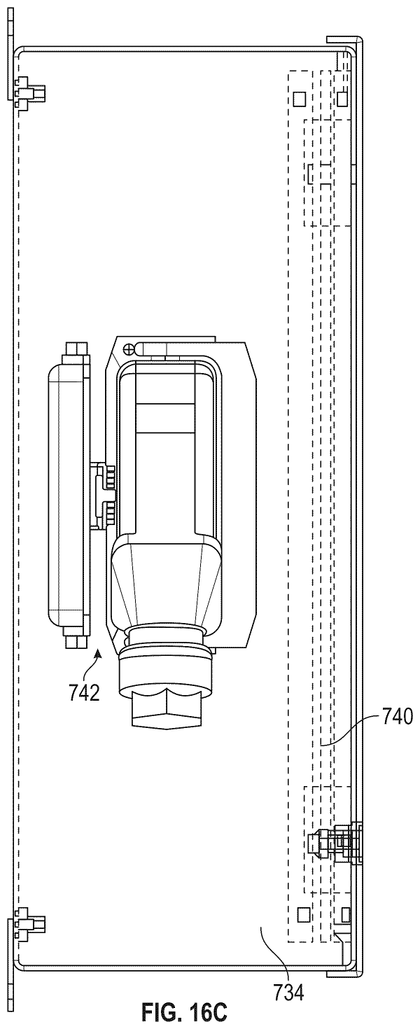

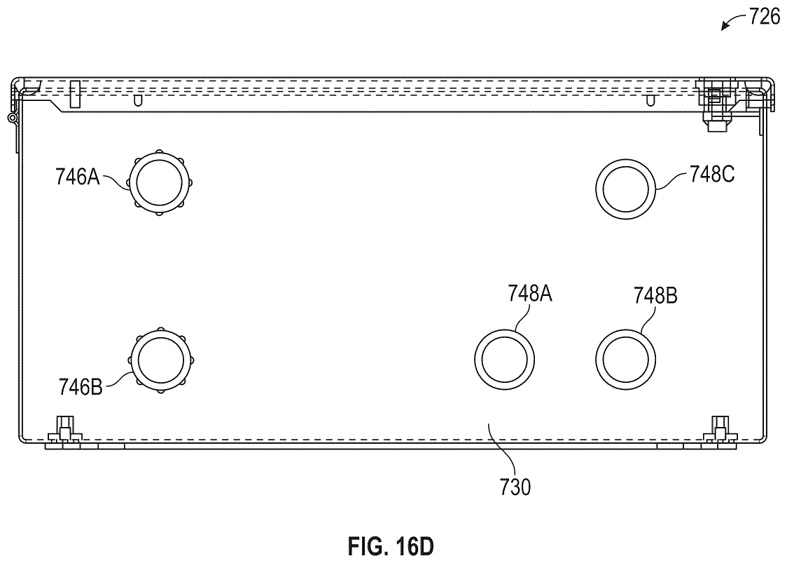

FIGS. 16A-D show various elevation views of the enclosure 726 associated with an external HPU. Components and/or aspects of the industrial enclosure 726 can be the same as and/or similar to and can function in the same and/or similar manner as corresponding and/or like components and/or aspects of any other industrial enclosure described herein such as the industrial enclosure 126, the industrial enclosure 226, the industrial enclosure 426, and/or the industrial enclosure 626.

FIG. 16A shows a front elevation view of the enclosure 726. As shown in FIG. 16A, the enclosure 726 can comprise a front 736 wherein the front 736 can be hingedly connected to the rest of the enclosure 726 via a hinge 740. The hinge 740 can be the same and/or similar as any hinge described herein.

FIG. 16B shows an internal elevation view of internal components of the enclosure 726. As shown in FIG. 16B, the internal portion of the enclosure 726 can comprise a DIN rail 744. According to some embodiments, the DIN rail 744 can be about 10 inches in length and the mid-point of the width of the DIN rail 744 can be positioned about 6.5 inches from the right side of the enclosure 726, however, the DIN rail 744 could be any suitable length and could be positioned in any suitable location. According to some embodiments, the DIN rail 744 can comprise any suitable number of terminal block(s), grounding terminal block(s), end cover(s), and/or terminal end stops. According to some embodiments, the terminal block(s) and grounding terminal block(s) can be 3-hole terminal block(s) and 3-hole grounding terminal block(s) and the end cover(s) can be configured to cover the terminal block(s). Alternatively or additionally, according to some embodiments, the DIN rial 744 can comprise any number of 3-hole large ground terminal block(s), 8A terminal block twin(s), and/or 8A terminal block end cover(s).

FIG. 16C shows a left-side elevation view of the enclosure 726. As shown in FIG. 16C, the enclosure 726 can comprise a left side 734. As shown in FIG. 16C, the left side 734 can comprise a connector 742. According to some embodiments, the connector 742 is operatively attached to the connector 456 such that the two connectors 742, 456 are operatively connected via a cable, or other suitable means, wherein each connector 742, 456 are on opposite ends of the cable. The connectors 742, 456 serve to operatively connect the enclosure 426 and the enclosure 726 such that the enclosures 426, 726, and their respective components, are in communication with each other. According to some embodiments, the connector 742 is the same as and/or similar to the connector 456. According to some embodiments, the connector 742 can be mounted on a cutout in the left side 734, wherein the cutout is generally rectangular having a length of about 4.449 inches and a width of about 1.26 inches, and wherein a left side of the cutout is about 2 inches from the back of the enclosure 726 and a bottom of the cutout is about 6 inches from the bottom 730 of the enclosure 626. However, the cutout could be of any suitable size and location.

FIG. 16D shows a bottom elevation view of the enclosure 726. As shown in FIG. 16D, the enclosure 726 can comprise a bottom 730. As shown in FIG. 16D, the bottom 730 can comprise two cord inlets/outlets 746A, 746B and three cored inlets/outlets 748A, 748B, and 748C. Each cord inlet/outlet 746A, 746B can be the same as and/or similar to any of the cord inlets/outlets 466, 652A, and/or 652B. The cord inlets/outlets 748A, 748B, and 748C can be the same as and/or similar to any of the cord inlets/outlets 464A, 464B, 464C, 464D, 464E, 464F, 648A, 648B, 648C, 648C, and/or 648E. While two cord inlets/outlets 746A, 746B and three cord inlets/outlets 748A, 748B, and 748C are shown in FIG. 16D, any suitable number of cord inlet(s)/outlet(s) could be included on the bottom 730. According to some embodiments, the center of the cord inlet/outlet 748A can be located about 1.75 inches from the back and about 4.5 inches from the right side of the enclosure 726, the center of the cord inlet/outlet 748B can be located about 1.75 inches from the back and about 3 inches from the right side of the enclosure 726, and the center of the cord inlet/outlet 748C can be located about 4 inches from the back and about 3 inches from the right side of the enclosure 726. However, the cord inlets/outlets 748A, 748B, 748C could be positioned in any suitable location. According to some embodiments, the center of the cord inlet/outlet 746A can be located about 4 inches from the back and about 3 inches from the left side 734 of the enclosure 726 and the center of the cord inlet/outlet 746V can be located about 1.75 inches from the back and about 3 inches from the left side 734 of the enclosure 726. However, the cord inlets/outlets 746A, 746B could be positioned in any suitable location.

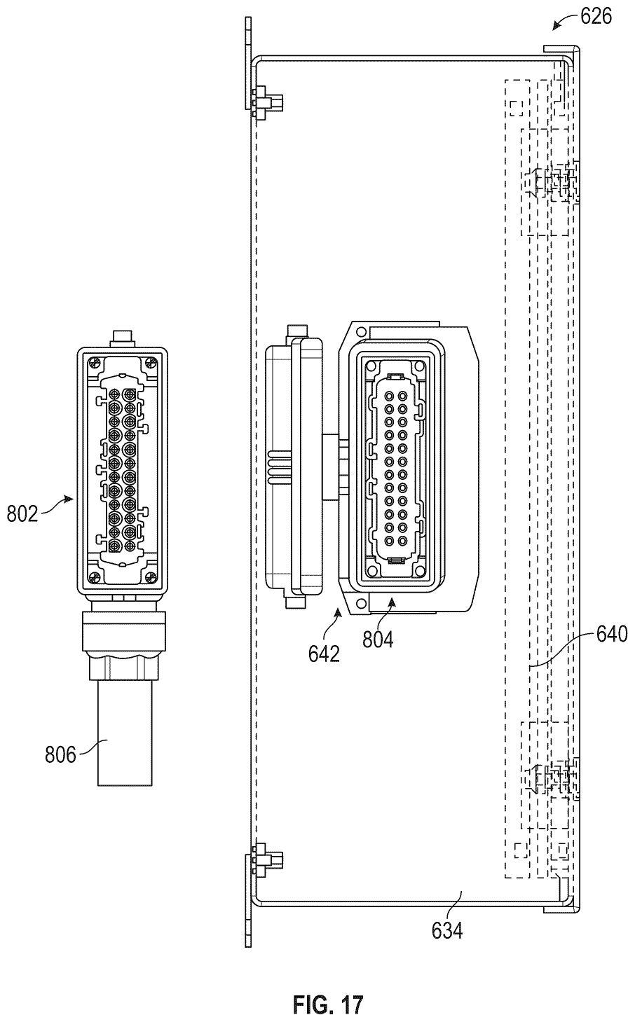

FIG. 17 shows a left side elevation view of the enclosure 626 according to some embodiments. As shown in FIG. 17, the connector 642 can comprise a female portion 802 and a male portion 804. The female portion 802 and male portion 804 can be configured such that the two portions 802, 804 can mate with each other to create an operative connection between components. According to some embodiments, the female portion 802 can comprise female pin connections and the male portion 804 can comprise male pin connections. As shown in FIG. 17, the male portion 804 can be attached and/or mounted to the left side 634 of the enclosure 626. The female portion 802 can be removable from the male portion 804. Further, as shown in FIG. 17, the female portion 802 can comprise a cable 806. The cable 806 can create and/or facilitate operative connection between the enclosure 626 and the enclosure 426. The cable 806 can be any suitable cable, cord, wire, conductor, and the like capable of performing electrical communication. According to some embodiments, the cable 806 should be angled down when the female portion 802 and male portion 804 are connected.

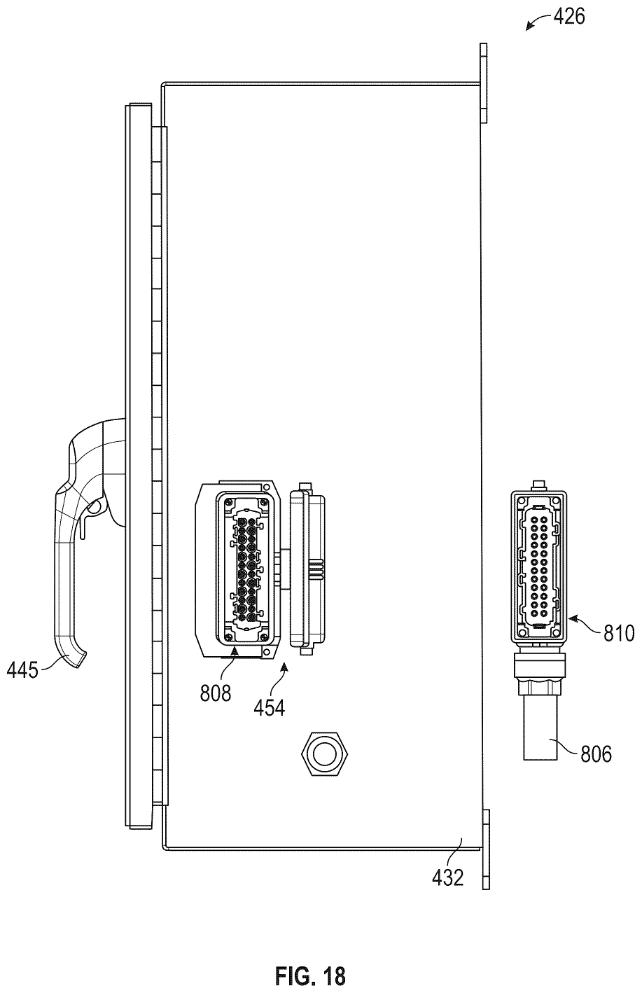

FIG. 18 shows a right-side elevation view of the enclosure 426 according to some embodiments. As shown in FIG. 18, the connector 454 can comprise a female portion 808 and a male portion 810. The female portion 808 can be the same as and/or similar to the female portion 802. The male portion 810 can be the same as and/or similar to the male portion 804. As shown in FIG. 18, the female portion 808 can be attached and/or mounted to the right side 432 of the enclosure 426, and the male portion 810 can be removable from the female portion 808. Further, as shown in FIG. 18, the male portion 810 can comprise the cable 806. Thus, one end of the cable 806 can comprise the male portion 810 and the other end can comprise the female portion 802. Therefore, when the female portion 808 and the male portion 810 are connected and the female portion 802 and the male portion 804 are connected, the enclosure 426 and 626 are in operative communication with each other. According to some embodiments, the cable 806 should be angled down when the female portion 808 and male portion 810 are connected.

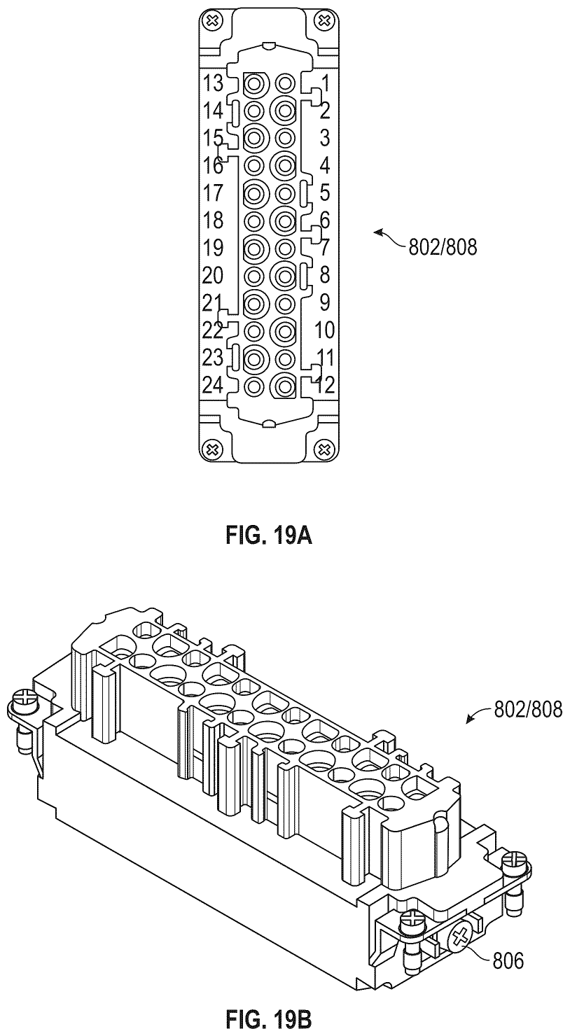

FIG. 19A shows an elevation view of each female portion 802/808, and FIG. 19B shows a perspective view of each female portion 802/808 according to some embodiments. As shown in FIG. 19B, each female portion 802/810 can comprise a ground screw 812. According to some embodiments, each connector 454, 456, 642, 742 must be grounded. Each connector can be grounded by wiring the ground screw 812 of each connector to a grounding point in each connector's respective enclosure. As shown in FIGS. 19A-B, each female portion 802/808 can have 24 female pin connections. However, any suitable number of pin connections could be included.

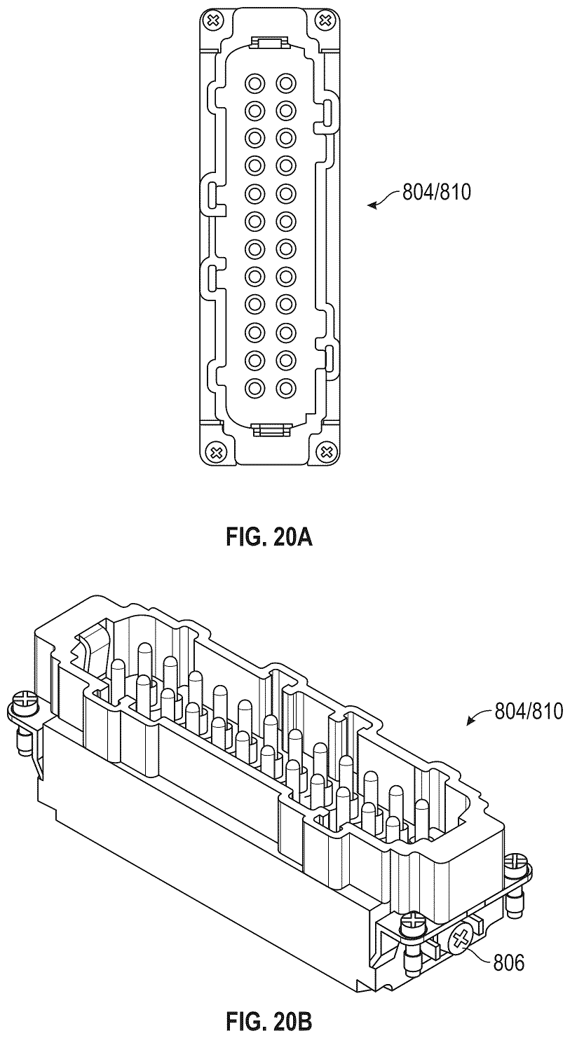

FIG. 20A shows an elevation view of each male portion 804/810, and FIG. 20B shows a perspective view of each male portion 804/810 according to some embodiments. As shown in FIG. 20B, each male portion 804/810 can comprise a ground screw 812. As shown in FIGS. 20A-B, each male portion 804/810 can have 24 male pin connections. However, any suitable number of pin connections could be included.

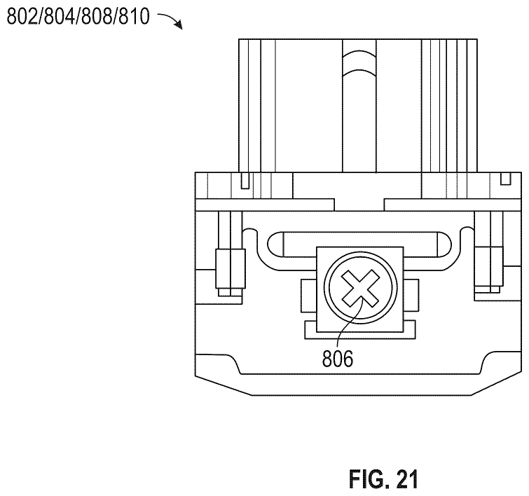

FIG. 21 shows an elevation view of a female and/or male portion 802/808, 804/810 according to some embodiments. The grounding screw 812 is shown in FIG. 21.

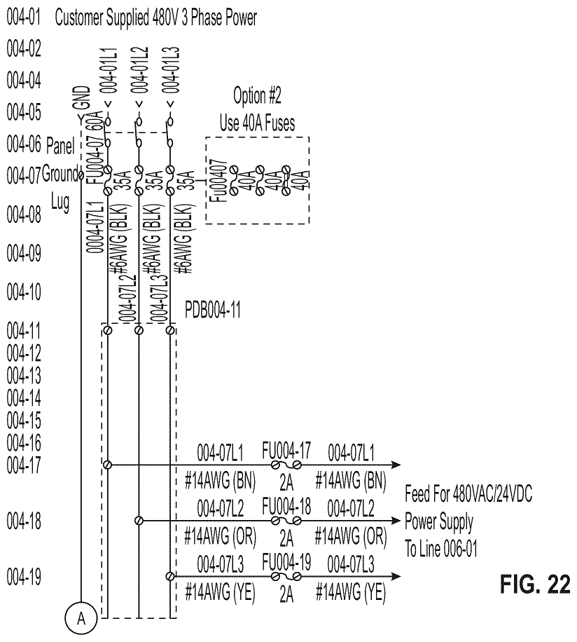

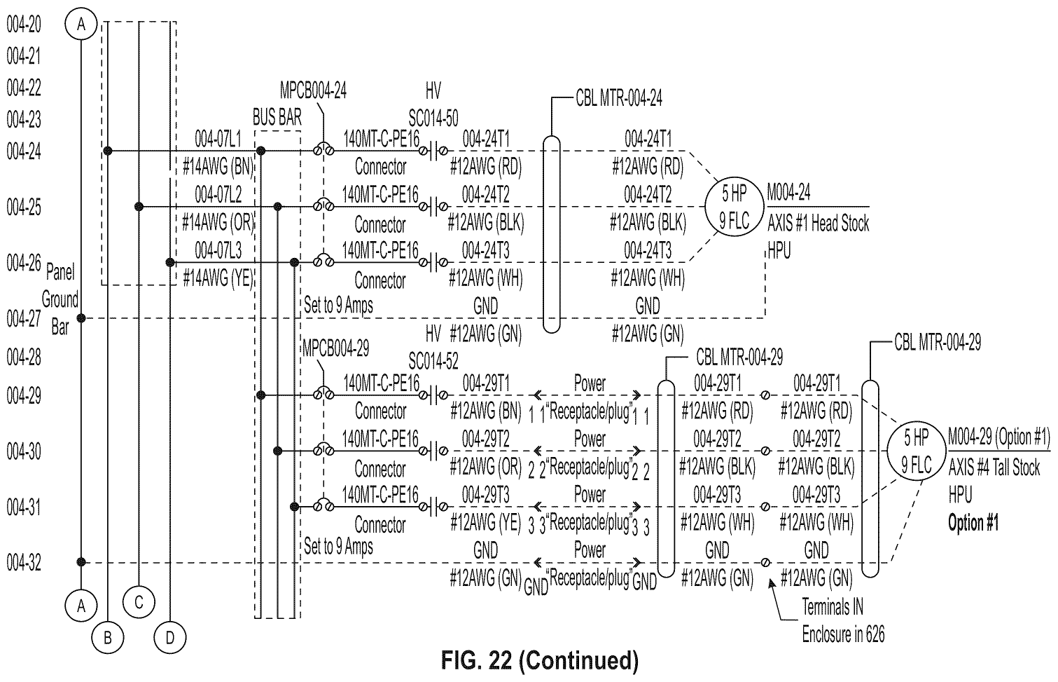

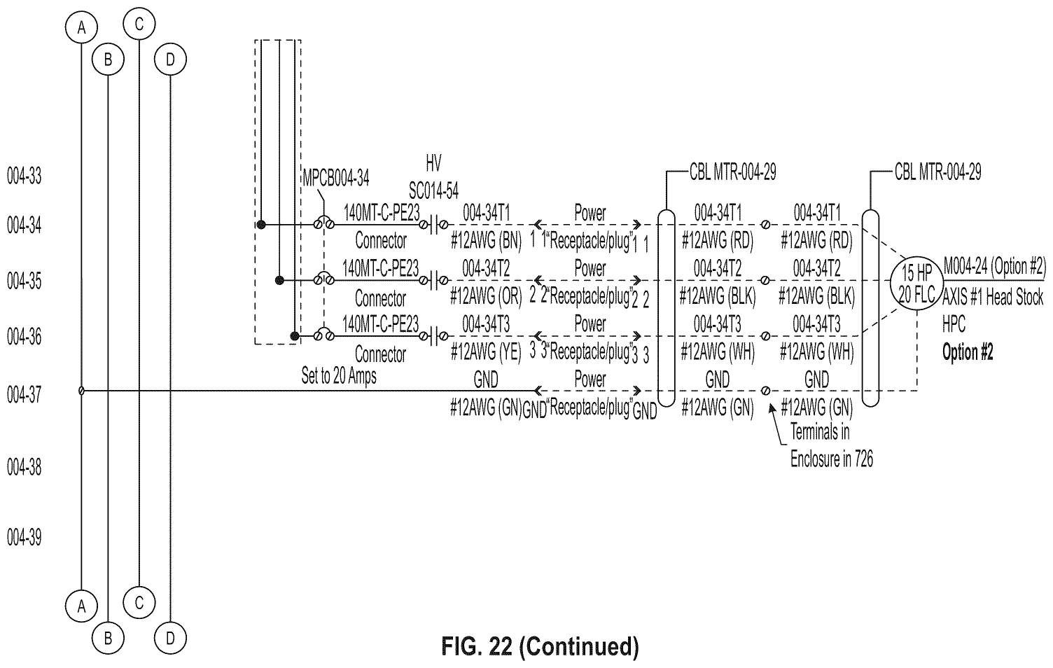

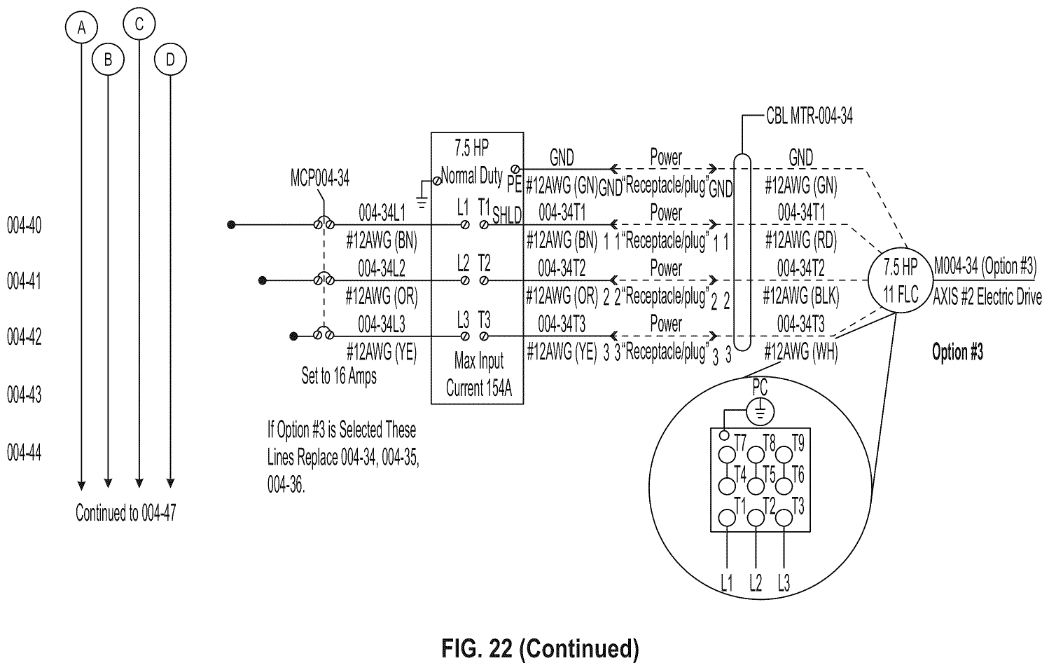

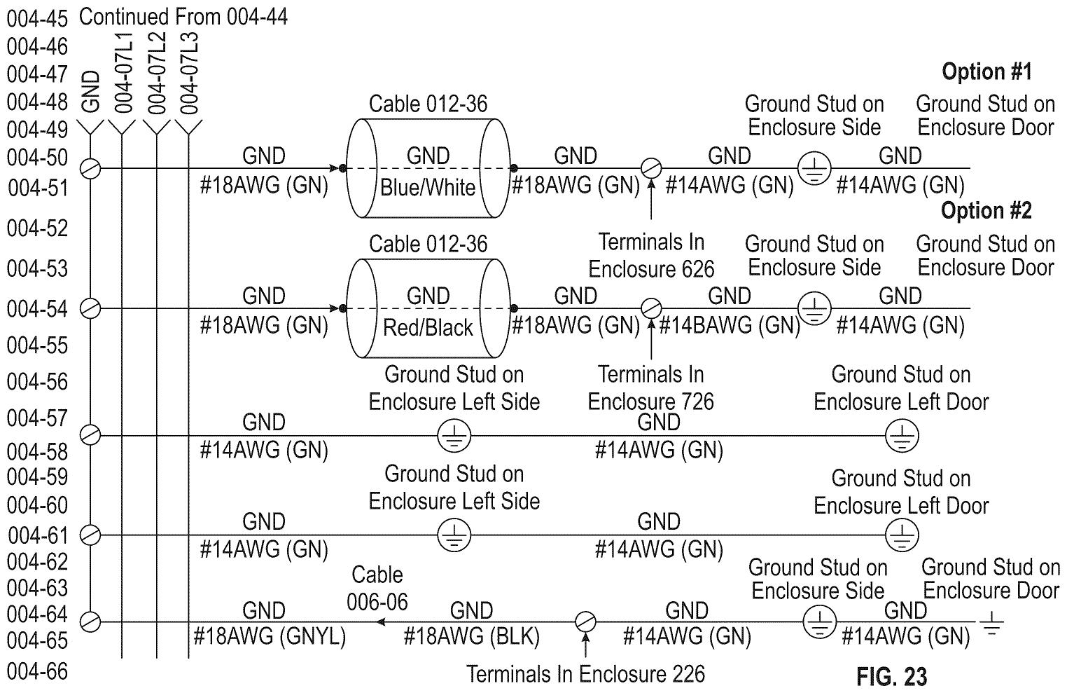

FIGS. 22-39 show various schematic diagrams related to circuitry of the system 200 according to some embodiments. The various schematic diagrams are for example purposes only. FIGS. 22-39 show circuitry options depending under which option the system 200 is operating. FIGS. 22 and 23 show schematic diagrams of circuitry relating to electrical controls regarding 480 VAC power distribution according to some embodiments.

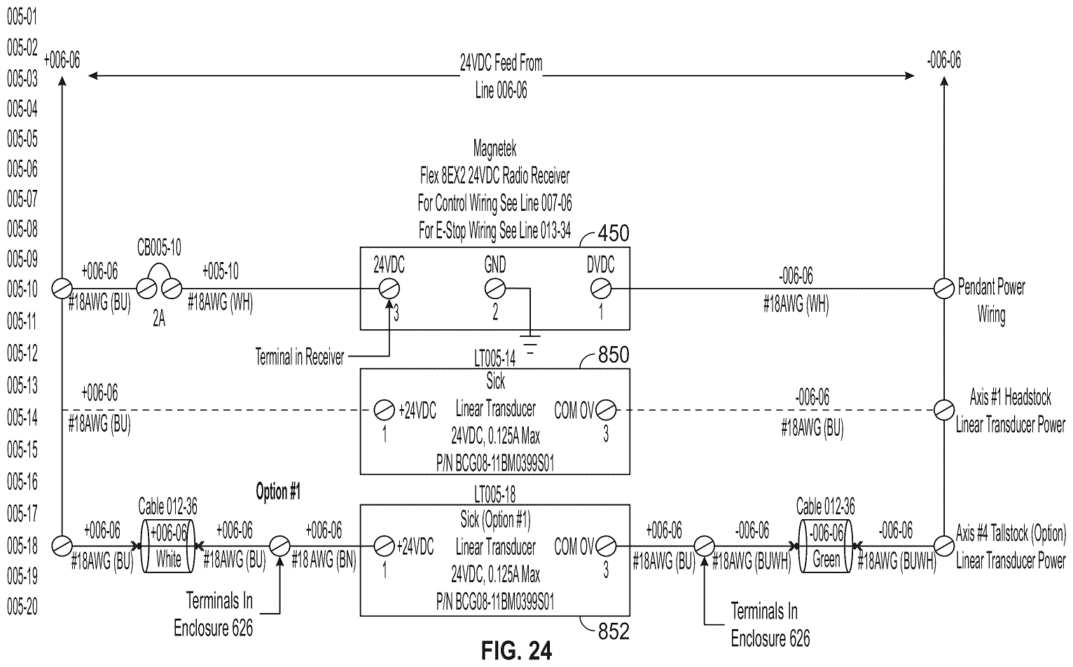

FIGS. 24-26 show schematic diagrams of circuitry relating to electrical controls regarding 24 V DC power distribution according to some embodiments.

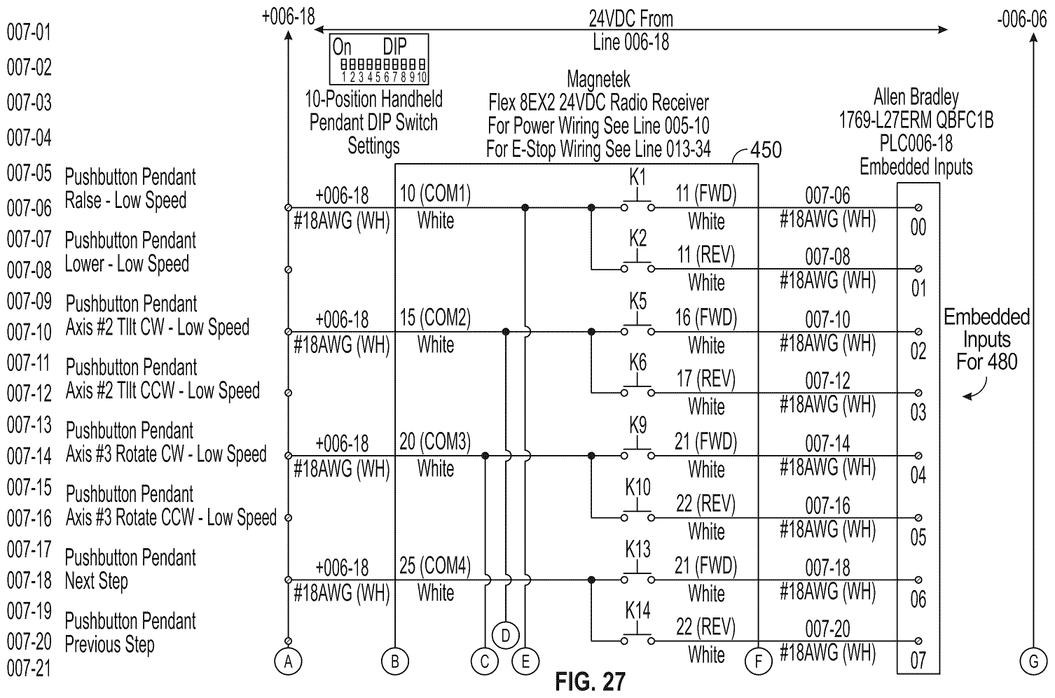

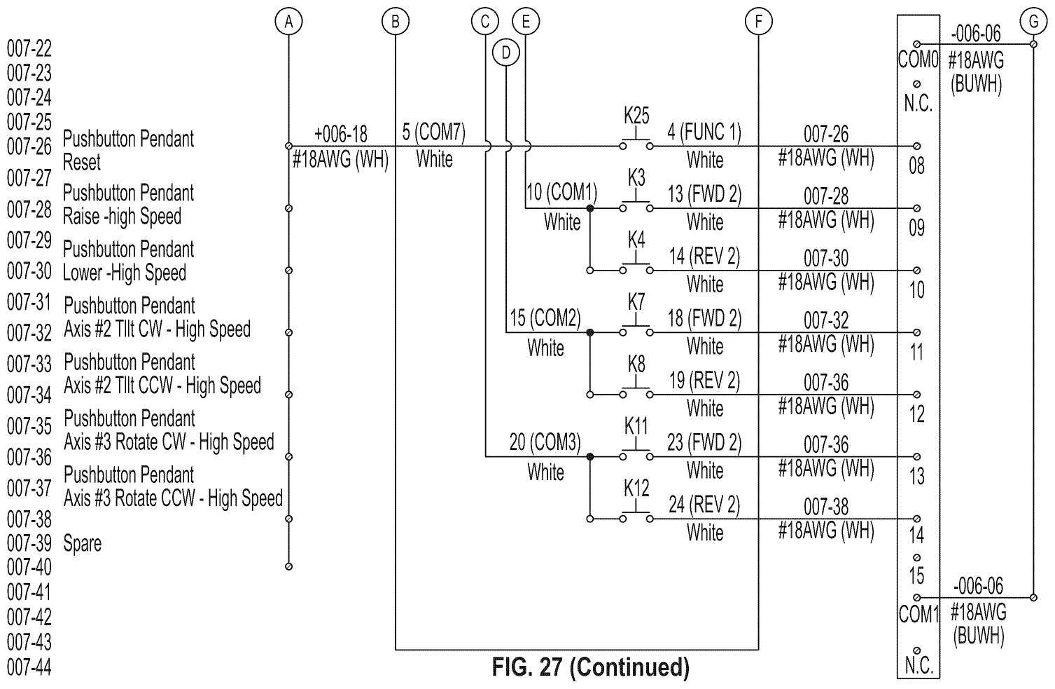

FIG. 27 shows a schematic diagram of circuitry relating to electrical controls regarding embedded input wiring related to the controller 480 and operatively connected component(s) according to some embodiments.

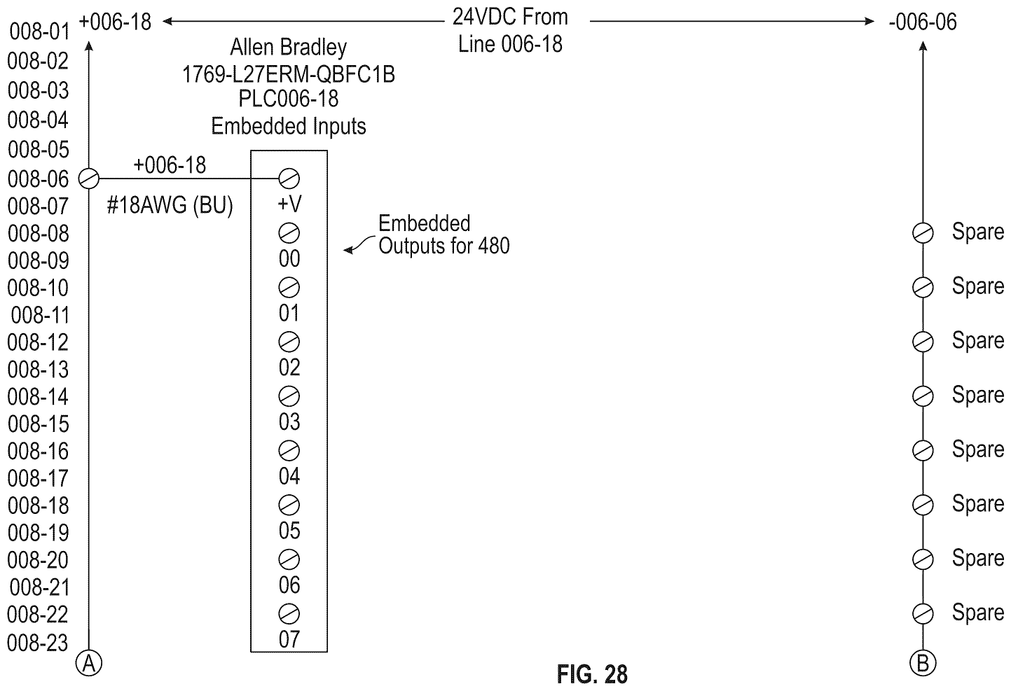

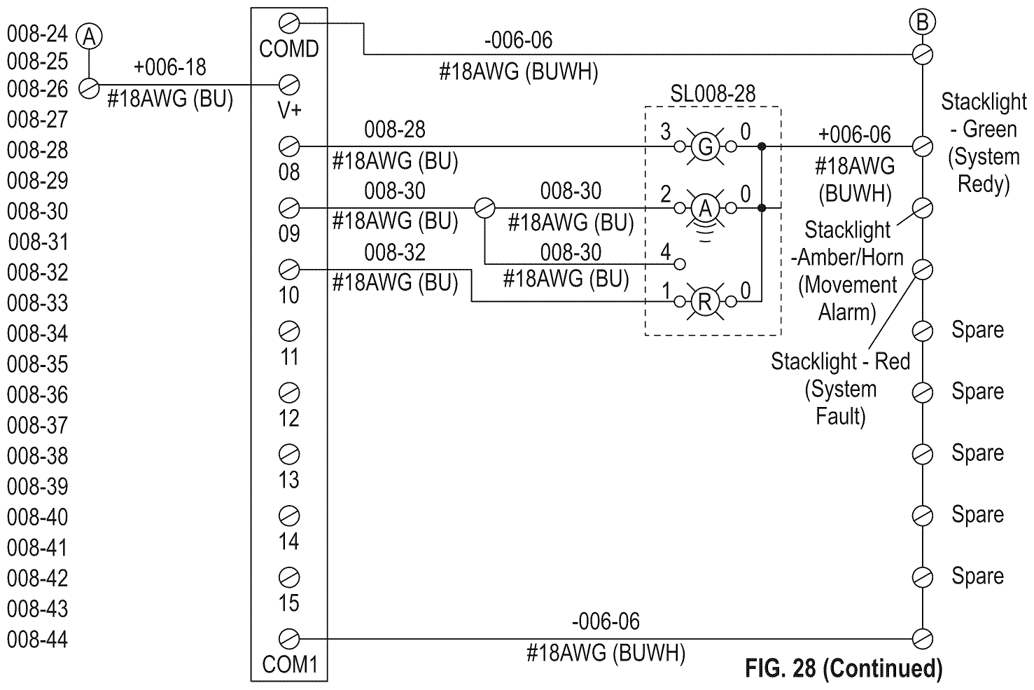

FIG. 28 shows a schematic diagram of circuitry relating to electrical controls regarding embedded output wiring related to the controller 480 and operatively connected component(s) according to some embodiments.

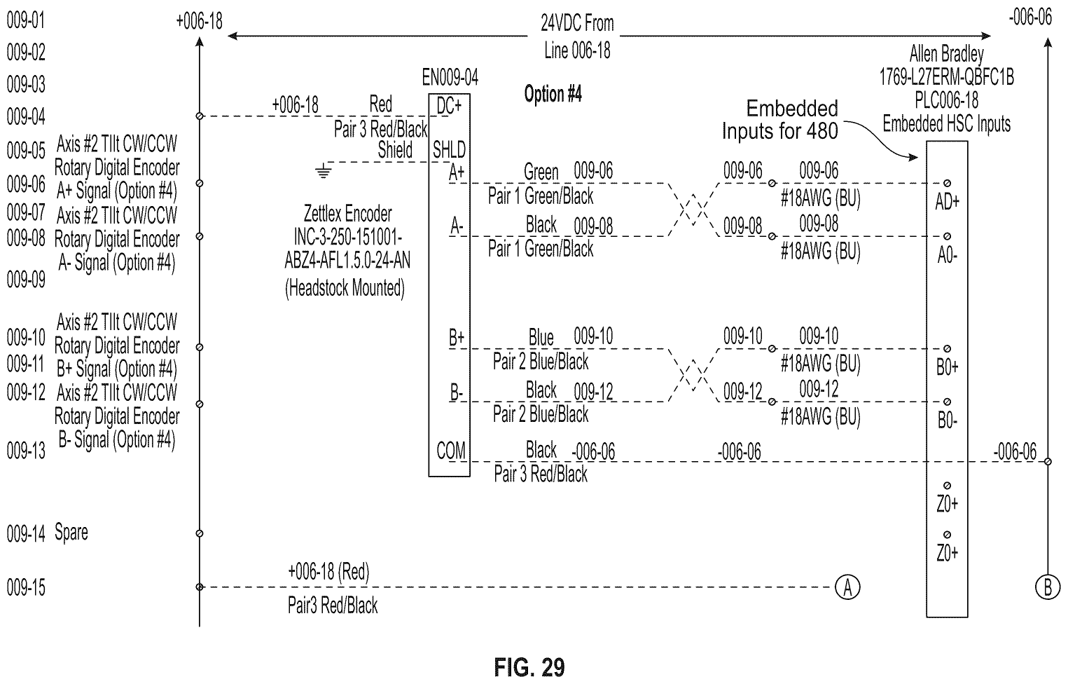

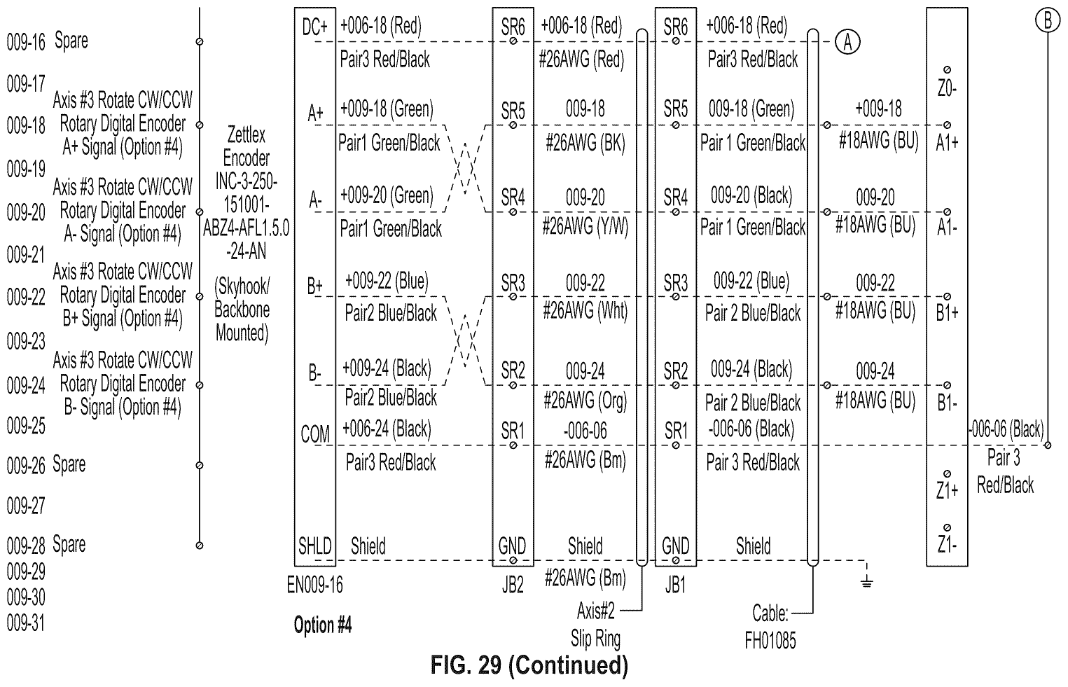

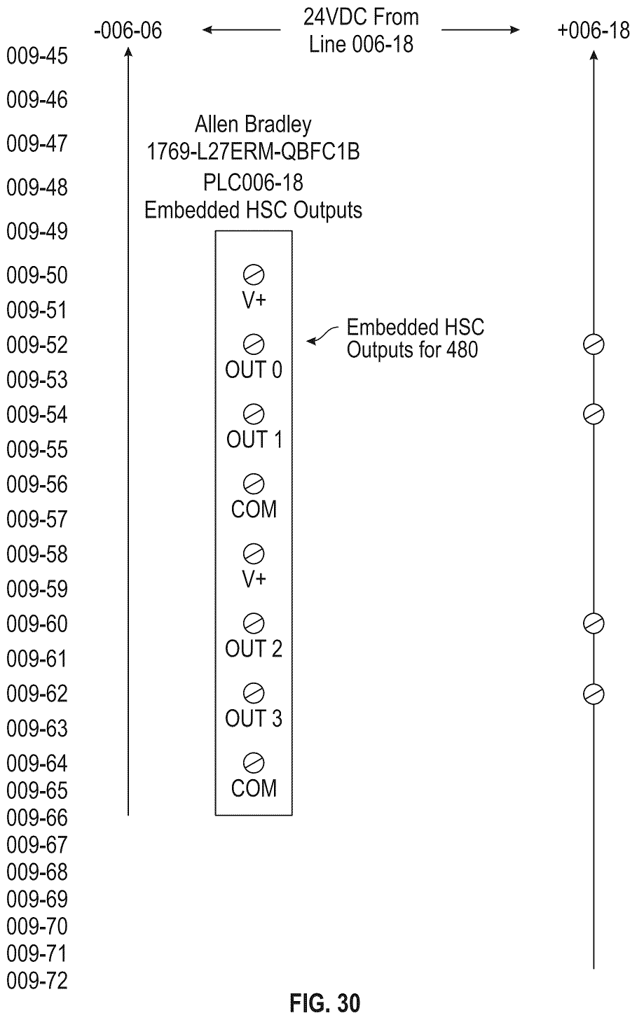

FIGS. 29 and 30 show schematic diagrams of circuitry relating to electrical controls regarding embedded high-speed counters (HSC) wiring related to the controller 480 and operatively connected component(s) according to some embodiments.

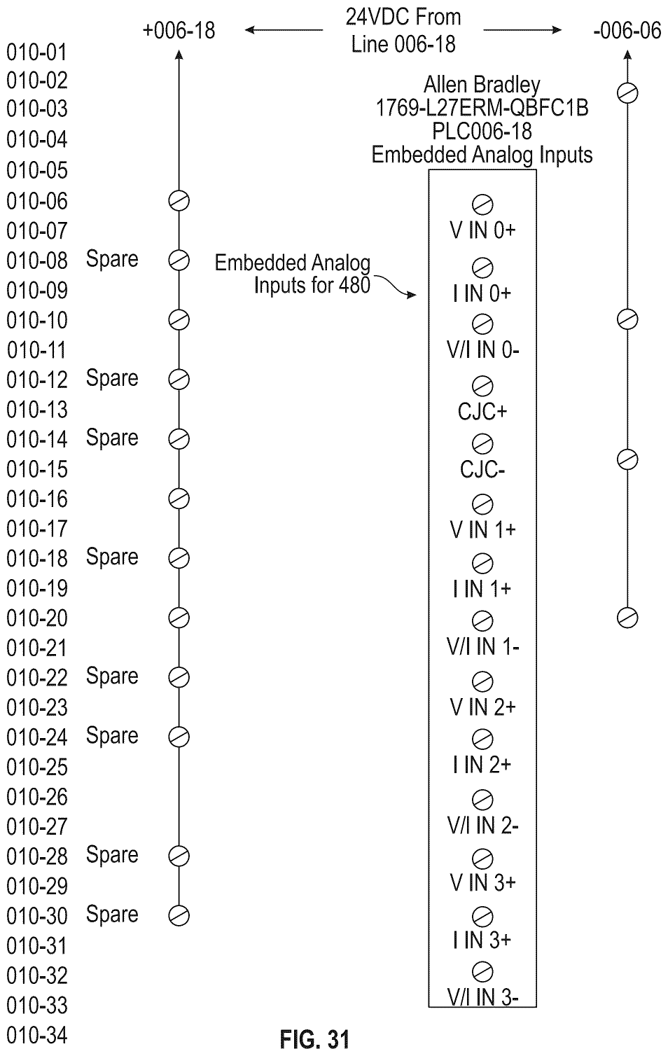

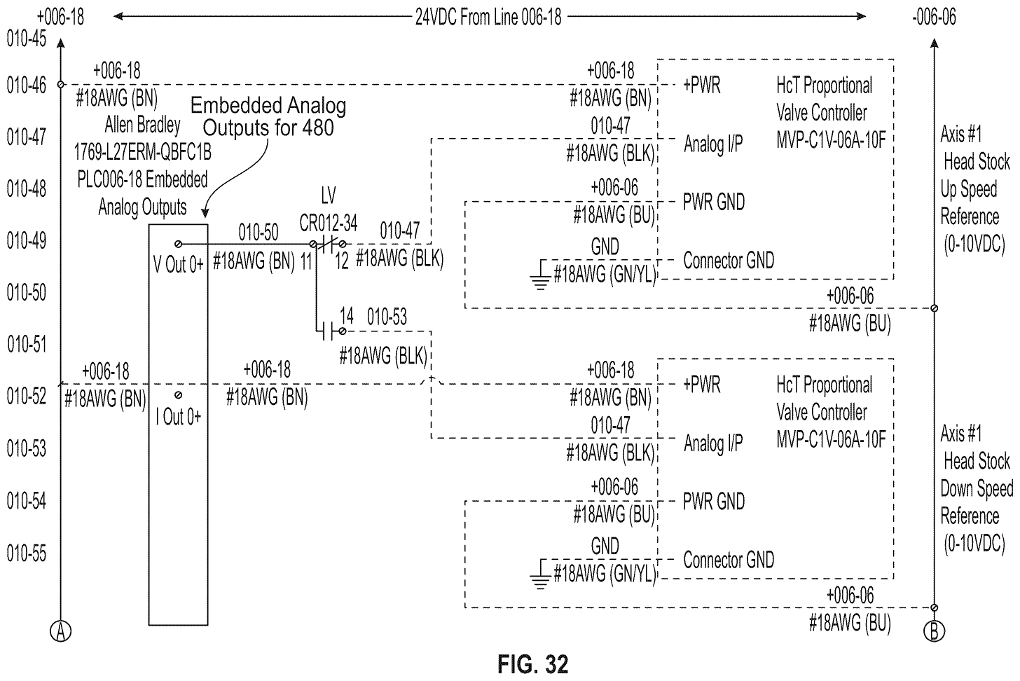

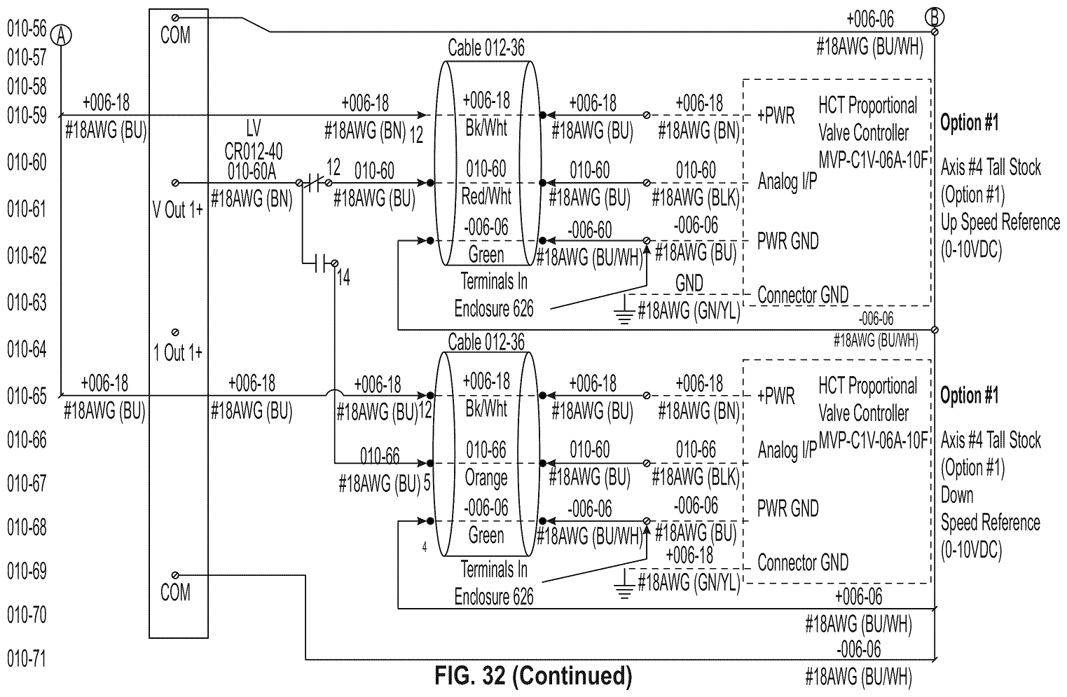

FIGS. 31 and 32 show schematic diagrams of circuitry relating to electrical controls regarding embedded analog input/output wiring related to the controller 480 and operatively connected component(s) according to some embodiments.

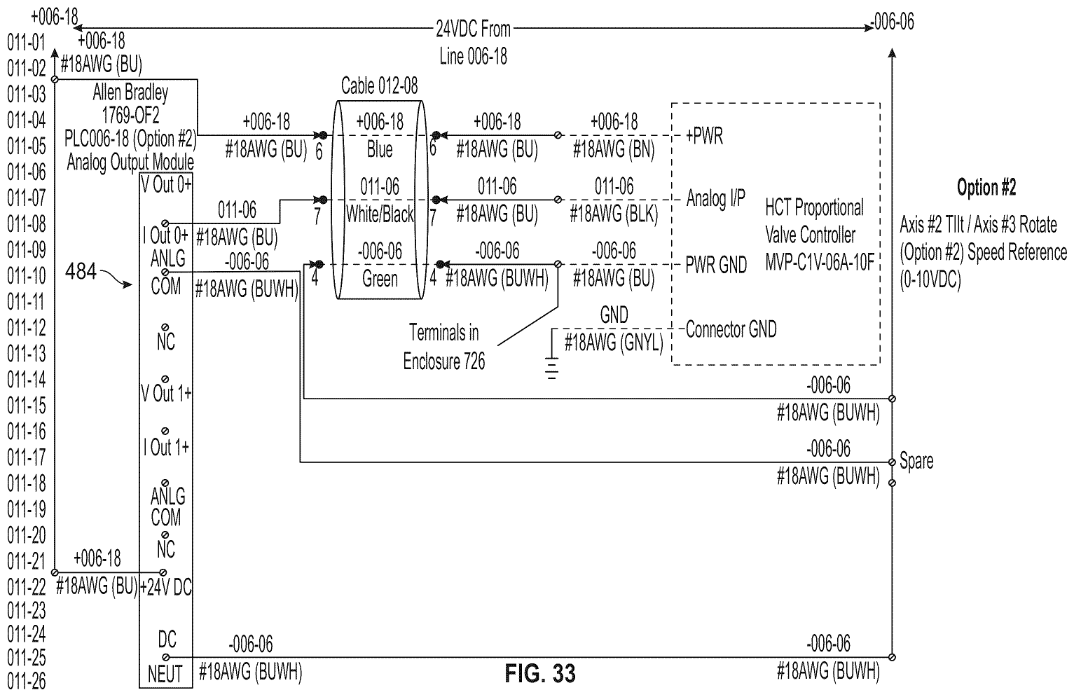

FIG. 33 shows a schematic diagram of circuitry relating to electrical controls regarding analog wiring related to the output module that replaces the specialty module 484 when the system 200 is operating under option #2 and operatively connected component(s) according to some embodiments.

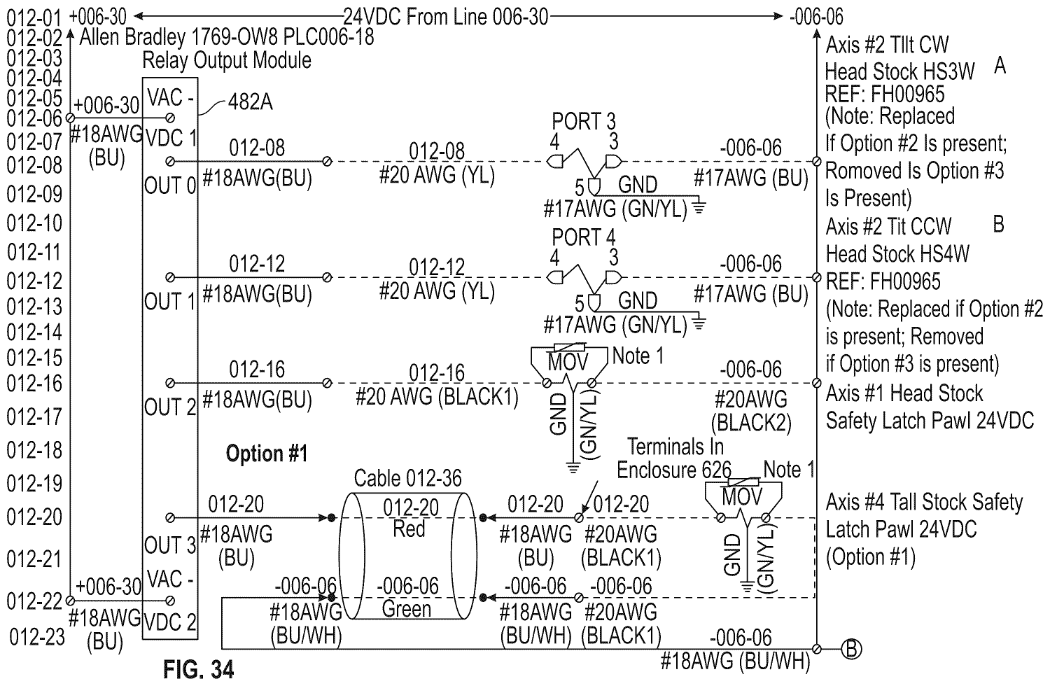

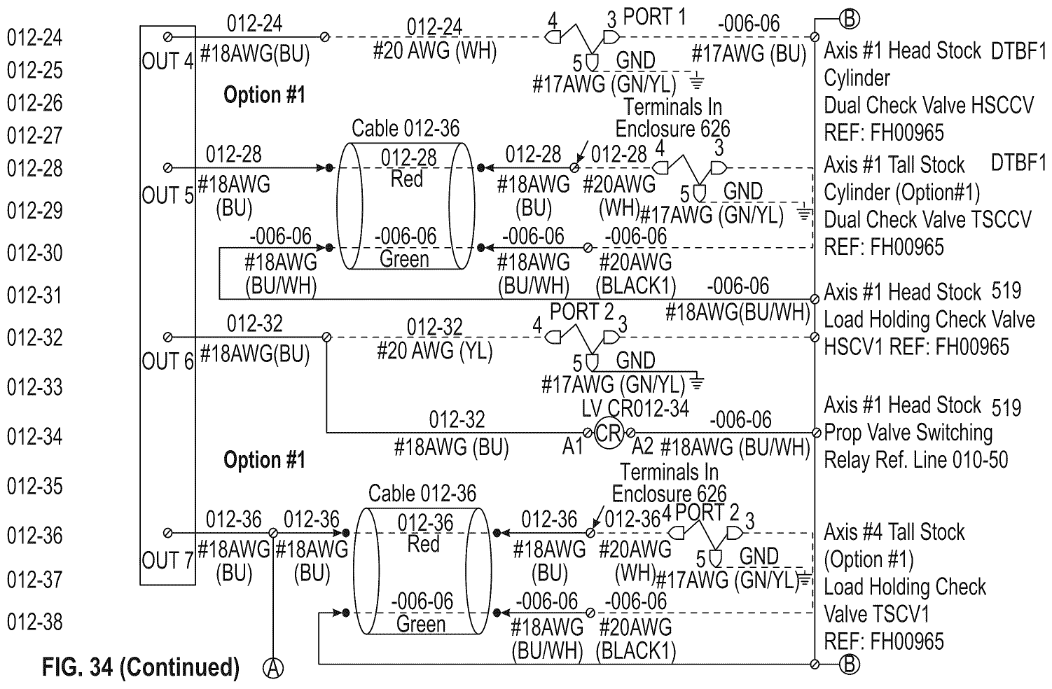

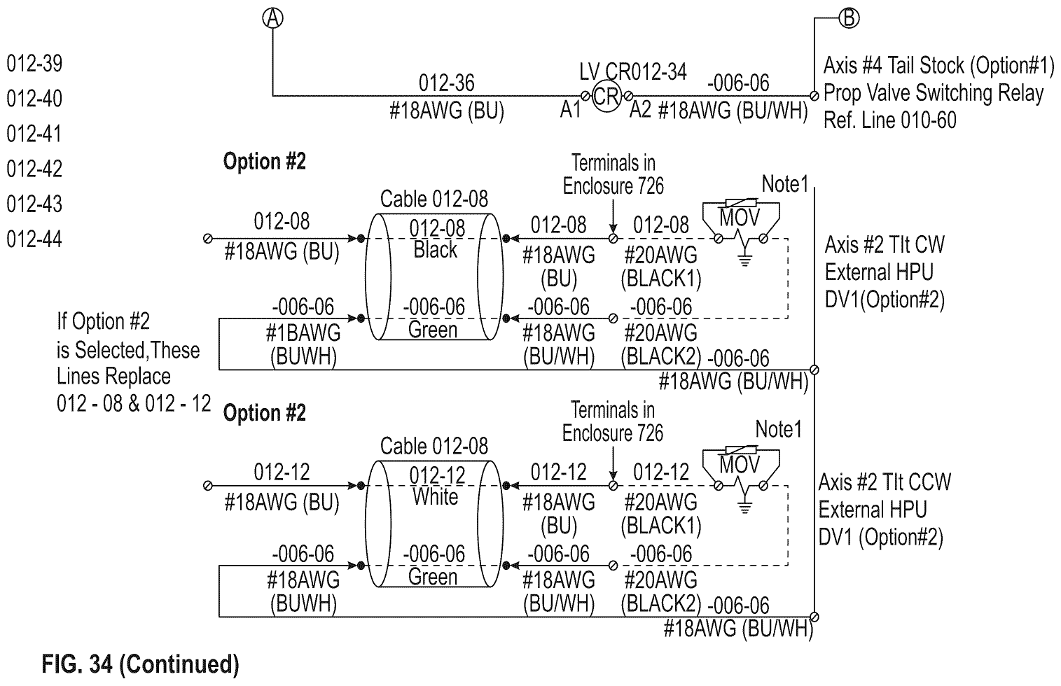

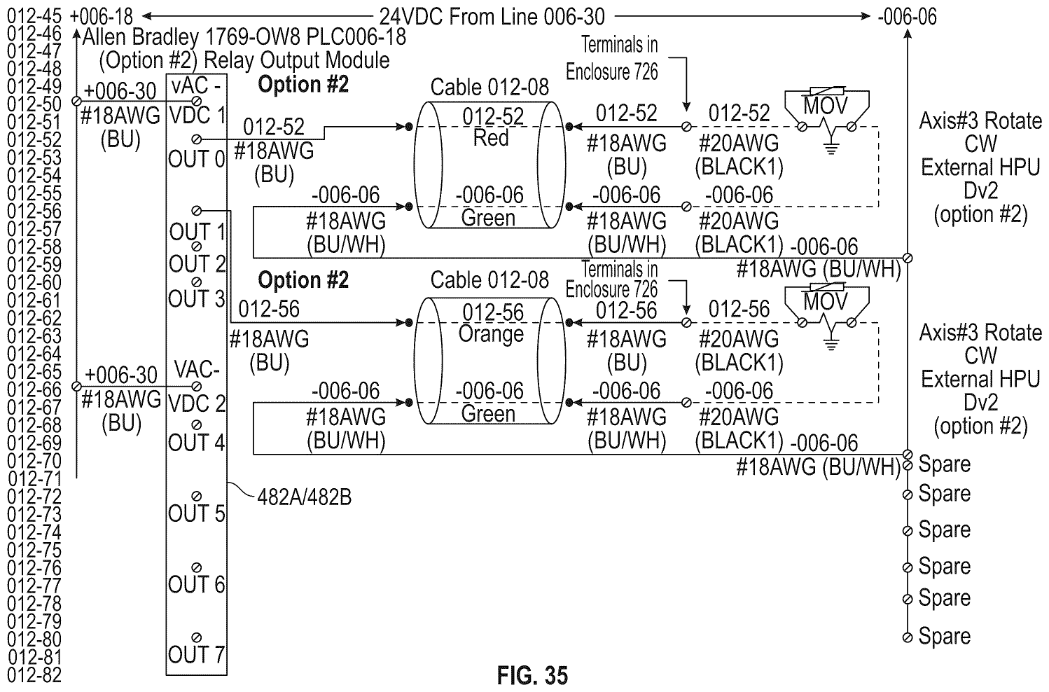

FIGS. 34 and 35 show schematic diagrams of circuitry relating to electrical controls regarding wiring related to the output module(s) 482A, 482B and operatively connected component(s) according to some embodiments.

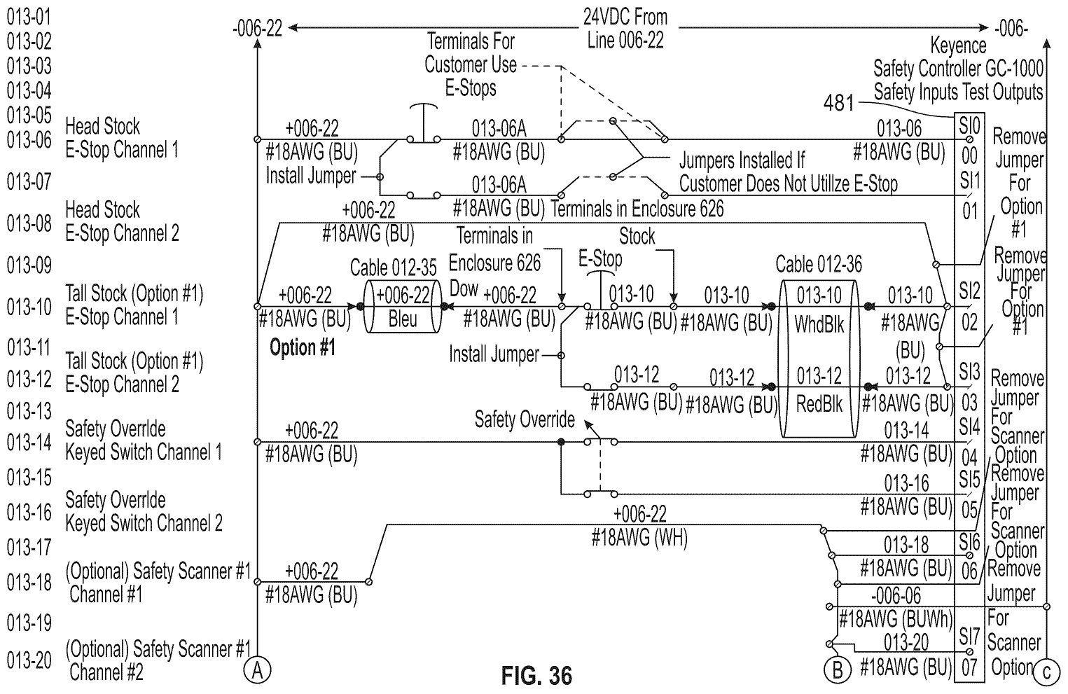

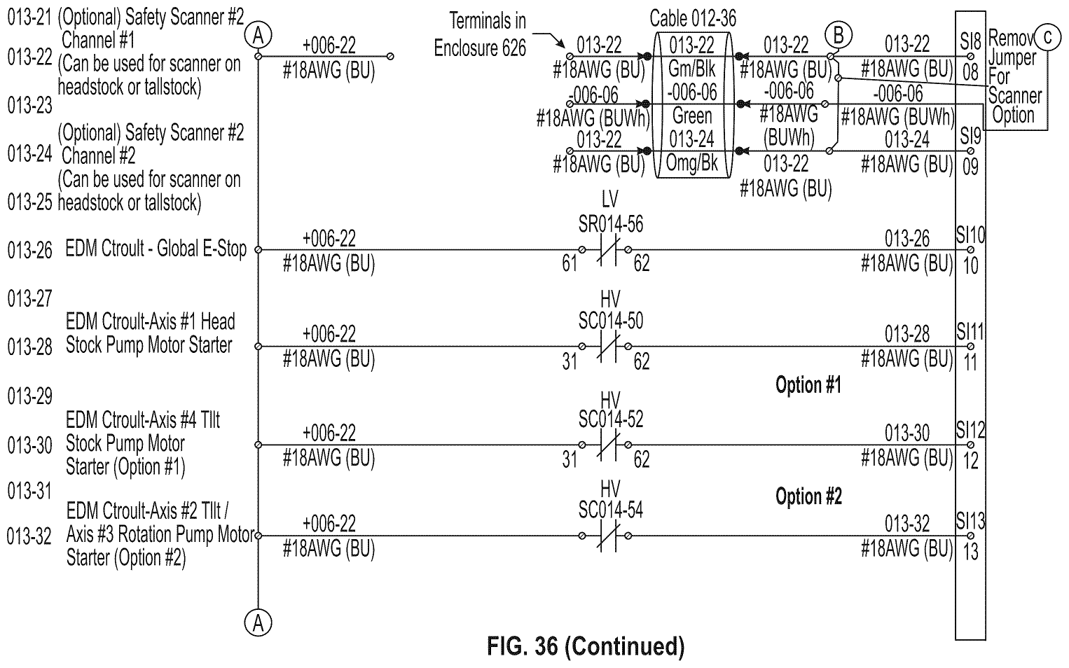

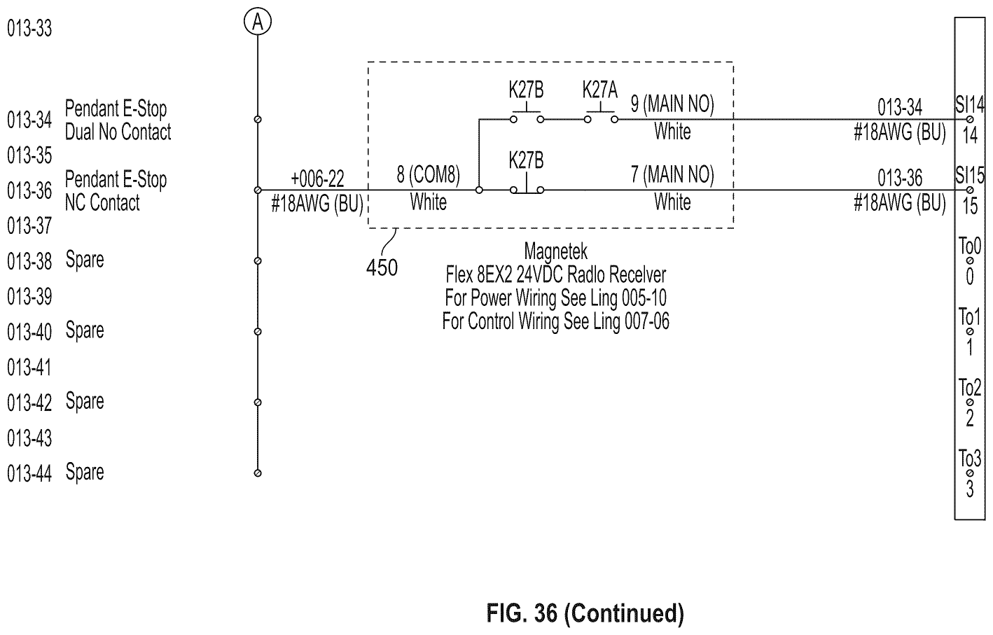

FIG. 36 shows a schematic diagram of circuitry relating to electrical controls regarding inputs related to the safety controller 481 and operatively connected component(s) according to some embodiments.

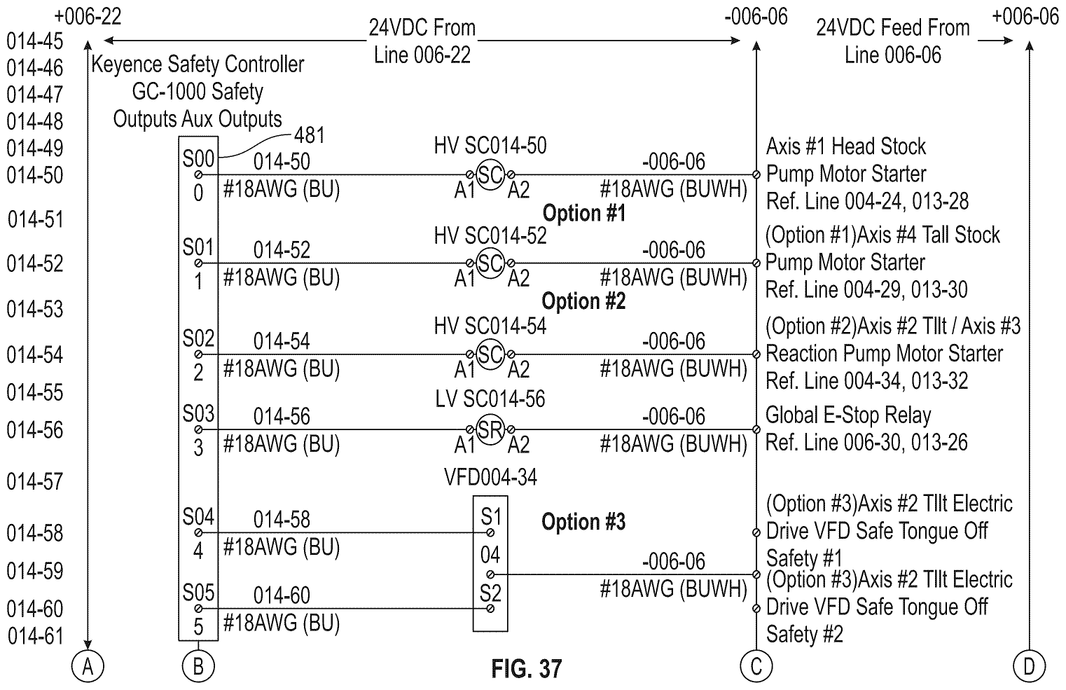

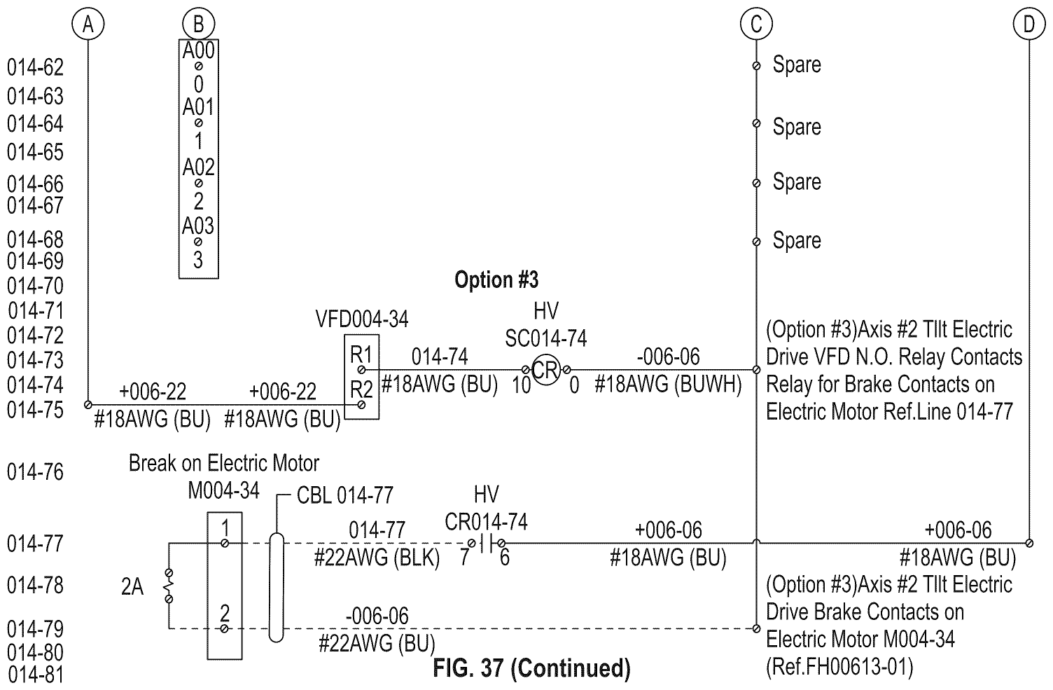

FIG. 37 shows a schematic diagram of circuitry relating to electrical controls regarding outputs related to the safety controller 481 and operatively connected component(s) according to some embodiments.

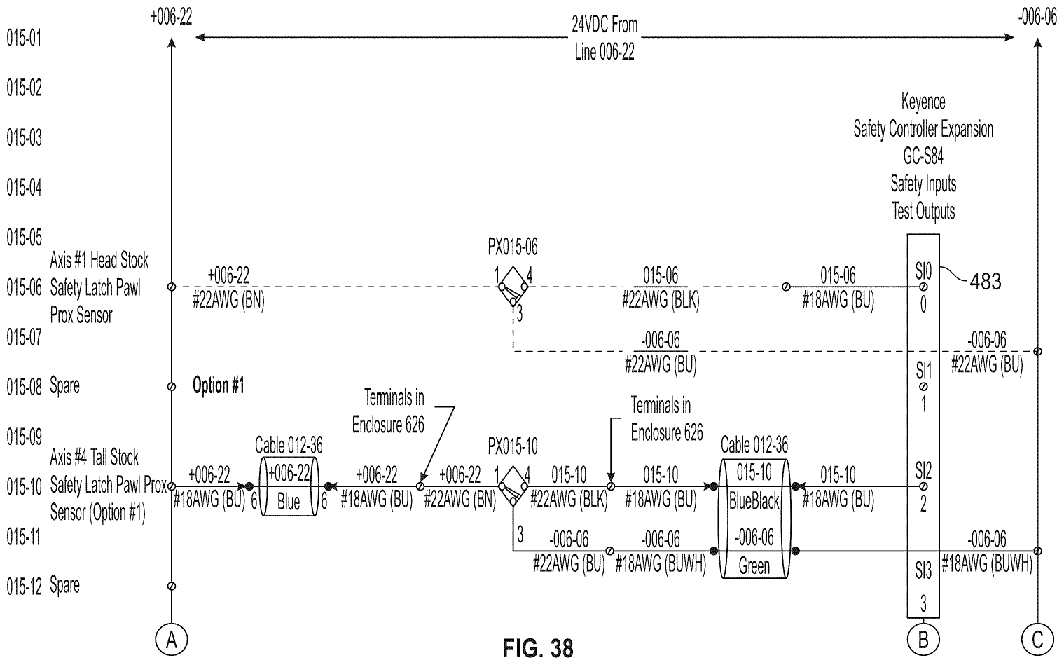

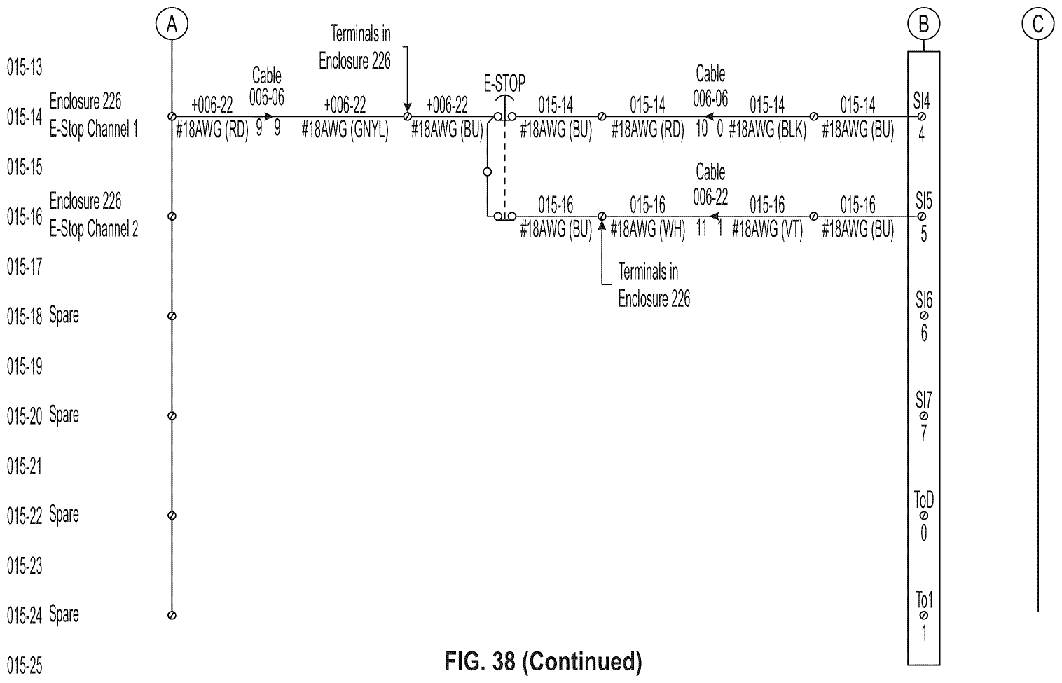

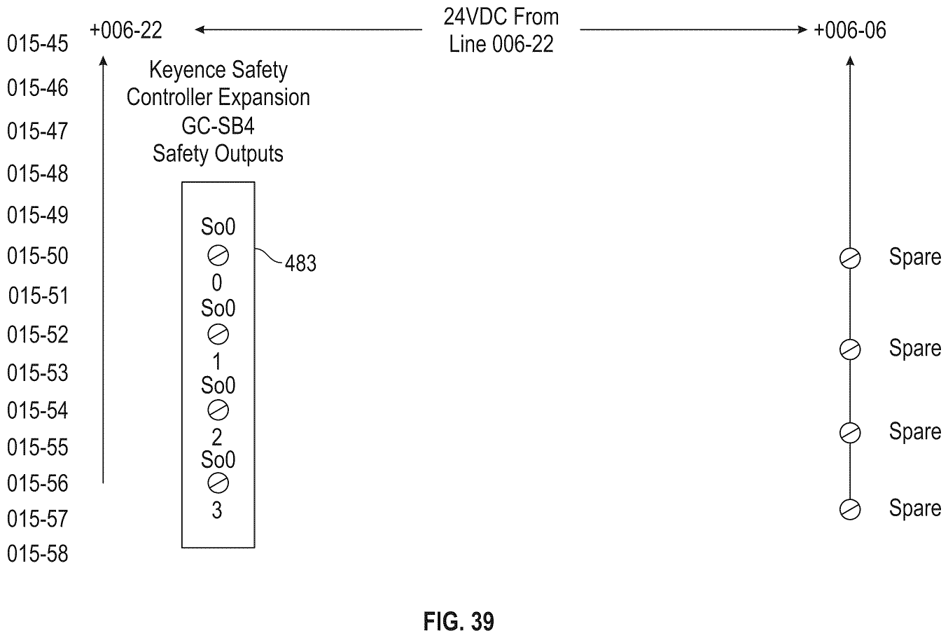

FIGS. 38 and 39 show schematic diagrams of circuitry relating to electrical controls regarding inputs and outputs related to the safety expansion 483 and operatively connected component(s) according to some embodiments.

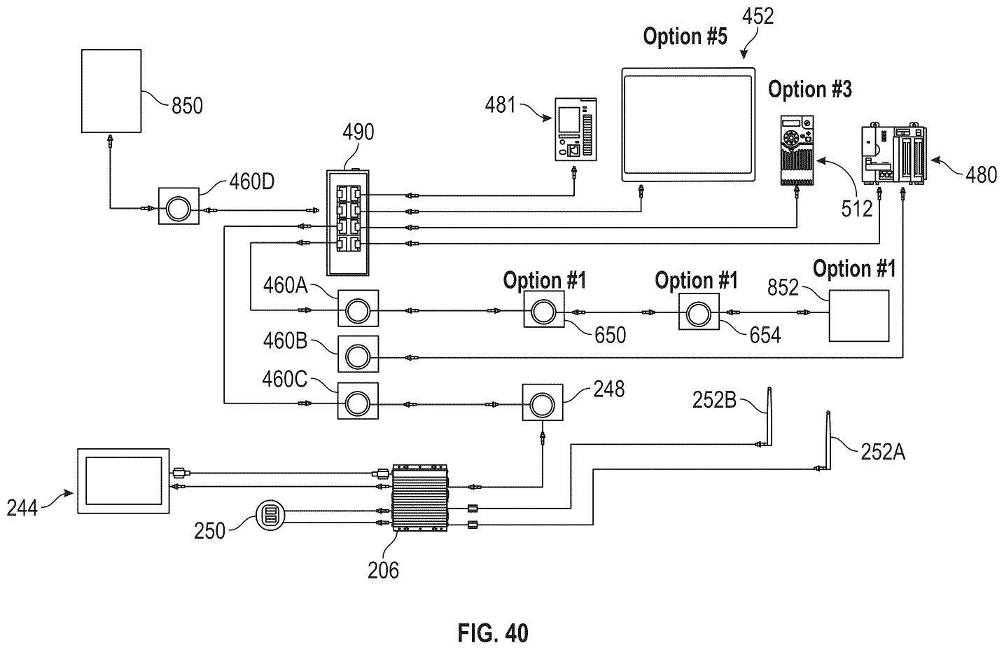

FIG. 40 shows a schematic diagram of components of the system 200 according to some embodiments. As shown in FIG. 40, a first linear transducer 850 can be operatively connected to the enclosure 426 via the cable port 460D located on the top 428 of the enclosure 426 and/or the switch 490 located within the enclosure 426. A network cable, such as an ethernet cable, can be used to operatively connect the first linear transducer 850 to the cable port 460D. A network cable, such as an ethernet cable, can be used to operatively connect the cable port 460D to the switch 490. According to some embodiments, the first linear transducer 850 can be associated with the headstock portion 204 of the positioner 202.

As shown in FIG. 40, the safety controller 481 can be operatively connected to the switch 490. A network cable, such as an ethernet cable, can be used to operatively connect the safety controller 481 to the switch 490.

As shown in FIG. 40, when the system 200 is operating under option #5, the display 452 can be operatively connected to the switch 490. A network cable, such as an ethernet cable, can be used to operatively connect the display 452 to the switch 490.

As shown in FIG. 40, when the system 200 is operating under option #3, the drive 512 can be operatively connected to the switch 490. A network cable, such as an ethernet cable, can be used to operatively connect the drive 512 to the switch 490.

As shown in FIG. 40, the controller 480 can be operatively connected to the switch 490. A network cable, such as an ethernet cable, can be used to operatively connect the controller 480 to the switch 490. The controller 480 can also be operatively connected to one of the cable ports on the bottom 430 of the enclosure 426. FIG. 40 shows the controller 480 to be operatively connected to the cable port 460B. A network cable, such as an ethernet cable, can be used to operatively connect the controller 480 to one of the cable ports, such as the cable port 460B, on the bottom 430 of the enclosure 426.

As shown in FIG. 40, the switch 490 can be operatively connected to one of the cable ports on the bottom 430 of the enclosure 426. FIG. 40 shows the switch 490 to be operatively connected to the cable port 460A. A network cable, such as an ethernet cable, can be used to operatively connect the switch 490 to one of the cable ports, such as the cable port 460A, on the bottom 430 of the enclosure 426.

As shown in FIG. 40, when the system 200 is operating under option #1, one of the cable ports on the bottom 430 of the enclosure 426 can be operatively connected to the cable port 650 located on the bottom 630 of the enclosure 626. FIG. 40 shows that the cable port 460A on the bottom 430 of the enclosure 462 is operatively connected to the cable port 650. A network cable, such as an ethernet cable, can be used to operatively connect the cable port 460A to the cable port 650. Further, as shown in FIG. 40, when the system 200 is operating under option #1, the cable port 650 can be operatively connected to the cable port 654 located on the top 628 of the enclosure 426. A network cable, such as an ethernet cable, can be used to operatively connect the cable port 650 to the cable port 654. Even further, as shown in FIG. 40, when the system 200 is operating under option #1, a second linear transducer 852 can be operatively connected to the cable port 654. A network cable, such as an ethernet cable, can be used to operatively connect the second linear transducer 852 to the cable port 654. According to some embodiments, the second linear transducer 852 can be associated with the tailstock portion 205 of the positioner 202.

As shown in FIG. 40, the cable port 248 located on the bottom 230 of the enclosure 226 can be operatively connected to one of the cable ports located on the bottom of the enclosure 426. FIG. 40 shows the cable port 248 to be operatively connected to the cable port 460C located on the bottom 430 of the enclosure 426. A network cable, such as an ethernet cable, can be used to operatively connect the cable port 248 to the cable port 460C. As shown in FIG. 40, the cable port 460C can be operatively connected to the switch 490. A network cable, such as an ethernet cable, can be used to operatively connect the cable port 460° C. to the switch 490.

As shown in FIG. 40, the cable port 248 can be operatively connected to the AI-enabled voice control module 206. A network cable, such as an ethernet cable, can be used to operatively connect the cable port 248 to the AI-enabled voice control module 206.

As shown in FIG. 40, the display 244 can be operatively connected to the AI-enabled voice control module 206. As shown in FIG. 40, multiple connection means can be used to operatively connect the display 244 to the AI-enabled voice control module 206. For example, a Video Graphics Array (VGA) cable and a console cable can be used to operatively connect the display 244 to the AI-enabled voice control module 206. However, any suitable connection means could be used.

As shown in FIG. 40, the USB port 250 can be operatively connected to the AI-enabled voice control module 206. As shown in FIG. 40, each USB port of the USB port 250 can be operatively connected to the AI-enabled voice control module 206. A USB cable can be used to operatively connect each port of the USB port 250 to the AI-enabled voice control module 206. However, any suitable connection means could be used.

As shown in FIG. 40, both the right-side antenna 252A and the left-side antenna 252B are operatively connected to the AI-enabled voice control module 206. A bulkhead cable can be used to operatively connect each of the right-side antenna 252A and left-side antenna 252B to the AI-enabled voice control module 206. However, any suitable connection means could be used.

As shown in FIG. 40, all aspects of the system 200, including voice control aspects, can operate properly without the need for wireless internet.

It is noted that, according to some embodiments, any cord inlet/outlet, cable port, USB port, connector port, cable inlet/outlet, jacket cable port, and the like described herein, can be mounted onto its respective enclosure via a cutout in the enclosure wherein the cutout is generally circular and has a diameter or circumference of about 0.875 inches.

It is noted that, according to some embodiments, any cord inlet/outlet, cable port, USB port, connector port, cable inlet/outlet, jacket cable port, and the like described herein, can comprise a port wherein a cable, cord, wire, and the like could be plugged in to operatively connect components of the system 200.

It is noted that, according to some embodiments, any cord, cable, wire, wiring, and the like entering and/or exiting any of the enclosures 226, 426, 626, and/or 726 described herein via any cord inlet/outlet, cable port, USB port, connector port, cable inlet/outlet, jacket cable port, and the like described herein, can be for the purpose of power, data communication, and/or any other suitable purpose.

It is noted that, according to some embodiments, each enclosure described herein including the enclosures 226, 426, 626, and 726 can each comprise any amount of wire duct(s) and/or protective film in its interior to house and/or protect wiring and/or other components in the internal portions of the enclosures 226, 426, 626, 726.

It is noted that, according to some embodiments, components and/or aspects of any industrial enclosure can be the same as and/or similar to and can function in the same and/or similar manner as corresponding and/or like components and/or aspects of any other industrial enclosure described herein.

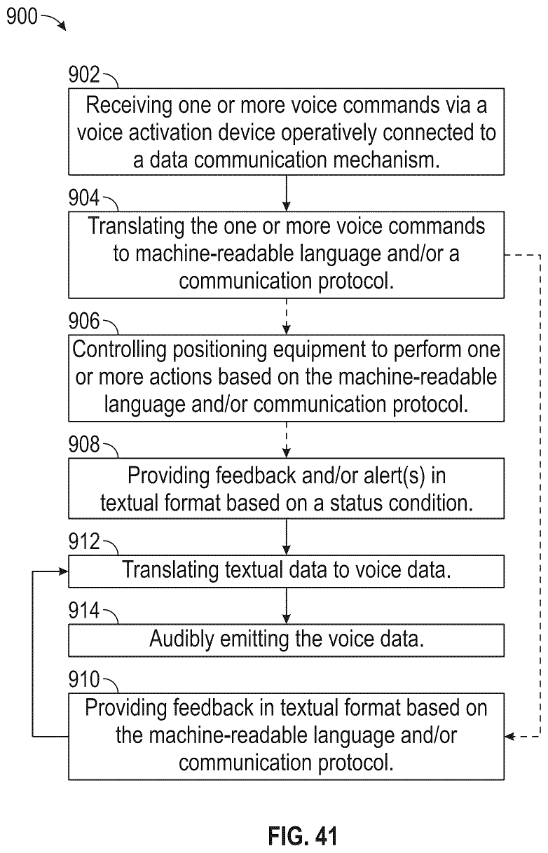

FIG. 41 shows a flow chart of an example method 900 for controlling positioning equipment via voice commands in a hands-free manner according to at least some aspects of the present disclosure. According to some embodiments, the method 900 can be performed via either of the systems 100 or 200 described herein. The method 900 can include a first step 902 which can comprise receiving one or more voice commands via a voice activation device operatively connected to a data communication mechanism. According to some embodiments, the voice activation device can be and/or comprise the hands-free interface device 104, the hands-free interface device 304, and/or any other suitable device. For example, the voice activation device can comprise a transducer (e.g., a microphone) and/or any other mechanism, device, and/or machine capable of receiving sound and/or any type of audio material and converting that sound and/or audio material into a signal. Such sound and/or audio material could include, but is not limited to, spoken words and/or the voice of a user. The voice activation device can further comprise an auditory mechanism wherein the auditory mechanism can comprise any sort of mechanism, device, and/or machine capable of emitting sound, such as speaker(s), headphone(s), ear piece(s), and the like. According to some embodiments, the voice activation device can comprise a headset that comprises both (1) a transducer (e.g., a microphone) and/or any other mechanism, device, and/or machine capable of receiving sound and/or any type of audio material and converting that sound and/or audio material into a signal, and (2) an auditory mechanism capable of emitting sound such as speaker(s), headphone(s), and/or ear piece(s).

The voice activation device can include a communication mechanism, such as the wearable communication mechanism 128 or the wearable communication mechanism 332, and can be paired with, coupled with, and/or otherwise operatively connected to a data communication mechanism. According to some embodiments, the data communication mechanism can be and/or comprise the data communication mechanism 114 of the system 100. For example, according to some embodiments, the data communication mechanism can be a BLE radio wherein the voice activation device and the data communication mechanism engage in data communication via Bluetooth. Additionally or alternatively, the data communication mechanism could be any suitable mechanism capable of performing data communication with the voice activation device using any suitable protocol such as Bluetooth, Wi-Fi, RFID, and/or any wired connection including, but not limited to, ethernet.

Thus, the step 902 can comprise receiving voice command(s) from an operator via the voice activation device wherein the voice activation device communicates the voice data to the data communication mechanism. According to some embodiments, the data communication mechanism can be part of an AI-enabled voice control module. According to some embodiments, the AI-enabled voice control module can be the same as and/or similar to the AI-enabled intelligence control module 106 of the system 100 and/or the AI-enabled intelligence control module 206 of the system 200. According to some embodiments, the AI-enabled voice control module can be integrated with a PLC such as the PLC 116 of the system 100 and/or the PLC 216 of the system 200.

As shown in FIG. 41, the method 900 can comprise a second step 904 which can comprise translating the one or more voice commands from step 902 to a machine-readable language and/or a communication protocol. According to some embodiments, the step 904 can comprise understanding and/or interpreting the one or more voice commands. According to some embodiments, the machine-readable language and/or communication protocol can be and/or comprise MQTT. Such translation can occur as described herein regarding the system 100. The AI-enabled voice control module can perform voice-to-text and/or text-to-voice conversion(s), which enables the AI-enabled voice control module to work in conjunction with the PLC to carry out text-to-operation functionality and/or status-to-text-to-voice functionality. The AI-enabled voice control module can include built-in, internal software and/or hardware capable of utilizing AI to translate the voice data to a machine-readable language and/or a communication protocol. The voice activation device can be in operative communication with the AI-enabled voice control module and, thus, with the software thereof. Additionally or alternatively, according to some embodiments, the AI-enabled voice control module can utilize the Internet when performing the voice-to-text and/or text-to-voice conversion(s). Performing the voice-to-text conversion of the voice data enables the text-to-operation functionality.

As shown in FIG. 41, based on the voice data input by an operator, after performing the step 904, the method 900 can then perform the step 906 and/or the step 910. If the voice data is a command for the positioning equipment to perform one or more action(s), then the step 906 can be performed. The step 906 can comprise controlling positioning equipment to perform one or more actions based on the machine-readable language and/or communication protocol. The AI-enabled voice control module and PLC can use the machine-readable language and/or communication protocol, such as MQTT, to control positioning equipment. According to some embodiments, the positioning equipment can be the positioner 102 of the system 100 and/or the positioner 202 of the system 200. The AI-enabled voice control module and/or PLC can include a controller library of action(s) of the positioning equipment wherein the machine-readable language and/or communication protocol, translated based on the voice data, dictates which action(s) are performed by the positioning equipment. Such action(s) can comprise moving (e.g., raising, lowering, rotating, tilting, and the like) a work piece. According to some embodiments, the positioning equipment is used for welding.

As shown in FIG. 41, after performing the step 906, the method 900 can then either perform the step 908 or the step 912. The step 908 can comprise providing feedback and/or alert(s) in textual format based on a sensed status condition. The feedback could comprise any sort of feedback noted herein with reference to the system 100 and/or the system 200. For example, the feedback could comprise a ready to move signal, a move command signal, a fault signal comprising identification of a fault and information regarding how to rectify the fault, and/or a confirmation signal regarding command execution. According to various embodiments, providing feedback can be optional based on an operator's preferences and/or a particular configuration. The system can provide said feedback in textual format to the AI-enabled voice control module and/or the PLC. If no feedback is necessary and/or desired, the method 900 can continue to the step 912 after performing the step 906. If, while performing the one or more action(s) during the step 906, a status condition is sensed wherein said status condition triggers an alert, the system can provide an alert in textual format to the AI-enabled voice control module and/or the PLC. An alert can comprise one or more of a machine status alert, a maintenance alert; and/or a safety alert. An alert could be triggered based on any sensed condition noted herein with reference to the system 100 and/or the system 200. For example, an alert could be triggered for an unsafe condition, a situation wherein a component of the positioning equipment is damaged and/or needs to be replaced, an overvoltage, an undervoltage, and the like. According to some embodiments, such alert(s) can be sensed and communicated in real time. If, after performing the step 906, no alert(s) are necessary, the method 900 can continue to the step 912.

As shown in FIG. 41, based on the voice data input by an operator, after performing the step 904, the method 900 can then perform the step 906 and/or the step 910. If the voice data is a command to provide feedback, a question regarding the status of positioning equipment and/or a component thereof, a troubleshooting question, and/or any other type of question, then the step 910 can be performed. The step 910 can comprise providing feedback in textual format based on the machine-readable language and/or communication protocol. For example, such statement(s) and/or question(s) that trigger the step 910 could be related to topics comprising troubleshooting, seeking help, receiving guidance, enhancing efficiency of problem resolution, inquiring about scheduled tasks, checking pending items, communicating with a manager, and/or streamlining workflow and/or coordination. The system can provide said feedback in textual format to the AI-enabled voice control module and/or the PLC.

As shown in FIG. 41, after performing the step 906, 908, or 910, the method 900 can comprise performing the step 912. The step 912 can comprise translating textual data to voice data. According to some embodiments, the step 912 can comprise understanding and interpreting the textual data. The step 912 can include translating any feedback and/or alert(s) in textual format to voice data. The AI-enabled voice control module and/or PLC can be utilized to perform text-to-voice conversion of the textual feedback and/or alert data, enabling the status-to-text-to-voice functionality. The AI-enabled voice control module and/or PLC can utilize built-in software and/or hardware as well as AI to perform the text-to-voice conversion. Additionally or alternatively, the AI-enabled voice control module and/or PLC can utilize the Internet to perform the text-to-voice conversion.

As shown in FIG. 41, the method 900 can comprise the step 914 which can comprise audibly emitting the voice data. After the feedback and/or alert(s) are converted into voice data via the AI-enabled voice control module and/or the PLC, the data communication mechanism can send the voice data to the voice activation device. The voice activation device can then audibly emit the voice data such that an operator is able to hear the voice data. The voice activation device can emit the voice data via its auditory mechanism which can include, but is not limited to, speaker(s), headphone(s), ear piece(s), and the like. In this way, an operator can effectively have a conversation with the positioning equipment via the system, including the AI-enabled voice control module and/or PLC, completely via voice and sound in a hands-free manner.

Therefore, as understood from the present disclosure, the apparatus(es), system(s), and/or method(s) described herein provide at least safety benefits, productivity and/or efficiency benefits, and ergonomic benefits. By being able to control positioning and/or other types of industrial machinery via voice commands in a hands-free manner wherein direct physical contact between an operator and the machinery is minimized, the apparatus(es), system(s), and/or method(s) significantly increase overall safety for operators and significantly reduce the risk of operator(s) sustaining injuries. For example, in the prior art, traditional equipment handling and/or welding setups often require operator(s) to manually adjust or position manufactured product(s). Stopping to interact with manual controls can expose the operator to various hazards, such as burns from hot surfaces, injuries from moving parts, or even more severe accidents involving heavy machinery. The apparatus(es), system(s), and/or method(s) herein eliminate and/or reduce the risk of such injuries and/or unsafe situations by minimizing an operator's direct contact with machinery. The apparatus(es), system(s), and/or method(s) described herein allow an operator to maintain a safer distance from hot surfaces and moving parts, reducing the likelihood of burns and/or other injuries.

As noted, the apparatus(es), system(s), and/or method(s) described herein provide efficiency and productivity benefits. In the prior art, traditional handling of positioning equipment involved manual adjustment of the equipment which was time-consuming and interrupted the manufacturing process, leading to decreased efficiency and productivity. For example, in the prior art, each time an operator had to stop to adjust the positioning equipment, valuable working time was lost and the overall workflow was disrupted. Controlling industrial equipment, such as positioning equipment, via voice commands enables continuous operation without the need to stop to manually adjust equipment, thereby streamlining the production process. This leads to a more efficient and productive workflow wherein operator(s) can focus more on the quality of their work rather than on equipment positioning. Thus, the apparatus(es), system(s), and/or method(s) described herein provide a work environment that is safer and is conducive to higher quality work and more efficient output. Since workflow is not interrupted due to the need to manually adjust equipment, operator(s) utilizing the apparatus(es), system(s), and/or method(s) described herein are able to save time and resources such that production is maximized while the time needed for production is minimized. This helps to reduce costs as less operators working for less amounts of time are necessary to maintain, and/or increase, productivity.

The apparatus(es), system(s), and/or method(s) described herein also provide ergonomic benefits. By controlling equipment via voice commands wherein the need for physical adjustments is minimized, physical strain and/or fatigue for operator(s) is eliminated and/or reduced. In the prior art, traditional handling of industrial equipment often required operator(s) to perform repetitive movements and/or maintain awkward positions to manipulate the equipment. The apparatus(es), system(s), and/or method(s) described herein eliminate and/or minimize the need for operator(s) to perform repetitive movements and/or maintain awkward positions to manipulate equipment. Thus, the apparatus(es), system(s), and/or method(s) described herein promote a healthier work environment and reduce the risk of injuries caused by repetitive strain.

The incorporation of aspect(s) of the apparatus(es), system(s), and/or method(s) described herein, such as the AI-enabled intelligence control module, to any existing positioner machine to enable the machine to utilize voice-activated commands significantly enhances the appeal of the innovation described herein. The apparatus(es), system(s), and/or method(s) described herein address the practical concerns of cost, applicability, and integration, making the safety, productivity, and ergonomic benefits accessible to a broader range of industrial operations. This approach not only maximizes the potential impact of the innovation on the manufacturing industry but also aligns with broader goals of sustainability and technological adaptability.

From the foregoing, it can be seen that the present disclosure accomplishes at least all of the stated objectives.

1. A voice activated and hands-free method of controlling positioning of a work piece held by a positioner for welding to be done on the work piece, the method comprising:
transmitting one or more voice commands from an operator via a voice activation device to a PLC having voice activated software and AI-enabled voice control;
translating the one or more voice commands to a machine-readable language and/or a communication protocol;
raising, lowering, and/or rotating the positioner by executable instructions from the PLC selected from an action library so as to raise, lower and/or rotate the work piece into a position for the welding to be done on the work piece, without manual adjustment of the work piece; and
providing real time audio feedback and alerts to the operator from the PLC.

2.-3. (canceled)

4. The method of claim 1, wherein the one or more voice commands are customizable based on operational needs and/or preferences.

5. (canceled)

6. The method of claim 1, wherein the feedback comprises one or more of:
(a) a ready to move signal;
(b) a move command signal;
(c) a fault signal comprising identification of a fault and information regarding how to rectify the fault; and
(d) a confirmation signal regarding command execution.

7. The method of claim 1, further comprising providing one or more real-time verbal alerts to the operator wherein the one or more verbal alerts comprises one or more of:
(a) a machine status alert;
(b) a maintenance alert; and
(c) a safety alert.

8. The method of claim 1, further comprising offering ongoing technical support and/or update(s).

9. (canceled)

10. The method of claim 1, wherein the AI-enabled voice controller is housed within an industrial enclosure.

11.-20. (canceled)

21. The method of claim 1 wherein the voice activation device is hands free.

22. The method of claim 1 wherein the voice activation device is wearable.

23. A method of adjusting a position of a work piece for welding, comprising;
mounting the work piece on a headstock carriage and a tailstock carriage of a hydraulic positioner;
using voice activated software operatively coupled with the positioner to receive a voice command from an operator and send the command to a PLC;
the voice activated software using an AI-enabled voice control module to perform voice-to-text and/or text-to-voice translations enabling text-to-operation functionality and/or status-to-text-to-voice functionality;
the PLC selecting instructions from an action library to move at least one of the headstock and tailstock carriages such that the work piece is at a desired position for welding; and
providing audible feedback and alerts from the AI-enabled voice control module to the operator.

24. The method of claim 23 wherein the movement of at least one of the headstock and tailstock carriages includes height adjustment and/or rotational adjustment.

25. The method of claim 23 wherein the work piece is raised, lowered and/or rotated by the voice activated software.

26. The method of claim 23 wherein the feedback comprising one or more of:
(a) a ready to move signal;
(b) a move command signal;
(c) a fault signal; and
(d) a confirmation signal.

27. The method of claim 23 wherein the alerts comprising one or more of:
(a) a machine status alert;
(b) a maintenance alert; and
(c) a safety alert.

28. The method of claim 23 further comprising using an AI-enabled voice control module to perform voice-to-text conversion(s) and/or text-to-voice conversion(s) enabling text-to-operation functionality and/or status-to-text-to-voice functionality.

29. The method of claim 23 wherein the voice activated software is controlled by an operator wearing a device operatively connected to the software so as to provide voice activated, hands free adjustment of the work piece.

30. The method of claim 23 wherein the software has safety protocols to prevent accidental movement of the work piece.

31. The method of claim 23 wherein the voice activated software includes an AI-enabled voice control module configured to convert voice input from an operator to a machine-readable language and/or a communication protocol.

32. A method of welding a work piece, comprising:
a) mounting the work piece in an adjustable positioner;
b) issuing a voice command by an operator;
c) converting the voice command utilizing AI enabled software to a machine-readable language and/or a communication protocol;
d) transmitting the machine-readable language or communication protocol to a PLC;
e) selecting movement for the positioner from a library of movement options of the PLC;
f) executing a selected movement of the positioner in real time to adjust the orientation of the work piece;
g) maintaining the work piece in the adjusted orientation; and then
h) welding the work piece; and
i) repeating steps b)-h) as needed to complete the welding on the work piece; and
providing real time audible feedback and alerts to the operator.

33. (canceled)

34. An industrial control process for moving a work piece mounted on an adjustable positioner, comprising:
initiating an input phase wherein an AI-enabled voice controller receives and processes human operator voice commands;
translating the voice commands using the voice controller to provide communication protocol for a PLC;
actuating mechanical adjustment of the positioner using executable instructions from the PLC based on the communication protocol and a library of adjustment options;
generating real time audible feedback and alerts to the human operator; and
the process being voice activated and hands-free.

35. The industrial control process of claim 34 wherein the communication protocol dictates the executable instructions for the positioner adjustment.

36. The industrial control process of claim 35 wherein the voice commands dictate the communication protocol.
